(19) United States
(12) Patent Application Publication
(10) Pub. No.: US 2026/0349540 A1
(43) Pub. Date: Nov. 5, 2026

(54) INPUT MECHANISMS

(71) Applicant: Apple Inc., Cupertino, CA (US)

(72) Inventors: Arian BEHZADI, San Francisco, CA (US); Stephen B. LYNCH, Portola Valley, CA (US); Andrew S. KIM, Walnut Creek, CA (US); Christopher P. FOSS, San Francisco, CA (US); Corey K. WANG, Palo Alto, CA (US); Andrew W. KOOKER, San Francisco, CA (US); Kurt R. STIEHL, Los Gatos, CA (US); Matthew J. ALLEN, Menlo Park, CA (US); Camille MOUSSETTE, San Francisco, CA (US); Gemma A. ROPER, San Francisco, CA (US); Megan M. SAPP, Napa, CA (US); Steven J. TAYLOR, Los Gatos, CA (US); Julian JAEDE, San Jose, CA (US)

(21) Appl. No.: 19/112,499

(22) PCT Filed: Sep. 23, 2023
(86) PCT No.: PCT/US2023/033560

§ 371 Date: Mar. 17, 2025

Related U.S. Application Data
(60) Provisional application No. 63/409,778, filed on Sep. 24, 2022.
(60) Provisional application No. 63/409,771, filed on Sep. 24, 2022.
(60) Provisional application No. 63/409,772, filed on Sep. 24, 2022.

(51) Int. Cl. G06F 3/0362; G06F 3/01; G06F 3/04847; G06F 3/0487; G06F 3/16

(52) U.S. Cl. CPC G06F 3/0362; G06F 3/016; G06F 3/04847; G06F 3/0487; G06F 3/167

(57) ABSTRACT

The present disclosure generally relates to input mechanisms.

### CROSS-REFERENCE TO RELATED APPLICATIONS

This application claims the benefit of U.S. Provisional Application No. 63/409,771, entitled “RESISTANCE FOR INPUT MECHANISMS,” filed Sep. 24, 2022, and claims the benefit of U.S. Provisional Application No. 63/409,772, entitled “MOVEMENT FOR INPUT MECHANISM,” filed Sep. 24, 2022, and claims the benefit of U.S. Provisional Application No. 63/409,778, entitled “INPUT MECHANISM,” filed Sep. 24, 2022, the entirety of each of which is incorporated herein by reference.

### FIELD

The present disclosure relates generally to computer user interfaces and, more specifically, to techniques for using input mechanisms.

### BACKGROUND

Devices often use various input mechanisms to detect interactions by a user. Such input mechanisms vary widely in their functionality and usability.

### SUMMARY

Some techniques for using input mechanisms of electronic devices, however, are generally cumbersome and inefficient. For example, some existing techniques use a complex and time-consuming user interface, which may include multiple actions by a user that do not result in the desired outcome. Existing techniques require more time than necessary, wasting user time and device energy. This latter consideration is particularly important in battery-operated devices.

Accordingly, the present technique provides electronic devices with faster, more efficient methods and interfaces for using input mechanisms. Such methods and interfaces optionally complement or replace other methods for using input mechanisms. Such methods and interfaces reduce the cognitive burden on a user and produce a more efficient human-machine interface. For battery-operated computing devices, such methods and interfaces conserve power and increase the time between battery charges.

In some embodiments, a method is performed at a computer system that is in communication with a physical input mechanism. In some embodiments, the method comprises: while the physical input mechanism is configured to have a first set of movement characteristics in response to detecting a rotation of the physical input mechanism, detecting an input directed to a control; and in response to detecting the input directed to the control: in accordance with a determination that the control corresponds to a first type of setting, configuring the physical input mechanism to have a second set of movement characteristics in response to detecting the rotation of the physical input mechanism, wherein the second set of movement characteristics is different form the first set of movement characteristics; and in accordance with a determination that the control corresponds to a second type of setting that is different from the first type of setting, configuring the physical input mechanism to have a third set of movement characteristics in response to detecting the rotation of the physical input mechanism, wherein the third set of movement characteristics is different from the second set of movement characteristics.

In some embodiments, a non-transitory computer-readable storage medium storing one or more programs configured to be executed by one or more processors of a computer system that is in communication with a physical input mechanism is described. In some embodiments, the one or more programs including instructions for: while the physical input mechanism is configured to have a first set of movement characteristics in response to detecting a rotation of the physical input mechanism, detecting an input directed to a control; and in response to detecting the input directed to the control: in accordance with a determination that the control corresponds to a first type of setting, configuring the physical input mechanism to have a second set of movement characteristics in response to detecting the rotation of the physical input mechanism, wherein the second set of movement characteristics is different form the first set of movement characteristics; and in accordance with a determination that the control corresponds to a second type of setting that is different from the first type of setting, configuring the physical input mechanism to have a third set of movement characteristics in response to detecting the rotation of the physical input mechanism, wherein the third set of movement characteristics is different from the second set of movement characteristics.

In some embodiments, a transitory computer-readable storage medium storing one or more programs configured to be executed by one or more processors of a computer system that is in communication with a physical input mechanism is described. In some embodiments, the one or more programs including instructions for: while the physical input mechanism is configured to have a first set of movement characteristics in response to detecting a rotation of the physical input mechanism, detecting an input directed to a control; and in response to detecting the input directed to the control: in accordance with a determination that the control corresponds to a first type of setting, configuring the physical input mechanism to have a second set of movement characteristics in response to detecting the rotation of the physical input mechanism, wherein the second set of movement characteristics is different form the first set of movement characteristics; and in accordance with a determination that the control corresponds to a second type of setting that is different from the first type of setting, configuring the physical input mechanism to have a third set of movement characteristics in response to detecting the rotation of the physical input mechanism, wherein the third set of movement characteristics is different from the second set of movement characteristics.

In some embodiments, a computer system configured to communicate with a physical input mechanism is described. In some embodiments, the computer system comprises: one or more processors; and memory storing one or more programs configured to be executed by the one or more processors, the one or more programs including instructions for: while the physical input mechanism is configured to have a first set of movement characteristics in response to detecting a rotation of the physical input mechanism, detecting an input directed to a control; and in response to detecting the input directed to the control: in accordance with a determination that the control corresponds to a first type of setting, configuring the physical input mechanism to have a second set of movement characteristics in response to detecting the rotation of the physical input mechanism, wherein the second set of movement characteristics is different form the first set of movement characteristics; and in accordance with a determination that the control corresponds to a second type of setting that is different from the first type of setting, configuring the physical input mechanism to have a third set of movement characteristics in response to detecting the rotation of the physical input mechanism, wherein the third set of movement characteristics is different from the second set of movement characteristics.

In some embodiments, a computer system configured to communicate with a physical input mechanism is described. In some embodiments, the computer system comprises: means, while the physical input mechanism is configured to have a first set of movement characteristics in response to detecting a rotation of the physical input mechanism, for detecting an input directed to a control; and means, responsive to detecting the input directed to the control, for: in accordance with a determination that the control corresponds to a first type of setting, configuring the physical input mechanism to have a second set of movement characteristics in response to detecting the rotation of the physical input mechanism, wherein the second set of movement characteristics is different form the first set of movement characteristics; and in accordance with a determination that the control corresponds to a second type of setting that is different from the first type of setting, configuring the physical input mechanism to have a third set of movement characteristics in response to detecting the rotation of the physical input mechanism, wherein the third set of movement characteristics is different from the second set of movement characteristics.

In some embodiments, a computer program product is described. In some embodiments, the computer program product comprises one or more programs configured to be executed by one or more processors of a computer system that is in communication with a physical input mechanism, the one or more programs including instructions for: while the physical input mechanism is configured to have a first set of movement characteristics in response to detecting a rotation of the physical input mechanism, for detecting an input directed to a control; and means, responsive to detecting the input directed to the control, for: in accordance with a determination that the control corresponds to a first type of setting, configuring the physical input mechanism to have a second set of movement characteristics in response to detecting the rotation of the physical input mechanism, wherein the second set of movement characteristics is different form the first set of movement characteristics; and in accordance with a determination that the control corresponds to a second type of setting that is different from the first type of setting, configuring the physical input mechanism to have a third set of movement characteristics in response to detecting the rotation of the physical input mechanism, wherein the third set of movement characteristics is different from the second set of movement characteristics.

In some embodiments, a method is performed at a computer system that is in communication with a physical input mechanism. In some embodiments, the method comprises: detecting an input directed to a control; and in response to detecting the input directed to the control: in accordance with a determination that the control corresponds to a first type of setting: displaying a first user interface object that corresponds to the first setting; and configuring the physical input mechanism to provide an output in response to detecting an input corresponding to a touch input on the physical input mechanism; and in accordance with a determination that the control corresponds to a second type of setting that is different form the first type of setting: displaying a second user interface object that corresponds to the second type of setting; and forgoing configuring the physical input mechanism to provide the output in response to detecting the input corresponding to the touch input on the physical input mechanism.

In some embodiments, a non-transitory computer-readable storage medium storing one or more programs configured to be executed by one or more processors of a computer system that is in communication with a physical input mechanism is described. In some embodiments, the one or more programs including instructions for: detecting an input directed to a control; and in response to detecting the input directed to the control: in accordance with a determination that the control corresponds to a first type of setting: displaying a first user interface object that corresponds to the first setting; and configuring the physical input mechanism to provide an output in response to detecting an input corresponding to a touch input on the physical input mechanism; and in accordance with a determination that the control corresponds to a second type of setting that is different form the first type of setting: displaying a second user interface object that corresponds to the second type of setting; and forgoing configuring the physical input mechanism to provide the output in response to detecting the input corresponding to the touch input on the physical input mechanism.

In some embodiments, a transitory computer-readable storage medium storing one or more programs configured to be executed by one or more processors of a computer system that is in communication with a physical input mechanism is described. In some embodiments, the one or more programs including instructions for: detecting an input directed to a control; and in response to detecting the input directed to the control: in accordance with a determination that the control corresponds to a first type of setting: displaying a first user interface object that corresponds to the first setting; and configuring the physical input mechanism to provide an output in response to detecting an input corresponding to a touch input on the physical input mechanism; and in accordance with a determination that the control corresponds to a second type of setting that is different form the first type of setting: displaying a second user interface object that corresponds to the second type of setting; and forgoing configuring the physical input mechanism to provide the output in response to detecting the input corresponding to the touch input on the physical input mechanism.

In some embodiments, a computer system configured to communicate with a physical input mechanism is described. In some embodiments, the computer system comprises: one or more processors; and memory storing one or more programs configured to be executed by the one or more processors, the one or more programs including instructions for: detecting an input directed to a control; and in response to detecting the input directed to the control: in accordance with a determination that the control corresponds to a first type of setting: displaying a first user interface object that corresponds to the first setting; and configuring the physical input mechanism to provide an output in response to detecting an input corresponding to a touch input on the physical input mechanism; and in accordance with a determination that the control corresponds to a second type of setting that is different form the first type of setting: displaying a second user interface object that corresponds to the second type of setting; and forgoing configuring the physical input mechanism to provide the output in response to detecting the input corresponding to the touch input on the physical input mechanism.

In some embodiments, a computer system configured to communicate with a physical input mechanism is described. In some embodiments, the computer system comprises: means for detecting an input directed to a control; and means, responsive to detecting the input directed to the control, for: in accordance with a determination that the control corresponds to a first type of setting: displaying a first user interface object that corresponds to the first setting; and configuring the physical input mechanism to provide an output in response to detecting an input corresponding to a touch input on the physical input mechanism; and in accordance with a determination that the control corresponds to a second type of setting that is different form the first type of setting: displaying a second user interface object that corresponds to the second type of setting; and forgoing configuring the physical input mechanism to provide the output in response to detecting the input corresponding to the touch input on the physical input mechanism.

In some embodiments, a computer program product is described. In some embodiments, the computer program product comprises one or more programs configured to be executed by one or more processors of a computer system that is in communication with a physical input mechanism, the one or more programs including instructions for: detecting an input directed to a control; and in response to detecting the input directed to the control: in accordance with a determination that the control corresponds to a first type of setting: displaying a first user interface object that corresponds to the first setting; and configuring the physical input mechanism to provide an output in response to detecting an input corresponding to a touch input on the physical input mechanism; and in accordance with a determination that the control corresponds to a second type of setting that is different form the first type of setting: displaying a second user interface object that corresponds to the second type of setting; and forgoing configuring the physical input mechanism to provide the output in response to detecting the input corresponding to the touch input on the physical input mechanism.

In some embodiments, a method is performed at a computer system that is in communication with a rotatable input mechanism. In some embodiments, the method comprises: detecting an input directed to a control; and in response to detecting the input directed to the control: in accordance with a determination that the control corresponds to a first type of setting, configuring the rotatable input mechanism to cause the computer system to perform one or more operations in response to a first set of inputs being directed to the rotatable input mechanism, including: performing a first operation in response to a first type of input being directed to the rotatable input mechanism; and performing a second operation in response to a second type of input being directed to the rotatable input mechanism, wherein the first operation is different from the second operation, and wherein the first type of input is different from the second type of input; and in accordance with a determination that the control corresponds to a second type of setting that is different from the first type of setting, configuring the rotatable input mechanism to cause the computer system to perform one or more operations in response to a second set of inputs, different from the first set of inputs, being directed to the rotatable input mechanism, including: performing the first operation in response to the first type of input being directed to the rotatable input mechanism; and forgoing performing an operation in response to the second type of input being directed to the rotatable input mechanism.

In some embodiments, a non-transitory computer-readable storage medium storing one or more programs configured to be executed by one or more processors of a computer system that is in communication with a rotatable input mechanism is described. In some embodiments, the one or more programs including instructions for: detecting an input directed to a control; and in response to detecting the input directed to the control: in accordance with a determination that the control corresponds to a first type of setting, configuring the rotatable input mechanism to cause the computer system to perform one or more operations in response to a first set of inputs being directed to the rotatable input mechanism, including: performing a first operation in response to a first type of input being directed to the rotatable input mechanism; and performing a second operation in response to a second type of input being directed to the rotatable input mechanism, wherein the first operation is different from the second operation, and wherein the first type of input is different from the second type of input; and in accordance with a determination that the control corresponds to a second type of setting that is different from the first type of setting, configuring the rotatable input mechanism to cause the computer system to perform one or more operations in response to a second set of inputs, different from the first set of inputs, being directed to the rotatable input mechanism, including: performing the first operation in response to the first type of input being directed to the rotatable input mechanism; and forgoing performing an operation in response to the second type of input being directed to the rotatable input mechanism.

In some embodiments, a transitory computer-readable storage medium storing one or more programs configured to be executed by one or more processors of a computer system that is in communication with a rotatable input mechanism is described. In some embodiments, the one or more programs including instructions for: detecting an input directed to a control; and in response to detecting the input directed to the control: in accordance with a determination that the control corresponds to a first type of setting, configuring the rotatable input mechanism to cause the computer system to perform one or more operations in response to a first set of inputs being directed to the rotatable input mechanism, including: performing a first operation in response to a first type of input being directed to the rotatable input mechanism; and performing a second operation in response to a second type of input being directed to the rotatable input mechanism, wherein the first operation is different from the second operation, and wherein the first type of input is different from the second type of input; and in accordance with a determination that the control corresponds to a second type of setting that is different from the first type of setting, configuring the rotatable input mechanism to cause the computer system to perform one or more operations in response to a second set of inputs, different from the first set of inputs, being directed to the rotatable input mechanism, including: performing the first operation in response to the first type of input being directed to the rotatable input mechanism; and forgoing performing an operation in response to the second type of input being directed to the rotatable input mechanism.

In some embodiments, a computer system configured to communicate with a rotatable input mechanism is described. In some embodiments, the computer system comprises: one or more processors; and memory storing one or more programs configured to be executed by the one or more processors, the one or more programs including instructions for: detecting an input directed to a control; and in response to detecting the input directed to the control: in accordance with a determination that the control corresponds to a first type of setting, configuring the rotatable input mechanism to cause the computer system to perform one or more operations in response to a first set of inputs being directed to the rotatable input mechanism, including: performing a first operation in response to a first type of input being directed to the rotatable input mechanism; and performing a second operation in response to a second type of input being directed to the rotatable input mechanism, wherein the first operation is different from the second operation, and wherein the first type of input is different from the second type of input; and in accordance with a determination that the control corresponds to a second type of setting that is different from the first type of setting, configuring the rotatable input mechanism to cause the computer system to perform one or more operations in response to a second set of inputs, different from the first set of inputs, being directed to the rotatable input mechanism, including: performing the first operation in response to the first type of input being directed to the rotatable input mechanism; and forgoing performing an operation in response to the second type of input being directed to the rotatable input mechanism.

In some embodiments, a computer system configured to communicate with a rotatable input mechanism is described. In some embodiments, the computer system comprises: means for detecting an input directed to a control; and means, responsive to detecting the input directed to the control, for in accordance with a determination that the control corresponds to a first type of setting, configuring the rotatable input mechanism to cause the computer system to perform one or more operations in response to a first set of inputs being directed to the rotatable input mechanism, including: performing a first operation in response to a first type of input being directed to the rotatable input mechanism; and performing a second operation in response to a second type of input being directed to the rotatable input mechanism, wherein the first operation is different from the second operation, and wherein the first type of input is different from the second type of input; and in accordance with a determination that the control corresponds to a second type of setting that is different from the first type of setting, configuring the rotatable input mechanism to cause the computer system to perform one or more operations in response to a second set of inputs, different from the first set of inputs, being directed to the rotatable input mechanism, including: performing the first operation in response to the first type of input being directed to the rotatable input mechanism; and forgoing performing an operation in response to the second type of input being directed to the rotatable input mechanism.

In some embodiments, a computer program product is described. In some embodiments, the computer program product comprises one or more programs configured to be executed by one or more processors of a computer system that is in communication with a rotatable input mechanism, the one or more programs including instructions for: detecting an input directed to a control; and means, responsive to detecting the input directed to the control, for in accordance with a determination that the control corresponds to a first type of setting, configuring the rotatable input mechanism to cause the computer system to perform one or more operations in response to a first set of inputs being directed to the rotatable input mechanism, including: performing a first operation in response to a first type of input being directed to the rotatable input mechanism; and performing a second operation in response to a second type of input being directed to the rotatable input mechanism, wherein the first operation is different from the second operation, and wherein the first type of input is different from the second type of input; and in accordance with a determination that the control corresponds to a second type of setting that is different from the first type of setting, configuring the rotatable input mechanism to cause the computer system to perform one or more operations in response to a second set of inputs, different from the first set of inputs, being directed to the rotatable input mechanism, including: performing the first operation in response to the first type of input being directed to the rotatable input mechanism; and forgoing performing an operation in response to the second type of input being directed to the rotatable input mechanism.

In some embodiments, a method is performed at a computer system that is in communication with a physical input mechanism. In some embodiments, the method comprises: detecting movement of the physical input mechanism from a first position and in a first direction; and while the physical input mechanism is moving in the first direction and in response to detecting movement of the physical input mechanism from the first position and in the first direction: in accordance with a determination that movement of the physical input mechanism is configured to change a first type of setting, causing the physical input mechanism to stop moving in the first direction after a second position is reached, wherein the second position is a first distance away from the first position; and in accordance with a determination that movement of the physical input mechanism is configured to change a second type of setting that is different from the first type of setting, causing the physical input mechanism to stop moving in the first direction after a third position is reached, wherein the third position is a second distance away from the first position, and wherein the first distance is different from the second distance.

In some embodiments, a non-transitory computer-readable storage medium storing one or more programs configured to be executed by one or more processors of a computer system that is in communication with a physical input mechanism is described. In some embodiments, the one or more programs including instructions for: detecting movement of the physical input mechanism from a first position and in a first direction; and while the physical input mechanism is moving in the first direction and in response to detecting movement of the physical input mechanism from the first position and in the first direction: in accordance with a determination that movement of the physical input mechanism is configured to change a first type of setting, causing the physical input mechanism to stop moving in the first direction after a second position is reached, wherein the second position is a first distance away from the first position; and in accordance with a determination that movement of the physical input mechanism is configured to change a second type of setting that is different from the first type of setting, causing the physical input mechanism to stop moving in the first direction after a third position is reached, wherein the third position is a second distance away from the first position, and wherein the first distance is different from the second distance.

In some embodiments, a transitory computer-readable storage medium storing one or more programs configured to be executed by one or more processors of a computer system that is in communication with a physical input mechanism is described. In some embodiments, the one or more programs including instructions for: detecting movement of the physical input mechanism from a first position and in a first direction; and while the physical input mechanism is moving in the first direction and in response to detecting movement of the physical input mechanism from the first position and in the first direction: in accordance with a determination that movement of the physical input mechanism is configured to change a first type of setting, causing the physical input mechanism to stop moving in the first direction after a second position is reached, wherein the second position is a first distance away from the first position; and in accordance with a determination that movement of the physical input mechanism is configured to change a second type of setting that is different from the first type of setting, causing the physical input mechanism to stop moving in the first direction after a third position is reached, wherein the third position is a second distance away from the first position, and wherein the first distance is different from the second distance.

In some embodiments, a computer system configured to communicate with a physical input mechanism is described. In some embodiments, the computer system comprises: one or more processors; and memory storing one or more programs configured to be executed by the one or more processors, the one or more programs including instructions for: detecting movement of the physical input mechanism from a first position and in a first direction; and while the physical input mechanism is moving in the first direction and in response to detecting movement of the physical input mechanism from the first position and in the first direction: in accordance with a determination that movement of the physical input mechanism is configured to change a first type of setting, causing the physical input mechanism to stop moving in the first direction after a second position is reached, wherein the second position is a first distance away from the first position; and in accordance with a determination that movement of the physical input mechanism is configured to change a second type of setting that is different from the first type of setting, causing the physical input mechanism to stop moving in the first direction after a third position is reached, wherein the third position is a second distance away from the first position, and wherein the first distance is different from the second distance.

In some embodiments, a computer system configured to communicate with a physical input mechanism is described. In some embodiments, the computer system comprises: means for detecting movement of the physical input mechanism from a first position and in a first direction; and means, while the physical input mechanism is moving in the first direction and in response to detecting movement of the physical input mechanism from the first position and in the first direction, for: in accordance with a determination that movement of the physical input mechanism is configured to change a first type of setting, causing the physical input mechanism to stop moving in the first direction after a second position is reached, wherein the second position is a first distance away from the first position; and in accordance with a determination that movement of the physical input mechanism is configured to change a second type of setting that is different from the first type of setting, causing the physical input mechanism to stop moving in the first direction after a third position is reached, wherein the third position is a second distance away from the first position, and wherein the first distance is different from the second distance.

In some embodiments, a computer program product is described. In some embodiments, the computer program product comprises one or more programs configured to be executed by one or more processors of a computer system that is in communication with a physical input mechanism, the one or more programs including instructions for: detecting movement of the physical input mechanism from a first position and in a first direction; and while the physical input mechanism is moving in the first direction and in response to detecting movement of the physical input mechanism from the first position and in the first direction: in accordance with a determination that movement of the physical input mechanism is configured to change a first type of setting, causing the physical input mechanism to stop moving in the first direction after a second position is reached, wherein the second position is a first distance away from the first position; and in accordance with a determination that movement of the physical input mechanism is configured to change a second type of setting that is different from the first type of setting, causing the physical input mechanism to stop moving in the first direction after a third position is reached, wherein the third position is a second distance away from the first position, and wherein the first distance is different from the second distance.

In some embodiments, a method is performed at a computer system that is in communication with a physical input mechanism. In some embodiments, the method comprises: detecting movement of the physical input mechanism; and in response to detecting movement of the physical input mechanism: in accordance with a determination that movement of the physical input mechanism is configured to change a first type of setting, causing the physical input mechanism to provide a first set of resistances while the physical input mechanism is moved by a respective amount; and in accordance with a determination that movement of the physical input mechanism is configured to change a second type of setting that is different from the first type of setting, causing the physical input mechanism to provide a second set of resistances, different from the first set of resistances, while the physical input mechanism is moved by the respective amount.

In some embodiments, a non-transitory computer-readable storage medium storing one or more programs configured to be executed by one or more processors of a computer system that is in communication with a physical input mechanism is described. In some embodiments, the one or more programs including instructions for: detecting movement of the physical input mechanism; and in response to detecting movement of the physical input mechanism: in accordance with a determination that movement of the physical input mechanism is configured to change a first type of setting, causing the physical input mechanism to provide a first set of resistances while the physical input mechanism is moved by a respective amount; and in accordance with a determination that movement of the physical input mechanism is configured to change a second type of setting that is different from the first type of setting, causing the physical input mechanism to provide a second set of resistances, different from the first set of resistances, while the physical input mechanism is moved by the respective amount.

In some embodiments, a transitory computer-readable storage medium storing one or more programs configured to be executed by one or more processors of a computer system that is in communication with a physical input mechanism is described. In some embodiments, the one or more programs including instructions for: detecting movement of the physical input mechanism; and in response to detecting movement of the physical input mechanism: in accordance with a determination that movement of the physical input mechanism is configured to change a first type of setting, causing the physical input mechanism to provide a first set of resistances while the physical input mechanism is moved by a respective amount; and in accordance with a determination that movement of the physical input mechanism is configured to change a second type of setting that is different from the first type of setting, causing the physical input mechanism to provide a second set of resistances, different from the first set of resistances, while the physical input mechanism is moved by the respective amount.

In some embodiments, a computer system configured to communicate with a physical input mechanism is described. In some embodiments, the computer system comprises: one or more processors; and memory storing one or more programs configured to be executed by the one or more processors, the one or more programs including instructions for: detecting movement of the physical input mechanism; and in response to detecting movement of the physical input mechanism: in accordance with a determination that movement of the physical input mechanism is configured to change a first type of setting, causing the physical input mechanism to provide a first set of resistances while the physical input mechanism is moved by a respective amount; and in accordance with a determination that movement of the physical input mechanism is configured to change a second type of setting that is different from the first type of setting, causing the physical input mechanism to provide a second set of resistances, different from the first set of resistances, while the physical input mechanism is moved by the respective amount.

In some embodiments, a computer system configured to communicate with a physical input mechanism is described. In some embodiments, the computer system comprises: means for detecting movement of the physical input mechanism; and means, responsive to detecting movement of the physical input mechanism, for: in accordance with a determination that movement of the physical input mechanism is configured to change a first type of setting, causing the physical input mechanism to provide a first set of resistances while the physical input mechanism is moved by a respective amount; and in accordance with a determination that movement of the physical input mechanism is configured to change a second type of setting that is different from the first type of setting, causing the physical input mechanism to provide a second set of resistances, different from the first set of resistances, while the physical input mechanism is moved by the respective amount.

In some embodiments, a computer program product is described. In some embodiments, the computer program product comprises one or more programs configured to be executed by one or more processors of a computer system that is in communication with a physical input mechanism, the one or more programs including instructions for: detecting movement of the physical input mechanism; and in response to detecting movement of the physical input mechanism: in accordance with a determination that movement of the physical input mechanism is configured to change a first type of setting, causing the physical input mechanism to provide a first set of resistances while the physical input mechanism is moved by a respective amount; and in accordance with a determination that movement of the physical input mechanism is configured to change a second type of setting that is different from the first type of setting, causing the physical input mechanism to provide a second set of resistances, different from the first set of resistances, while the physical input mechanism is moved by the respective amount.

In some embodiments, a method is performed at a computer system that is in communication with a physical input mechanism. In some embodiments, the method comprises: while detecting movement of the physical input mechanism in a first direction, detecting that the physical input mechanism is at a location that corresponds to a first position; and in response to detecting that the physical input mechanism is at the location that corresponds to the first position: in accordance with a determination that the first position is within a threshold distance from a respective position, causing the physical input mechanism to provide a set of haptics with intensity levels that change in a first manner as the physical mechanism is moved in the first direction.

In some embodiments, a non-transitory computer-readable storage medium storing one or more programs configured to be executed by one or more processors of a computer system that is in communication with a physical input mechanism is described. In some embodiments, the one or more programs including instructions for: while detecting movement of the physical input mechanism in a first direction, detecting that the physical input mechanism is at a location that corresponds to a first position; and in response to detecting that the physical input mechanism is at the location that corresponds to the first position: in accordance with a determination that the first position is within a threshold distance from a respective position, causing the physical input mechanism to provide a set of haptics with intensity levels that change in a first manner as the physical mechanism is moved in the first direction.

In some embodiments, a transitory computer-readable storage medium storing one or more programs configured to be executed by one or more processors of a computer system that is in communication with a physical input mechanism is described. In some embodiments, the one or more programs including instructions for: while detecting movement of the physical input mechanism in a first direction, detecting that the physical input mechanism is at a location that corresponds to a first position; and in response to detecting that the physical input mechanism is at the location that corresponds to the first position: in accordance with a determination that the first position is within a threshold distance from a respective position, causing the physical input mechanism to provide a set of haptics with intensity levels that change in a first manner as the physical mechanism is moved in the first direction.

In some embodiments, a computer system configured to communicate with a physical input mechanism is described. In some embodiments, the computer system comprises: one or more processors; and memory storing one or more programs configured to be executed by the one or more processors, the one or more programs including instructions for: while detecting movement of the physical input mechanism in a first direction, detecting that the physical input mechanism is at a location that corresponds to a first position; and in response to detecting that the physical input mechanism is at the location that corresponds to the first position: in accordance with a determination that the first position is within a threshold distance from a respective position, causing the physical input mechanism to provide a set of haptics with intensity levels that change in a first manner as the physical mechanism is moved in the first direction.

In some embodiments, a computer system configured to communicate with a physical input mechanism is described. In some embodiments, the computer system comprises: means, while detecting movement of the physical input mechanism in a first direction, for detecting that the physical input mechanism is at a location that corresponds to a first position; and means, responsive to detecting that the physical input mechanism is at the location that corresponds to the first position, for: in accordance with a determination that the first position is within a threshold distance from a respective position, causing the physical input mechanism to provide a set of haptics with intensity levels that change in a first manner as the physical mechanism is moved in the first direction.

In some embodiments, a computer program product is described. In some embodiments, the computer program product comprises one or more programs configured to be executed by one or more processors of a computer system that is in communication with a physical input mechanism, the one or more programs including instructions for: while detecting movement of the physical input mechanism in a first direction, detecting that the physical input mechanism is at a location that corresponds to a first position; and in response to detecting that the physical input mechanism is at the location that corresponds to the first position: in accordance with a determination that the first position is within a threshold distance from a respective position, causing the physical input mechanism to provide a set of haptics with intensity levels that change in a first manner as the physical mechanism is moved in the first direction.

In some embodiments, a method is performed at a computer system that is in communication with a physical input mechanism. In some embodiments, the method comprises: detecting an input directed to a control; and in response to detecting the input directed to the control: in accordance with a determination that the control corresponds to a first type of setting, configuring the physical input mechanism such that the physical input mechanism moves to a first position after input directed to the physical input mechanism is no longer detected; and in accordance with a determination that the control corresponds to a second type of setting that is different from the first type of setting, forgoing configuring the physical input mechanism such that the physical input mechanism moves to the first position after input directed to the physical input mechanism is no longer detected.

In some embodiments, a non-transitory computer-readable storage medium storing one or more programs configured to be executed by one or more processors of a computer system that is in communication with a physical input mechanism is described. In some embodiments, the one or more programs including instructions for: detecting an input directed to a control; and in response to detecting the input directed to the control: in accordance with a determination that the control corresponds to a first type of setting, configuring the physical input mechanism such that the physical input mechanism moves to a first position after input directed to the physical input mechanism is no longer detected; and in accordance with a determination that the control corresponds to a second type of setting that is different from the first type of setting, forgoing configuring the physical input mechanism such that the physical input mechanism moves to the first position after input directed to the physical input mechanism is no longer detected.

In some embodiments, a transitory computer-readable storage medium storing one or more programs configured to be executed by one or more processors of a computer system that is in communication with a physical input mechanism is described. In some embodiments, the one or more programs including instructions for: detecting an input directed to a control; and in response to detecting the input directed to the control: in accordance with a determination that the control corresponds to a first type of setting, configuring the physical input mechanism such that the physical input mechanism moves to a first position after input directed to the physical input mechanism is no longer detected; and in accordance with a determination that the control corresponds to a second type of setting that is different from the first type of setting, forgoing configuring the physical input mechanism such that the physical input mechanism moves to the first position after input directed to the physical input mechanism is no longer detected.

In some embodiments, a computer system configured to communicate with a physical input mechanism is described. In some embodiments, the computer system comprises: one or more processors; and memory storing one or more programs configured to be executed by the one or more processors, the one or more programs including instructions for: detecting an input directed to a control; and in response to detecting the input directed to the control: in accordance with a determination that the control corresponds to a first type of setting, configuring the physical input mechanism such that the physical input mechanism moves to a first position after input directed to the physical input mechanism is no longer detected; and in accordance with a determination that the control corresponds to a second type of setting that is different from the first type of setting, forgoing configuring the physical input mechanism such that the physical input mechanism moves to the first position after input directed to the physical input mechanism is no longer detected.

In some embodiments, a computer system configured to communicate with a physical input mechanism is described. In some embodiments, the computer system comprises: means for detecting an input directed to a control; and means, responsive to detecting the input directed to the control, for: in accordance with a determination that the control corresponds to a first type of setting, configuring the physical input mechanism such that the physical input mechanism moves to a first position after input directed to the physical input mechanism is no longer detected; and in accordance with a determination that the control corresponds to a second type of setting that is different from the first type of setting, forgoing configuring the physical input mechanism such that the physical input mechanism moves to the first position after input directed to the physical input mechanism is no longer detected.

In some embodiments, a computer program product is described. In some embodiments, the computer program product comprises one or more programs configured to be executed by one or more processors of a computer system that is in communication with a physical input mechanism, the one or more programs including instructions for: detecting an input directed to a control; and in response to detecting the input directed to the control: in accordance with a determination that the control corresponds to a first type of setting, configuring the physical input mechanism such that the physical input mechanism moves to a first position after input directed to the physical input mechanism is no longer detected; and in accordance with a determination that the control corresponds to a second type of setting that is different from the first type of setting, forgoing configuring the physical input mechanism such that the physical input mechanism moves to the first position after input directed to the physical input mechanism is no longer detected.

In some embodiments, a method is performed at a computer system that is in communication with a rotatable input mechanism and an output device. In some embodiments, the method comprises: while detecting that the rotatable input mechanism is rotating in a first direction, causing the output device to adjust an output in a first manner based on the rotatable input mechanism rotating in the first direction; while causing the output device to adjust the output based on the rotatable input mechanism rotating in the first direction, detecting the rotatable input mechanism is rotating in a second direction that is different from the first direction; and in response to detecting that the rotatable input mechanism is rotating in the second direction: in accordance with the rotatable input mechanism rotating a first amount in the first direction before rotating in the second direction, causing the output device to adjust output in a second manner based on rotation of the rotatable input mechanism; and in accordance with the rotatable input mechanism rotating a second amount in the first direction before rotating in the second direction, wherein the second amount is greater than the first amount, forgoing causing the output device to adjust output in the second manner based on rotation of the rotatable input mechanism.

In some embodiments, a non-transitory computer-readable storage medium storing one or more programs configured to be executed by one or more processors of a computer system that is in communication with a rotatable input mechanism and an output device is described. In some embodiments, the one or more programs including instructions for: while detecting that the rotatable input mechanism is rotating in a first direction, causing the output device to adjust an output in a first manner based on the rotatable input mechanism rotating in the first direction; while causing the output device to adjust the output based on the rotatable input mechanism rotating in the first direction, detecting the rotatable input mechanism is rotating in a second direction that is different from the first direction; and in response to detecting that the rotatable input mechanism is rotating in the second direction: in accordance with the rotatable input mechanism rotating a first amount in the first direction before rotating in the second direction, causing the output device to adjust output in a second manner based on rotation of the rotatable input mechanism; and in accordance with the rotatable input mechanism rotating a second amount in the first direction before rotating in the second direction, wherein the second amount is greater than the first amount, forgoing causing the output device to adjust output in the second manner based on rotation of the rotatable input mechanism.

In some embodiments, a transitory computer-readable storage medium storing one or more programs configured to be executed by one or more processors of a computer system that is in communication with a rotatable input mechanism and an output device is described. In some embodiments, the one or more programs including instructions for: while detecting that the rotatable input mechanism is rotating in a first direction, causing the output device to adjust an output in a first manner based on the rotatable input mechanism rotating in the first direction; while causing the output device to adjust the output based on the rotatable input mechanism rotating in the first direction, detecting the rotatable input mechanism is rotating in a second direction that is different from the first direction; and in response to detecting that the rotatable input mechanism is rotating in the second direction: in accordance with the rotatable input mechanism rotating a first amount in the first direction before rotating in the second direction, causing the output device to adjust output in a second manner based on rotation of the rotatable input mechanism; and in accordance with the rotatable input mechanism rotating a second amount in the first direction before rotating in the second direction, wherein the second amount is greater than the first amount, forgoing causing the output device to adjust output in the second manner based on rotation of the rotatable input mechanism.

In some embodiments, a computer system configured to communicate with a rotatable input mechanism and an output device is described. In some embodiments, the computer system comprises: one or more processors; and memory storing one or more programs configured to be executed by the one or more processors, the one or more programs including instructions for: while detecting that the rotatable input mechanism is rotating in a first direction, causing the output device to adjust an output in a first manner based on the rotatable input mechanism rotating in the first direction; while causing the output device to adjust the output based on the rotatable input mechanism rotating in the first direction, detecting the rotatable input mechanism is rotating in a second direction that is different from the first direction; and in response to detecting that the rotatable input mechanism is rotating in the second direction: in accordance with the rotatable input mechanism rotating a first amount in the first direction before rotating in the second direction, causing the output device to adjust output in a second manner based on rotation of the rotatable input mechanism; and in accordance with the rotatable input mechanism rotating a second amount in the first direction before rotating in the second direction, wherein the second amount is greater than the first amount, forgoing causing the output device to adjust output in the second manner based on rotation of the rotatable input mechanism.

In some embodiments, a computer system configured to communicate with a rotatable input mechanism and an output device is described. In some embodiments, the computer system comprises: means, while detecting that the rotatable input mechanism is rotating in a first direction, for causing the output device to adjust an output in a first manner based on the rotatable input mechanism rotating in the first direction; means, while causing the output device to adjust the output based on the rotatable input mechanism rotating in the first direction, for detecting the rotatable input mechanism is rotating in a second direction that is different from the first direction; and means, responsive to detecting that the rotatable input mechanism is rotating in the second direction, for: in accordance with the rotatable input mechanism rotating a first amount in the first direction before rotating in the second direction, causing the output device to adjust output in a second manner based on rotation of the rotatable input mechanism; and in accordance with the rotatable input mechanism rotating a second amount in the first direction before rotating in the second direction, wherein the second amount is greater than the first amount, forgoing causing the output device to adjust output in the second manner based on rotation of the rotatable input mechanism.

In some embodiments, a computer program product is described. In some embodiments, the computer program product comprises one or more programs configured to be executed by one or more processors of a computer system that is in communication with a rotatable input mechanism and an output device, the one or more programs including instructions for: while detecting that the rotatable input mechanism is rotating in a first direction, causing the output device to adjust an output in a first manner based on the rotatable input mechanism rotating in the first direction; while causing the output device to adjust the output based on the rotatable input mechanism rotating in the first direction, detecting the rotatable input mechanism is rotating in a second direction that is different from the first direction; and in response to detecting that the rotatable input mechanism is rotating in the second direction: in accordance with the rotatable input mechanism rotating a first amount in the first direction before rotating in the second direction, causing the output device to adjust output in a second manner based on rotation of the rotatable input mechanism; and in accordance with the rotatable input mechanism rotating a second amount in the first direction before rotating in the second direction, wherein the second amount is greater than the first amount, forgoing causing the output device to adjust output in the second manner based on rotation of the rotatable input mechanism.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for using input mechanisms, thereby increasing the effectiveness, efficiency, and user satisfaction with such devices. Such methods and interfaces may complement or replace other methods for using input mechanisms.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6G illustrate exemplary user interfaces for using an input mechanism in accordance with some embodiments.

FIG. 7 is a flow diagram illustrating a method for changing movement characteristics of an input mechanism using a computer system in accordance with some embodiments.

FIG. 8 is a flow diagram illustrating a method for changing a haptic of an input mechanism using a computer system in accordance with some embodiments.

FIG. 9 is a flow diagram illustrating a method for changing inputs for which an input mechanism is responsive using a computer system in accordance with some embodiments.

FIGS. 10A-10D illustrate exemplary user interfaces for using an input mechanism in accordance with some embodiments.

FIG. 11 is a flow diagram illustrating a method for changing a lock position of an input mechanism in accordance with some embodiments.

FIG. 12 is a flow diagram illustrating a method for rubber-banding with an input mechanism using a computer system in accordance with some embodiments.

FIG. 13 is a flow diagram illustrating a method for outputting haptics with an input mechanism using a computer system in accordance with some embodiments.

FIGS. 14A-14D illustrate exemplary user interfaces for using an input mechanism in accordance with some embodiments.

FIG. 15 is a flow diagram illustrating a method for a physical input mechanism using a computer system in accordance with some embodiments.

FIG. 16 is a flow diagram illustrating a method for a rotatable input mechanism using a computer system in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for using an input mechanism. Such techniques can reduce the cognitive burden on a user who using the input mechanism, thereby enhancing productivity. Further, such techniques can reduce processor and battery power otherwise wasted on redundant user inputs.

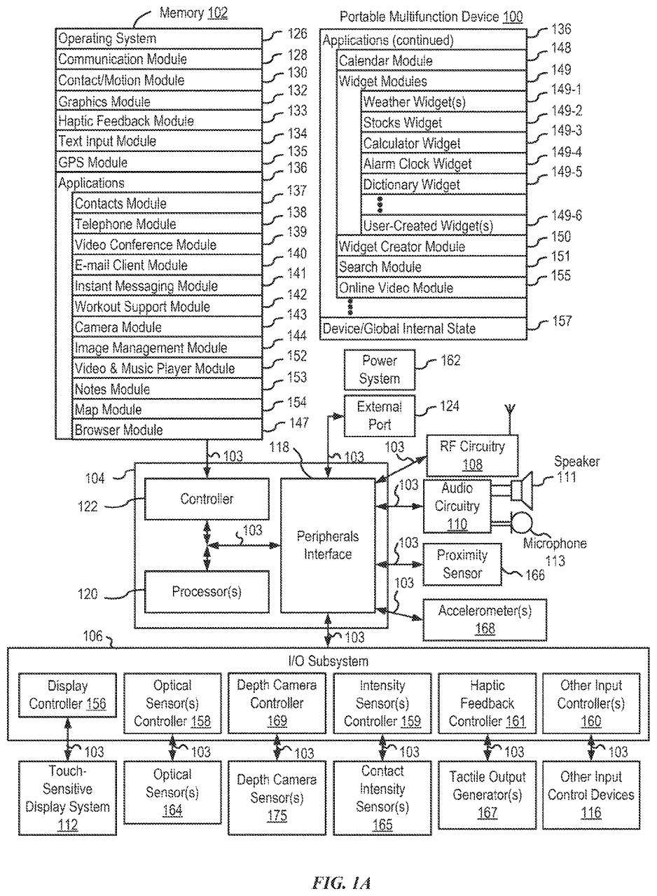

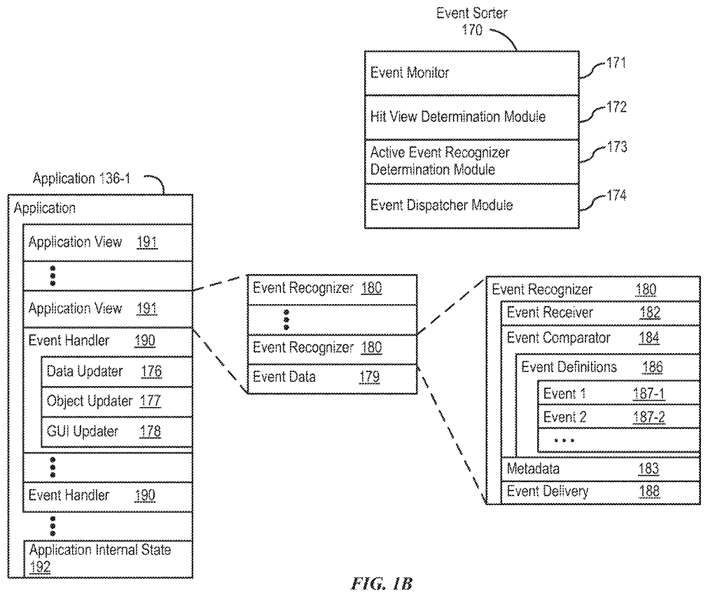

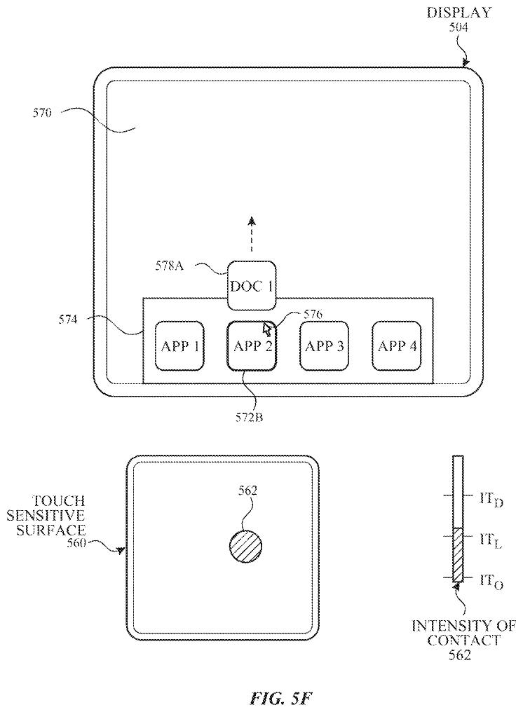

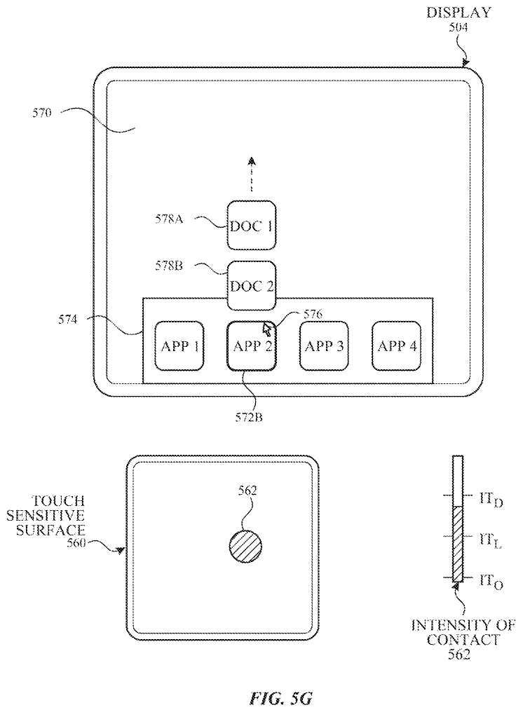

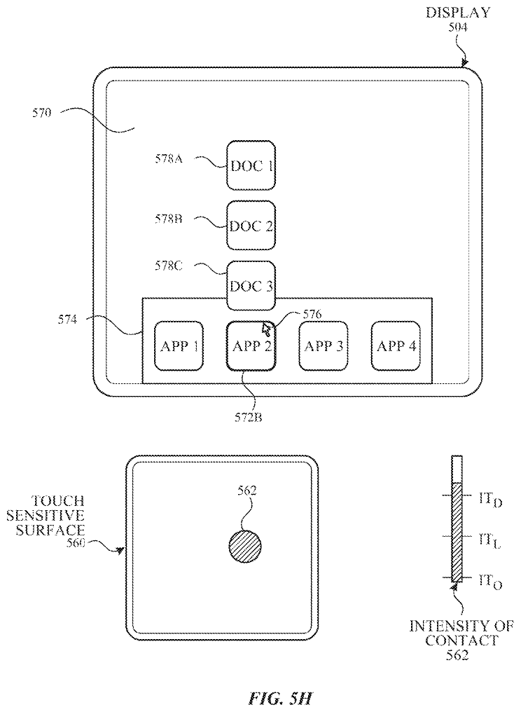

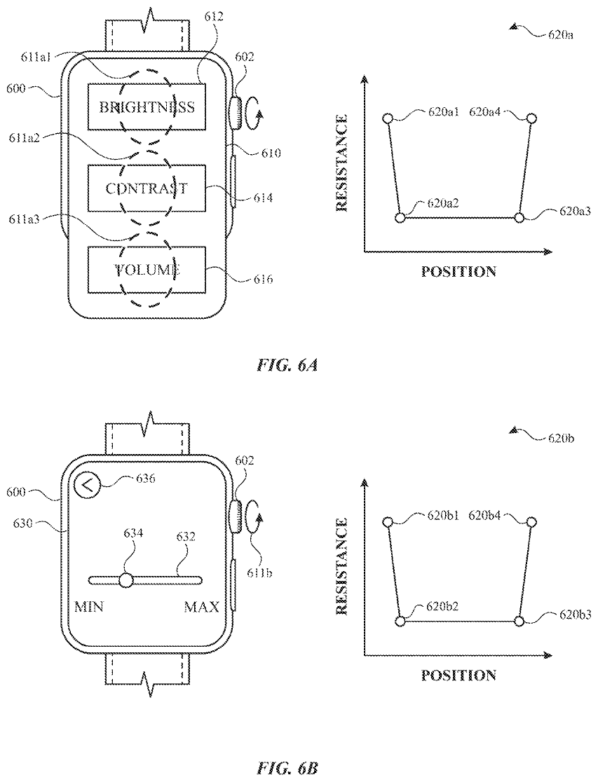

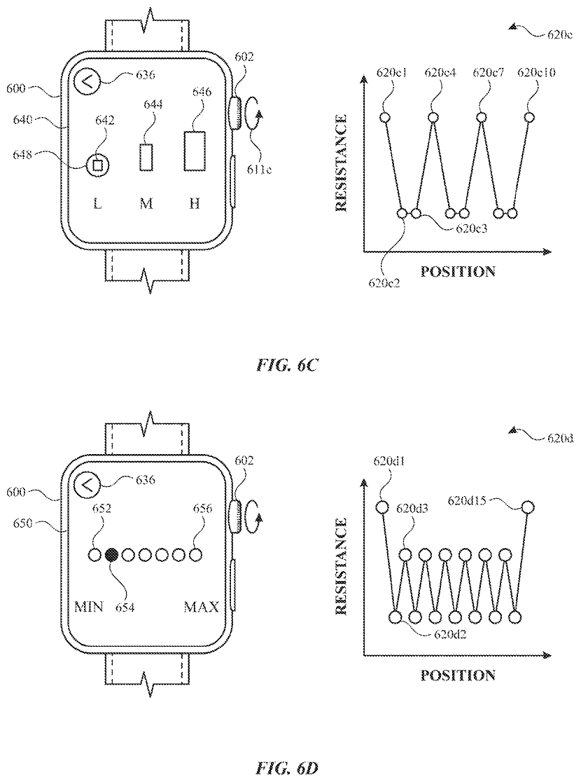

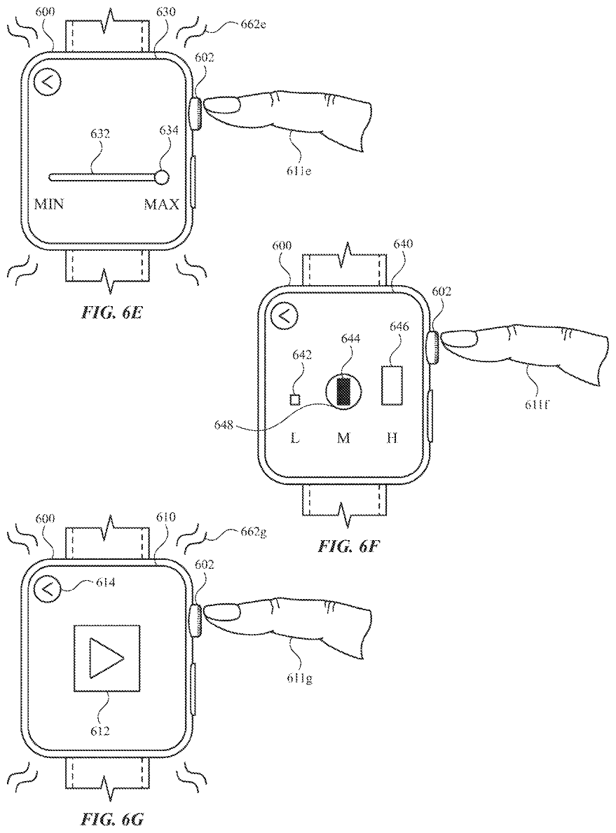

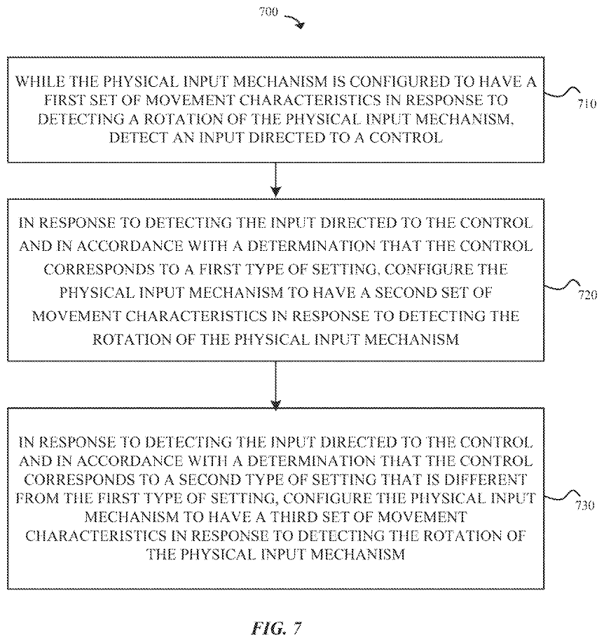

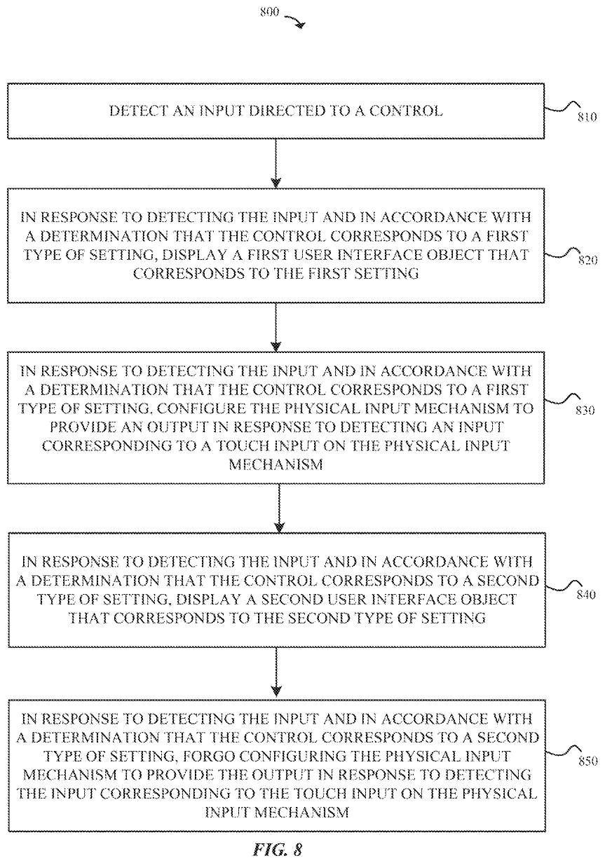

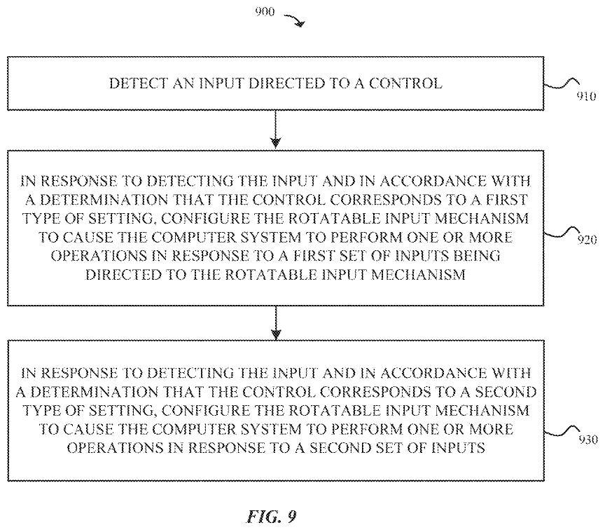

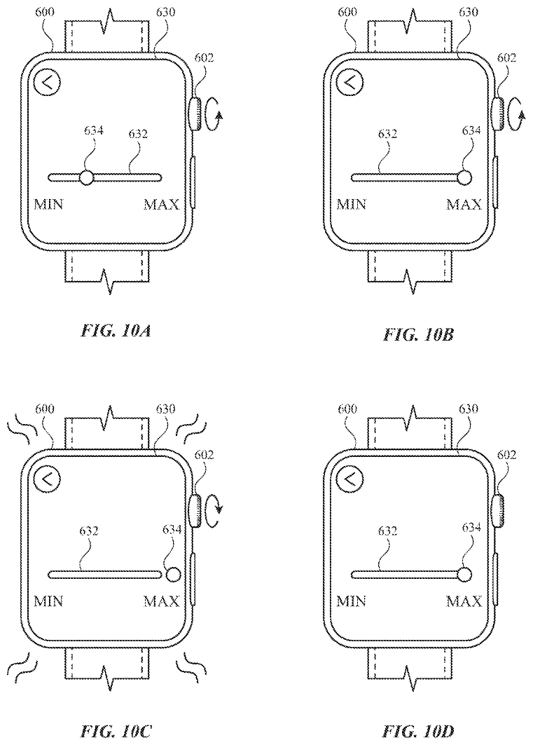

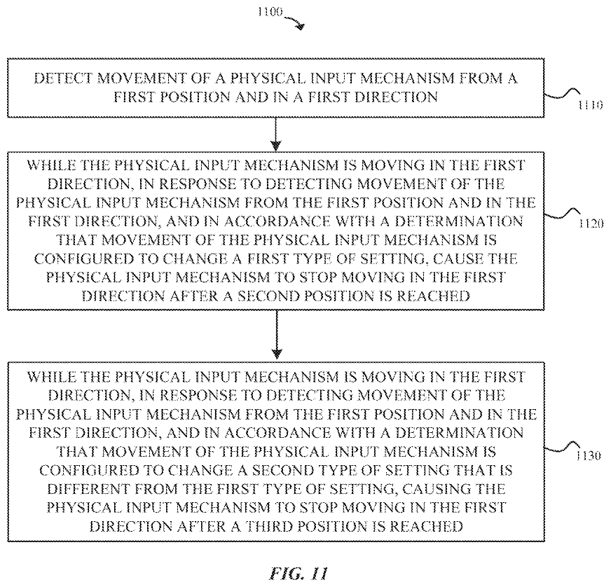

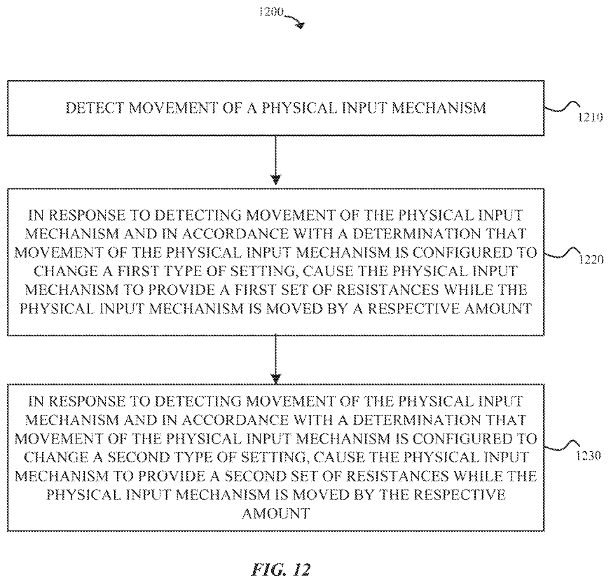

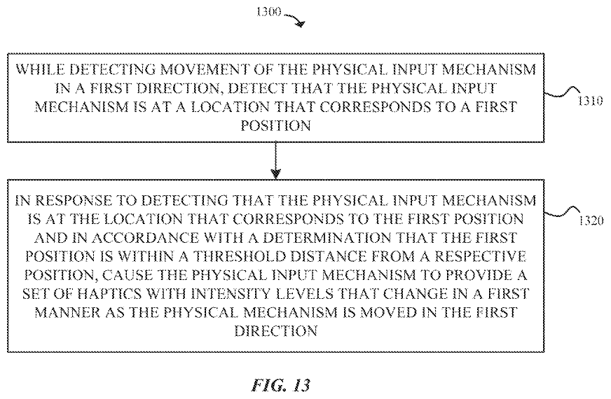

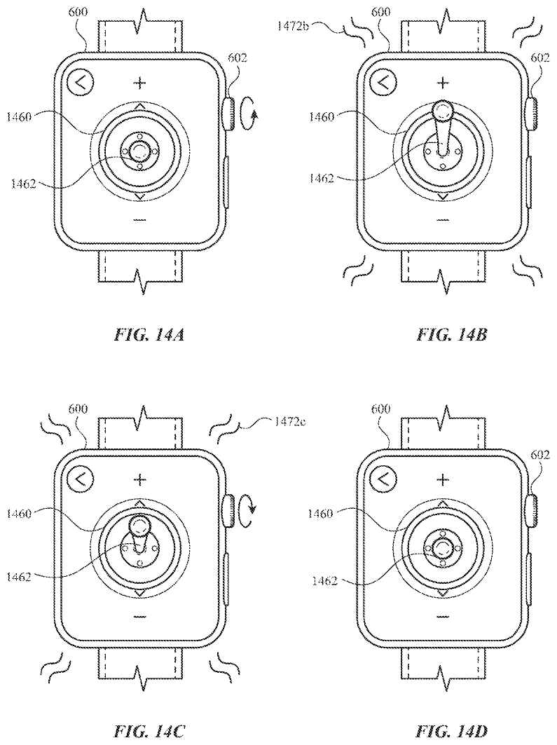

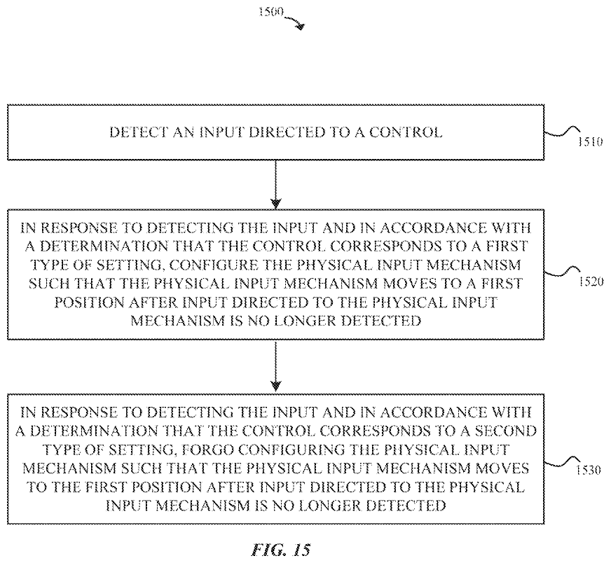

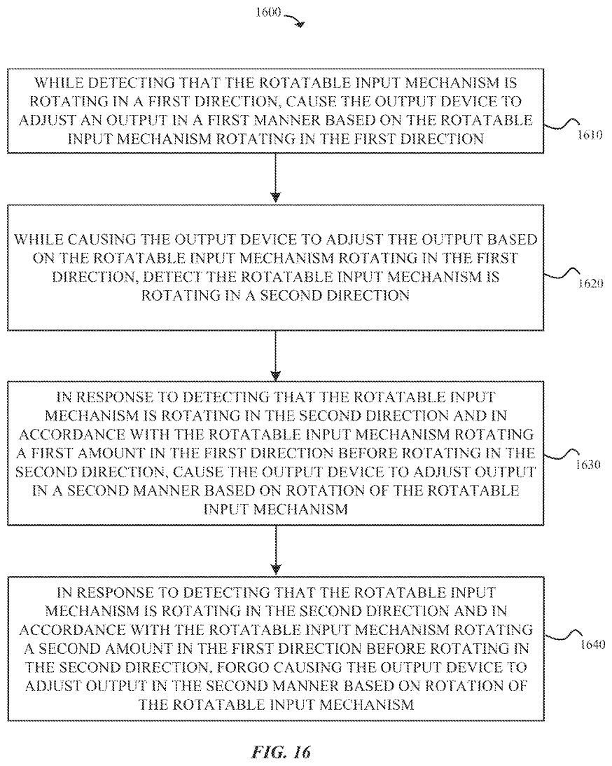

Below, FIGS. 1A-1B, 2, 3, 4A-4B, and 5A-5H provide a description of exemplary devices for performing the techniques for using an input mechanism. FIGS. 6A-6G illustrate exemplary user interfaces for using an input mechanism. FIG. 7 is a flow diagram illustrating a method for changing movement characteristics of an input mechanism in accordance with some embodiments. FIG. 8 is a flow diagram illustrating a method for changing a haptic of an input mechanism in accordance with some embodiments. FIG. 9 is a flow diagram illustrating a method for changing inputs for which an input mechanism is responsive in accordance with some embodiments. The user interfaces in FIGS. 6A-6G are used to illustrate the processes described below, including the processes in FIGS. 7, 8, and 9. FIGS. 10A-10D illustrate exemplary user interfaces for using an input mechanism. FIG. 11 is a flow diagram illustrating a method for changing a lock position of an input mechanism in accordance with some embodiments. FIG. 12 is a flow diagram illustrating a method for rubber-banding with an input mechanism using a computer system in accordance with some embodiments. FIG. 13 is a flow diagram illustrating a method for outputting haptics with an input mechanism using a computer system in accordance with some embodiments. The user interfaces in FIGS. 6A-6G and 10A-10D are used to illustrate the processes described below, including the processes in FIGS. 11, 12, and 13. FIGS. 14A-14D illustrate exemplary user interfaces for using an input mechanism. FIG. 15 is a flow diagram illustrating a method for a physical input mechanism using a computer system in accordance with some embodiments. FIG. 16 is a flow diagram illustrating a method for a rotatable input mechanism using a computer system in accordance with some embodiments. The user interfaces in FIGS. 6A-6G and 14A-14D are used to illustrate the processes described below, including the processes in FIGS. 15 and 16.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

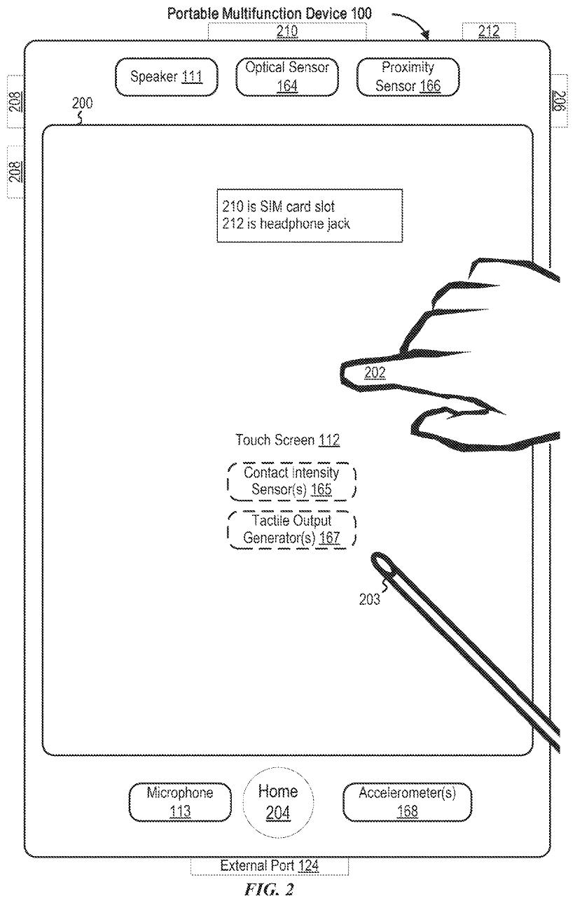

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse.

The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. no. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106.

Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175.

FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Nos. Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface.

Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information.

Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118.

Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170.

Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180.

Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192.

Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

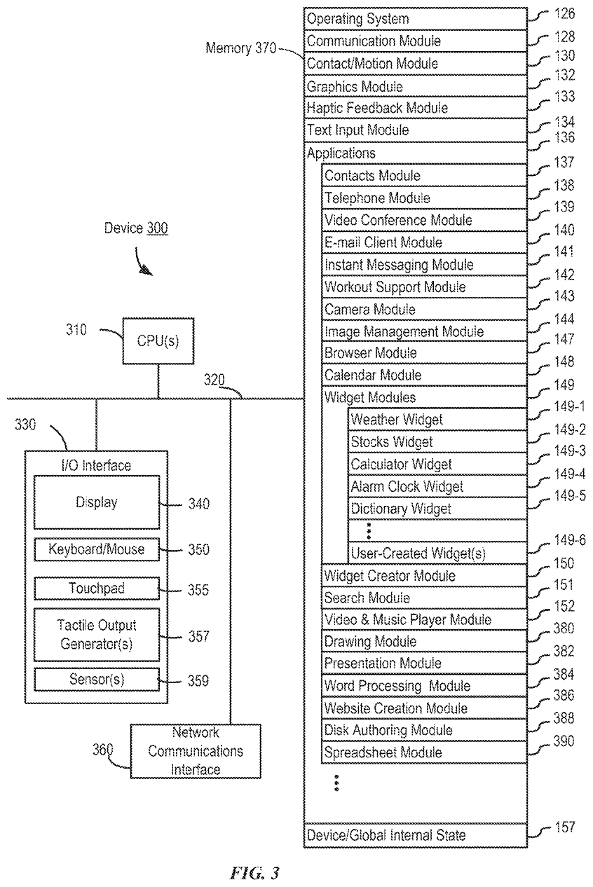

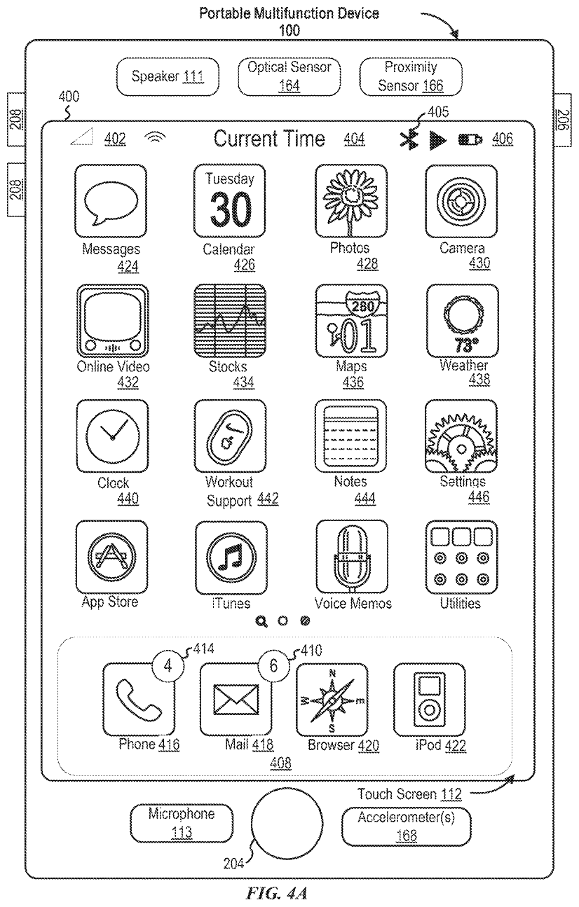

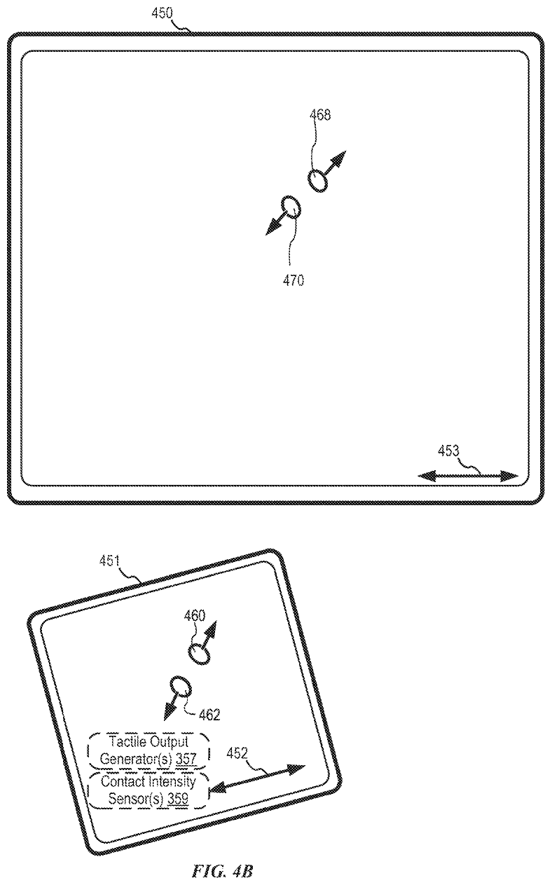

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIGS. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

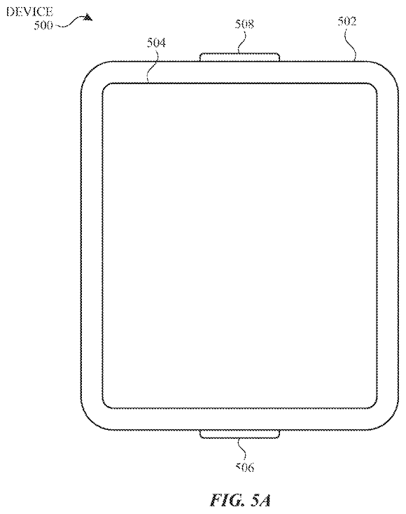

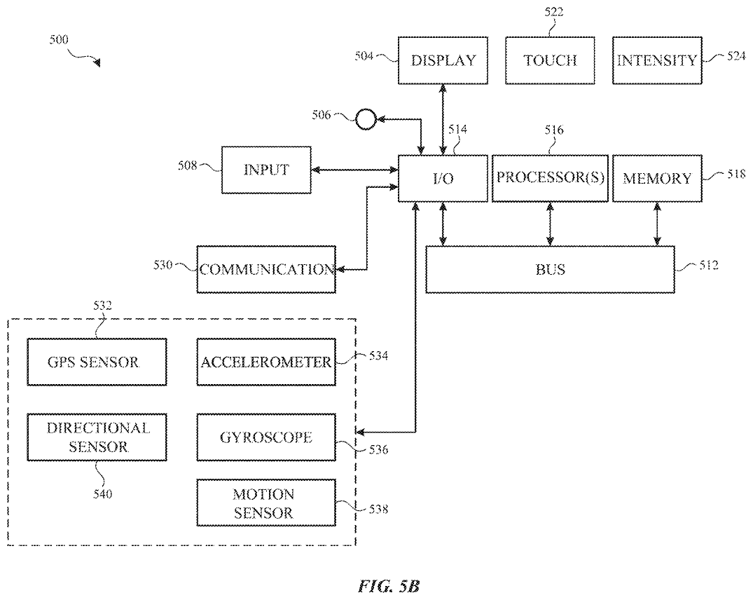

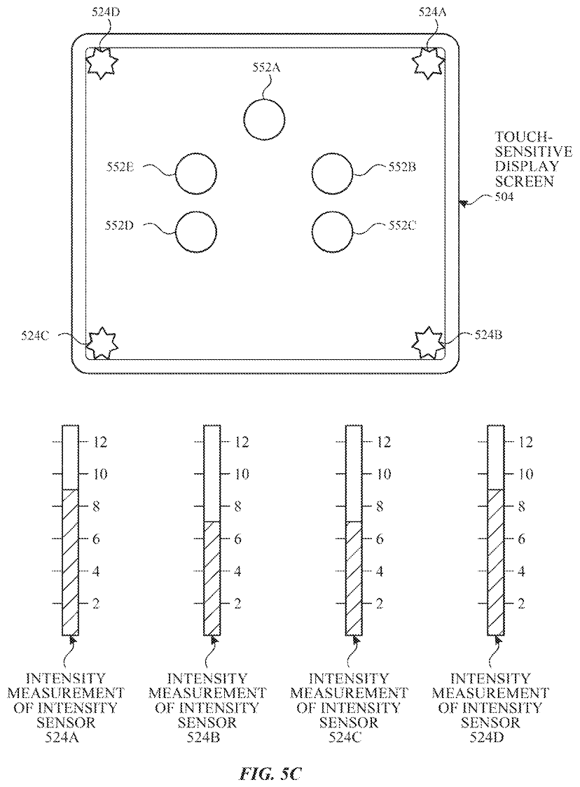

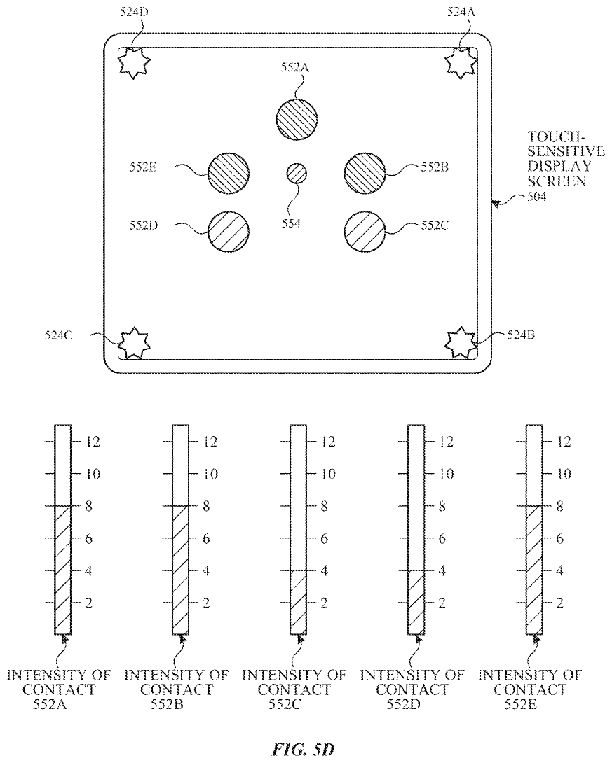

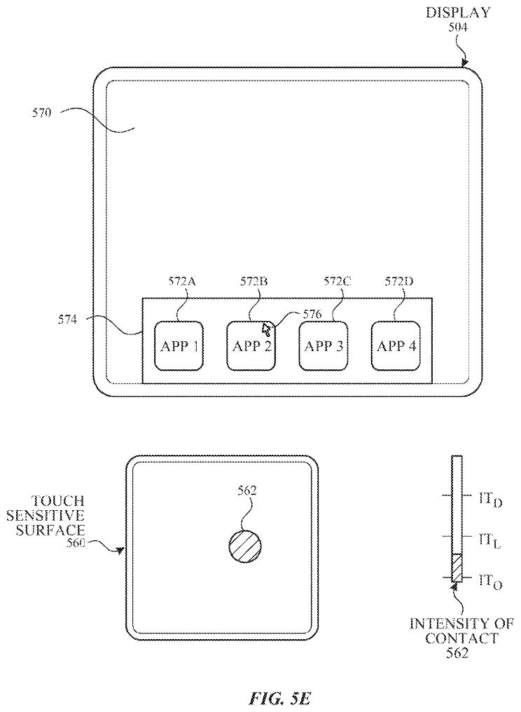

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No.

PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No.

PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques.

Device 500 can include input mechanisms 506 and/or 508. Input mechanism 506 is, optionally, a rotatable input device, for example. Input mechanism 508 is, optionally, a button, in some embodiments.

Input mechanism 508 is, optionally, a microphone, in some embodiments. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-900 (FIGS. 7-9, 11-13, and 15-16). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input).

Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6G illustrate exemplary user interfaces for using an input mechanism in accordance with some embodiments. The user interfaces in these figures are used to illustrate the processes described below, including the processes in FIGS. 7, 8, 9, 11, 12, 13, 15, and 16.

Amongst other techniques, FIGS. 6A-6G will be used to discuss one or more techniques concerning a rotatable input mechanism that moves and responds differently to inputs based on different settings that the rotatable input mechanism is configured to control. In addition to other techniques, FIGS. 6A-6G will also be used to discussed one or more techniques concerning a computer system's response to inputs that are directed to the rotatable input mechanism.

FIG. 6A illustrates computer system 600 displaying an exemplary user interface to illustrate the techniques and processes described below. Computer system 600 includes rotatable input mechanism 602 and a display (e.g., a display generation component), which are positioned on a housing of computer system 600. In FIG. 6A, rotatable input mechanism 602 and the display are physically and electronically coupled to computer system 600 via the housing of computer system 600. In some embodiments, one or more of the display of computer system 600 and rotatable input mechanism 602 are not physically coupled to computer system 600, and instead, computer system 600 is coupled wirelessly to one or more of rotatable input mechanism 602 and the display of computer system 600. In some embodiments, rotatable input mechanism 602 is not physically coupled to the same computer system as the display of computer system 600. In some embodiments, rotatable input mechanism is depressible.

As further discussed below, in response to detecting an input corresponding to a rotation of, a press on, a push on, and/or a tap on rotatable input mechanism 602, computer system 600 performs one or more operations that, optionally, include computer system 600 updating display of a user interface. In some embodiments, an input described as a rotation of, a press on, or a tap on rotatable input mechanism 602 (or an input directed to the display of computer system 600) can be substituted for one or more other types of inputs. In some embodiments, the one or more other types of inputs include, but are not limited to, air gestures and/or gaze inputs that are detected by one or more sensors of computer system 600, such as one or more heart rate sensors, gyroscopes, motion sensors, and/or cameras that are in communication with and/or that are included in computer system 600. In some embodiments, the one or more other types of inputs include, but are not limited to, mouse clicks, press-and-hold inputs, mouse click and drag inputs, and/or dragging inputs.

As illustrated in FIG. 6A, rotatable input mechanism 602 is a crown of a smartwatch and/or fitness tracking device (e.g., computer system 600). However, in some embodiments, rotatable input mechanism 602 is a knob, a dial, a joystick, a surface, a rotatable button, and/or a slider. In some embodiments, the size of rotatable input mechanism 602 in relation to computer system 600 is different from the size of rotatable input mechanism 602 in relation to computer system 600 illustrated in FIG. 6A. In some embodiments, rotatable input mechanism 602 is bigger than computer system 600. In some embodiments, computer system 600 is not a smartwatch and is a different computer system, such as a phone, a tablet, a touch-screen display, and/or a personal computing device. In some embodiments, computer system 600 is in communication with one or more devices (e.g., smart home devices (e.g., a heater, a fan, a window, a door lock, a light, and/or blinds) and/or entertainment devices (e.g., a speaker and/or a television)). In some embodiments, rotatable input mechanism 620 is a part of a platform, such as a vehicle (e.g., an automobile) and/or smart home devices, and computer system 600 is configured to adjust one or more settings of the platform via rotational input mechanism 620, such as temperature, volume, window opening, window tint, cabin light brightness, and the like. In some embodiments, rotatable input mechanism 620 is not physically coupled to one or more of the devices that are impacted by the changed in the one or more settings. In some embodiments, rotatable input mechanism 620 is a part of a platform, such as a vehicle (e.g., an automobile) and/or smart home devices, and computer system 600 is configured to adjust one or more settings of the platform via rotational input mechanism 620, such as temperature, volume, window opening, window tint, cabin light brightness, and the like. In some embodiments, rotatable input mechanism 620 is not physically coupled to one or more of the devices that are impacted by the changed in the one or more settings. In some embodiments, computer system 600 includes these one or more devices although computer system 600 is, optionally, not physically coupled to these one or more devices. In some embodiments, computer system 600 includes one or more features and/or components of computer systems 100, 300, and/or 500 described above.

As illustrated in FIG. 6A, computer system 600 displays user interface 610 that includes brightness setting control 612, contrast setting control 614, and volume setting control 616. At FIG. 6A, rotatable input mechanism 602 is configured to have movement characteristics as shown in movement characteristics graph 620a. It should be understood that the movement characteristics described in relation to movement characteristics graph 620a are for exemplary purposes only and other movement characteristics could be provided while computer system 600 displays the user interface of FIG. 6A (e.g., which also applies to other movement characteristics and movement characteristic graphs discussed herein). At FIG. 6A, movement characteristics graph 620a includes positions 620a1-620a3, which represent positions of rotatable input mechanism 620. Movement characteristics graph 620a indicates that rotatable input mechanism 602 is configured to have a set of movement characteristics, where rotatable input mechanism 602 is harder to move while rotatable input mechanism 602 is being rotated closer to a terminal position (e.g., an endpoint position and/or a position corresponding to a minimum or maximum value for a setting) than when rotatable input mechanism 602 is not being rotated closer to a terminal position. At FIG. 6A, position 620a1 corresponds to a minimum position (e.g., a position that corresponds to a minimum value for a setting and/or a terminal position). In response to rotatable input mechanism 602 being rotated clockwise (and, in some embodiments, counterclockwise) towards a maximum position (e.g., represented by 620a4) (e.g., a position that corresponds to a maximum value for a setting and/or a terminal position), computer system 600 causes rotatable input mechanism 602 to ramp down the level of resistance (e.g., decrease the level of resistance over an amount that rotatable input mechanism 602 is moved) provided until rotatable input mechanism 602 reaches position 620a2. If rotatable input mechanism 602 continues to be rotated in the clockwise direction from position 620a2 to position 620a3, computer system 600 causes rotatable input mechanism 602 to provide a consistent and lower level of resistance (and, in some embodiments, no resistance) than the levels of resistance provided between position 620a1 and position 620a2. Moreover, if rotatable input mechanism 602 is further rotated in the clockwise direction from position 620a3 to position 620a4, computer system 600 causes rotatable input mechanism to ramp up the level of resistance from position 620a3 until position 620a4 (e.g., a maximum position and/or terminal position) is reached. In some embodiments, at position 620a4, computer system 600 causes rotatable input mechanism 602 to provide a high level of resistance, such that rotatable input mechanism 602 cannot be rotated further in the clockwise direction.

FIGS. 6B-6D illustrate exemplary user interfaces to discuss techniques concerning how the movement characteristics of the rotatable input mechanism can changed based on a setting that the rotatable input mechanism is configured to control. At FIG. 6A, computer system 600 detects tap input 611a1 on brightness setting control 612, tap input 611a2 on contrast setting control 614, or tap input 611a3 on volume setting control 616. As discussed above, in some embodiments, tap inputs 611a1-611a3 could be one or more other inputs, such as air gestures, gaze inputs, mouse clicks, and/or one or more other inputs.

As illustrated in FIG. 6B, in response to detecting tap input 611a on brightness setting control 612, computer system 600 displays brightness setting user interface 630 that includes brightness slider 632 and current brightness value indicator 634. Brightness slider 632 indicates a range of values to which the current brightness value can be set. Current brightness value indicator 634 indicates a value of the range of values to which the current brightness value is set. In response to detecting a rotation (e.g., a clockwise or counterclockwise) of rotatable input mechanism 602, computer system 600 moves display of current brightness value indicator 634 in a direction (e.g., left or right at FIG. 6B) that corresponds to the direction (e.g., counterclockwise or clockwise) of the rotation of rotatable input mechanism 602. In some embodiments, while moving display of current brightness value indicator 634, computer system 600 causes output (e.g., light) of one or more devices (e.g., brightness of a kitchen light and/or brightness of a display) to change based on the updated position of current brightness value indicator 634 on brightness slider 632. In some embodiments, computer system 600 causes output of the one or more devices to change after current brightness value indicator 634 stops moving and/or after the rotation of rotatable input mechanism 602 has stopped. In some embodiments, computer system 600 detects an input, such as a tap input, a drag input, and/or a slide input, directed to the display of computer system 600 and, in response, moves current brightness value indicator 634 based on the detected input and causes output of the one or more devices to change. In some embodiments, computer system 600 provide less haptic outputs while detecting tap input, drag input, and/or a slide input than computer system 600 would cause rotatable input mechanism 602 to provide (e.g., as further discussed below) while a setting is being set to the same value via rotation of the rotatable input mechanism 602.

At FIG. 6B, in response to detecting tap input 611a on brightness setting control 612, computer system 600 does not configure rotatable input mechanism 602 to have a different set of movement characteristics. In other words, the movement characteristics of rotatable input mechanism 602 at FIG. 6B is the same as the movement characteristics of rotatable input mechanism 602 at FIG. 6A, which is indicated by movement characteristics graph 620a of FIG. 6A being the same as movement characteristics graph 620b of FIG. 6B. Thus, at FIG. 6B, computer system 600 causes rotatable input mechanism 602 to ramp down the level of resistance (e.g., from position 620b1 to position 620b2) to provide a consistent level of resistance (e.g., from position 620b2 to position 620b3), and ramp up the level of resistance (e.g., from position 620b3 to position 620b4) as rotatable input mechanism 602 is rotated clockwise (or, in some embodiments, counterclockwise). In some embodiments, computer system 600 causes rotatable input mechanism 602 to ramp down the level of resistance (or ramp up the level of resistance) provided more abruptly or suddenly than indicated by movement characteristics graph 620b. In some embodiments, computer system 600 provides the set of resistances in the way discussed above in reverse as rotatable input mechanism 602 is rotated in the opposite direction (e.g., counterclockwise direction). In some embodiments, in response to detecting tap input 611a on brightness setting control 612, computer system 600 configures rotatable input mechanism 602 to have a different set of movement characteristics, where computer system 600 configures rotatable input mechanism 602 to provide the constant level of resistance for an amount of rotation that is shorter or longer than the amount of rotation to go from positions 620b2 and 620b3 (or vice-versa). As an example, computer system 600 can cause rotatable input mechanism 602 to ramp up (or ramp down) the level of resistance after rotatable input mechanism 602 is rotated 400 (or 150, 220, or 505) degrees at FIG. 6B from a respective position (e.g., a terminal position or another position) while causing rotatable input mechanism to ramp up (or ramp down) resistance after rotatable input mechanism 602 is rotated 180 (or 120, 630, or 275) degrees at FIG. 6A from the respective position.

As discussed above and turning back to FIG. 6A, computer system 600 detects tap input 611a2 on contrast setting control 614. As illustrated in FIG. 6C, in response to detecting tap input 611a2 on contrast setting control 614, computer system 600 displays contrast setting user interface 640 that includes low contrast value setting 642, medium contrast value setting 644, and high contrast value setting 646. As illustrated in FIG. 6C, computer system 600 displays current contrast value indicator 648 around low contrast value setting 642 to indicate that a contrast value is set to the low contrast value setting. Notably, computer system 600 displays a different user interface with a different mechanism (e.g., individual value settings) for setting the contrast value at FIG. 6C than the mechanism (e.g., a slider) displayed for setting the value for the brightness setting at FIG. 6B. Thus, some settings have a particular mechanism for setting the value for a respective setting. As illustrated in FIG. 6C, in response to detecting tap input 611a2 on contrast setting control 614, computer system 600 configures rotatable input mechanism 602 to have a different set of movement characteristics as compared to the movement characteristics of rotatable input mechanism 602 at FIG. 6B. In some embodiments, computer system 600 configures rotatable input mechanism 602 to have a different set of movement characteristics as compared to the movement characteristics of rotatable input mechanism 602 at FIG. 6B because the mechanism for setting the contrast value is different from the mechanism for setting the brightness value.

As indicated by movement characteristics graph 620c of FIG. 6C, computer system 600 causes rotatable input mechanism 602 to provide more transitions and shorter transitions between high and low levels of resistance as compared to the configuration of rotatable input mechanism 602 at FIG. 6B (e.g., as indicated by movement characteristics graph 620b of FIG. 6B). At FIG. 6C, when rotatable input mechanism 602 is rotated in the clockwise direction (or counterclockwise direction) starting at position 620c1, which corresponds to the position of low contrast value setting 642 (e.g., the minimum value for the contrast setting), computer system 600 causes rotatable input mechanism 602 to ramp down the level of resistance provided while rotatable input mechanism is moved between positions 620c1 and 620c2. In some embodiments, while rotatable input mechanism is moved between positions 620c1 and 620c2, current contrast value indicator 648 continues to be around low contrast value setting 642 (e.g., low contrast value setting 642 continues to be selected). At FIG. 6C, as rotatable input mechanism 602 is rotated further in the clockwise direction between positions 620c2-620c3, computer system 600 causes rotatable input mechanism 602 to provide a consistent level of resistance until ramping up the level of resistance provided while being moved position 620c3-620c4. In some embodiments, when rotatable input mechanism 602 is moved to position 620c4, current contrast value indicator 648 is moved from being around low contrast value setting 642 to medium contrast value setting 644, and computer system 600 causes a display, such as the display of computer system 600 or another display (e.g., a television or a monitor) to change from providing a low level of contrast to a medium level of contrast. As indicated by movement characteristics graph 620c of FIG. 6C, further rotation of rotatable input mechanism 602 at FIG. 6C, would provide similar movement characteristics to those discussed above in relation to rotatable input mechanism 602 being rotated between positions 620c1-620c4 in order to move current contrast value indicator 648 from medium contrast value setting 644 to high contrast value setting 646. When comparing the movement characteristics that computer system 600 configures rotatable input mechanism 602 to provide at FIG. 6B with the movement characteristics that computer system 600 configures rotatable input mechanism 602 to provide at FIG. 6C, the more consistent and continuous levels of resistances provided between positions 620b1 and 620b4 of FIG. 6B are more indicative of the movement of an indicator across a slider (e.g., more continuous resistance) (e.g., where values are not visually separated) than the less consistent and continuous resistances provided between positions 620b1-620b4 of FIG. 6C, which are more indicative of moving an indicator between individual and visually separated settings and not a slider.

As discussed above and turning back to FIG. 6A, computer system 600 detects tap input 611a3 on volume setting control 616. As illustrated in FIG. 6D, computer system 600 displays volume setting user interface 650 that includes a mechanism for changing the value of a volume setting. As illustrated in FIG. 6D, the mechanism for changing the volume has individual settings, such as minimum setting value 652 and maximum setting value 656.

When comparing FIG. 6C-6D, the mechanism for setting the volume setting at FIG. 6D has more individual value settings than the mechanism for setting the contrast setting at FIG. 6C. Turning back to 6D, value setting 654 is emphasized (e.g., is a different color and/or is bolded) when compared to minimum setting value 652 and maximum setting value 656, which indicates that value setting 654 corresponds to the current value for the volume setting. In response to detecting tap input 611a3, computer system 600 configures rotatable input mechanism 602 to provide a different set of resistances as compared to the sets of resistances discussed above in relation to FIGS. 6B-6C. As illustrated by movement characteristics graph 620d, computer system 600 configures rotatable input mechanism 602 to provide more transitions between the levels of resistances as rotatable input mechanism 602 is moved from position 620d1 to position 620d15 than the sets of resistances discussed in relation to FIGS. 6B-6C. Here, computer system 600 configures rotatable input mechanism 602 to provide more transitions between levels of resistances to mimic the selection of an individual value setting displayed on volume user interface 650. In addition, computer system 600 configures rotatable input mechanism 602 to ramp up to less than a high (or maximum and/or near maximum) level of resistance (or the resistance provided at the terminal positions, such as position 620d1 and 620d15) at some of the positions (e.g., such as 620d3), as indicated by movement characteristics graph 620d. Thus, in some embodiments, computer system 600 can cause rotatable input mechanism 602 to ramp up to levels of resistances that are less than a high level of resistance and/or ramp down to levels of resistances that are greater than a high level of resistance.

In some embodiments, computer system 600 provides different sets of haptic outputs along with providing different movement characteristics. In some embodiments, computer system 600 provides a respective set of haptic outputs to mimic the respective set of movement characteristics provided (e.g., which mimics the respective mechanism for setting a respective settings value). In some embodiments, when computer system 600 provides the set of haptic outputs, rotatable input mechanism 602 vibrates, such that the vibration can be felt by a user that is touching rotatable input mechanism 602. In some embodiments, computer system 600 causes rotatable input mechanism 602 to provide the set of haptic outputs (e.g., when rotatable input mechanism is not physically coupled to computer system 600). As an example of providing different sets of haptic outputs along with providing different movement characteristics, computer system 600 (or rotatable input mechanism 602) can provide an individual haptic at the maximum resistance levels and/or minimum resistance levels shown in movement characteristics graphs 620d-620d of FIGS. 6A-6D. In some embodiments, computer system 600 provides haptic outputs when rotatable input mechanism 602 is at positions 620a1 and 620a4 at FIG. 6A; positions 620b1 and 620b4 at FIG. 6B; positions 620c1, 620c4, and 620c10; and positions 620d1, 620d3, and 620d15 at FIG. 6D.

Thus, in some embodiments, computer system 600 provides a different number of haptic outputs and/or provides haptic outputs at different times and/or at different positions of rotatable input mechanism 602 while rotatable input mechanism 602 is configured to cause computer system 600 to change the value of a setting. In some embodiments, computer 600 provides haptic outputs that have different levels of intensities. As an example, computer system 600 can provide a stronger haptic output when causing rotatable input mechanism 602 to provide a higher level of resistance than when causing rotatable input mechanism 602 to provide a lower level of resistance (e.g., a stronger haptic output can be provided when rotatable input mechanism 602 is at position 620d2 than at position 620d3 in FIG. 6D). In some embodiments, in response to detecting an input directed back control 636 at FIG. 6D (or at FIG. 6B-6C), computer system 600 re-displays the user interface of FIG. 6A and configures rotatable input mechanism 602 to provide a different set of movement characteristics and/or haptic outputs than what was provided at FIG. 6D (or at FIG. 6C).

FIGS. 6E-6G illustrate exemplary user interfaces to discuss techniques concerning how a haptic of the rotatable input mechanism can change based on one or more operations that the rotatable input mechanism is configured to cause a computer system to perform. As illustrated in FIG. 6E, computer system 600 is displaying brightness setting user interface 630. At FIG. 6E, computer system 600 displays brightness setting user interface 630 in response to rotatable input mechanism 602 being rotated in the clockwise direction (e.g., via input 611b of FIG. 6B). Thus, at FIG. 6E, computer system 600 has moved current brightness value indicator 634 to a value that corresponds to the maximum value for the brightness setting on brightness slider 632. At FIG. 6E, computer system 600 detects touch input (e.g., an input corresponding to a tap input, a pinching input, a pressing input, and/or a non-rotational input) 611e on rotatable input mechanism 602. At FIG. 6E, in response to detecting touch input 611e on rotatable input mechanism 602, computer system 600 provides a haptic output (e.g., indicated by haptic output 662e) and/or causes rotatable input mechanism 602 to provide a haptic output. Moreover, in response to detecting touch input 611e on rotatable input mechanism 602, computer system 600 causes an external device (e.g., a dining room light, a kitchen light, and/or a bedroom light) to perform an operation, such as turning off or turning on. Thus, looking at FIGS. 6A, 6B, and 6E, computer system 600 configures rotatable input mechanism 602 to respond to two different types of inputs (e.g., a tap input (or other type of touch input) and a rotatable input), where each type of input causes different types of operations to be performed (e.g., turning a light on or off and changing a brightness setting). Moreover, computer system 600 configures rotatable input mechanism 602 in this manner based on the brightness setting being selected via tap input 611a1 at FIG. 6A.

At FIG. 6F, computer system 600 is displaying contrast settings user interface 640. At FIG. 6F, computer system 600 displays contrast settings user interface 640 in response to rotatable input mechanism 602 being rotated in the clockwise direction (e.g., via rotational input 611c of FIG. 6C). Thus, at FIG. 6F, computer system 600 has moved current contrast value indicator 648 to the right to indicate that medium contrast value setting 644 is selected (e.g., instead of low contrast value 642 being selected like in FIG. 6C). Notably, rotational input 611b of FIG. 6B and rotational input 611c of FIG. 6C have the same magnitude (e.g., or force and velocity). However, current brightness value indicator 634 moved further the right than current contrast value indicator 648 moved to the right because rotatable input mechanism 602 was configured to provide less resistance between certain positions of rotatable input mechanism 602 (e.g., as indicated between positions 620b2 and 620b3 of movement characteristics graph 620b of FIG. 6B) for the brightness setting than the resistances that rotatable input mechanism 602 was configured to provide at FIG. 6C (e.g., between positions 620c2 and 620c7 of movement characteristics graph 620c of FIG. 6C) during the same range of positions that correspond to positions 620b2 and 620b3 of movement characteristics graph 620b of FIG. 6B). In other words, rotatable input mechanism 602 moved by smaller amounts as rotatable input mechanism 602 is configured to apply more resistance in FIG. 6F. At FIG. 6F, computer system 600 detects touch input 611f on rotatable input mechanism 602. In response to detecting touch input 611f, computer system 600 does not provide a haptic output and/or does not cause rotatable input mechanism 602 to provide a haptic output. At FIG. 6F, computer system 600 also does not cause an operation to be performed in response to detecting touch input 611f. Thus, when looking at FIGS. 6A, 6C, and 6F, computer system 600 configures rotatable input mechanism 602 to respond to only one type of input (e.g., a rotational input and not a tap input (or another type of touch input)), where the input caused the same type of operation to be performed (e.g., changing at value of a setting) as the one performed due to the rotational input detected at FIG. 6B for the brightness setting.

FIG. 6G illustrates computer system 600 displaying a media user interface that includes media art 612 (e.g., an album and/or a video cover). At FIG. 6G, computer system 600 detects touch input 611g on rotatable input mechanism 602. In response to detecting touch input 611g, computer system 600 provides haptic output (e.g., indicated by haptic output 662g). Moreover, in response to detecting touch input 611g, computer system 600 causes a speaker and/or another device to perform a media operation, such as pausing playback and causing playback of the media that corresponds to media art 612. Thus, computer system 600 configures rotatable input mechanism 602 to perform a different operation in response to detecting the touch input than the operation performed at FIG. 6E. In some embodiments, media art 612 is a play control instead of media art, and in response to detecting touch input 611, computer system 600 causes media to play and replaces the play control with a pause control. In some embodiments, computer system 600 configured rotatable input mechanism 602 to provide a different type of haptic at FIG. 6C than at FIG. 6B, such as a pulsating haptic, a haptic that has more force, and/or a haptic that is provided for a longer time period. In some embodiments, while computer system 600 is displaying the media user interface, providing a rotational input to rotatable input mechanism 602 would not cause computer system 600 to perform an operation. In some embodiments, while computer system 600 displays the media user interface, rotatable input mechanism 602 is not configured to move when a rotational input is provided at rotatable input mechanism 602 (or is configured to provide a level of resistance that prevents movement of the rotatable input mechanism). It is anticipated that computer system 600 can be configured to perform one or more other operations in response to detecting an input corresponding to a touch input and/or a rotational input, such as unlocking a door, opening a garage, opening a window, causing an actuator to move an object, etc. It is also anticipated that computer system 600 can be configured to provide different movement characteristics beyond rotation of rotatable input mechanism 602, such as movement characteristics for pulling, pressing, and/or moving rotatable input mechanism 602 laterally.

FIG. 7 is a flow diagram illustrating a method for changing movement characteristics of an input mechanism using a computer system in accordance with some embodiments. Method 700 is performed at a computer system (e.g., 100, 300, 500) that is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the rotatable input mechanism is a part of a platform, such as a vehicle (e.g., an automobile and/or a boat) and/or smart home devices. In some embodiments, input detected at the rotatable input mechanism causes one or more settings, such as temperature, volume, window opening, window tint, cabin light brightness, and the like, to be updated. In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 700 are, optionally, combined, the orders of some operations are, optionally, changed, and some operations are, optionally, omitted.

As described below, method 700 provides an intuitive way for changing movement characteristics of the physical input mechanism. The method reduces the cognitive burden on a user for using the physical input mechanism, thereby creating a more efficient human-machine interface. For battery-operated computing devices, enabling a user to use the physical input mechanism faster and more efficiently conserves power and increases the time between battery charges.

At 710 of method 700, the computer system (e.g., 600), while the physical input mechanism (e.g., 602) is configured to have (e.g., and/or the physical input mechanism has) a first set of movement characteristics (e.g., 620a-60d) (e.g., a range of movement of the physical input mechanism for a certain distance in a graphical user interface, movement that is smooth over a first distance of movement of the physical input mechanism, movement that is jittery (e.g., bumpy and/or has resistance over the course of the movement) over a second distance of movement of the physical input mechanism), a range of accelerations for movement within a graphical user interface along a certain distance of movement of the physical input mechanism and/or with a force (e.g., the same or different from) applied to the physical input mechanism over a period of time) (e.g., slowing rotation down or stopping rotation for a period of time during the movement and/or speeding rotation up and/or starting rotation for a period of time during the movement of the physical input mechanism) in response to detecting a rotation (e.g., an amount of rotational movement (e.g., via rotational movement and/or force)) of the physical input mechanism, detect an input (e.g., a tap input and, in some embodiments, a non-tap input, such as a swipe input, a mouse click, a button press, a gaze input, an air gesture input, and/or a gaze input with an air gesture input) directed to (e.g., at a location corresponding to and/or on) a control. In some embodiments, the control is a user interface object. In some embodiments, the computer system displays the control on the user interface. In some embodiments, the control is a physical control that is not displayed. In some embodiments, the control is a settings control (e.g., a temperature control, a volume control, a fan control, and/or a heating element control (e.g., a heating pad control, a water heating element control, and/or a seat heating element control)). In some embodiments, the control is a value for a setting that is not displayed. In some embodiments, the computer system displays the control on a user interface that does not indicate (e.g., via text and/or symbols) that characteristics of physical input mechanism will be changed (e.g., while, in some embodiments, indicates that one or more other settings (e.g., volume, temperature, a fan, and/or a heating element) will be changed). In some embodiments, the control is a selectable user interface object.

At 720 of method 700, the computer system, in response to detecting the input directed to the control and in accordance with a determination that the control corresponds to a first type of setting (e.g., a temperature setting, a fan setting, a heating element setting, a volume setting, a brightness setting, a light setting, a contrast setting, a television setting, a cabin setting, a door setting (e.g., a garage door setting, a front door setting, and/or a back door setting) and/or a setting that does not indicate that the physical input mechanism will be configured differently and/or set the physical setting to have a different set of movement characteristics), configure the physical input mechanism to have a second set of movement characteristics in response to detecting the rotation of the physical input mechanism (and, in some embodiments, regardless of any haptic responses output by the computer system and/or the physical input mechanism), wherein the second set of movement characteristics is different form the first set of movement characteristics; and

At 730 of method 700, the computer system, in response to detecting the input directed to the control and in accordance with a determination that the control corresponds to a second type of setting that is different from the first type of setting, configure the physical input mechanism to have a third set of movement characteristics (and, in some embodiments, without configuring the physical input mechanism to have the second set of movement characteristics and/or the first set of movement characteristics) in response to detecting the rotation of the physical input mechanism (and, in some embodiments, regardless of any haptic responses output by the computer system and/or the physical input mechanism), wherein the third set of movement characteristics is different from the second set of movement characteristics. In some embodiments, in accordance with a determination that the control corresponds to the first type of setting, the computer system does not configure the physical input mechanism to have the first set of movement characteristics and/or the third set of movement characteristics. Configuring the physical input mechanism to have different movement characteristics based on prescribed conditions allows the computer system to automatically configure the physical input mechanism to have a particular set of movement characteristics based on the type of setting that the physical input mechanism can be used to adjust, which performs an operation when a set of conditions has been met without requiring further user input and provides improved feedback to the user.

In some embodiments, the second set of movement characteristics (e.g., 620a-620d) includes a first number of transitions (e.g., and/or changes) between different movement characteristics in the second set of movement characteristics (e.g., 620a-620d). In some embodiments, the third set of movement characteristics includes a second number of transitions (e.g., as discussed in relation to FIG. 6A-6D) between different movement characteristics in the third set of movement characteristics (e.g., 620a-620d). In some embodiments, an amount of (e.g., a total amount, a total number, the total number of different types of movement characteristics in, the total number of movement characteristics irrespective of the type of movement characteristic, and/or the total number of transitions between different movement characteristics) the second set of movement characteristics is different from an amount of the third set of movement characteristics. In some embodiments, the amount of the second movement characteristics is different from an amount of the first movement characteristics. In some embodiments, the amount of the third movement characteristics is different from the amount of the first movement characteristics. In some embodiments, one or more of the first set of movement characteristics, the second set of movement characteristics, and the third set of movement characteristics has a different number of transitions between movement characteristics while the input mechanism is moving. Configuring the physical input mechanism to have movement characteristics that have different numbers of transitions between movement characteristics based on prescribed conditions allows the computer system to automatically configure the physical input mechanism to have a particular set of movement characteristics based on the type of setting that the physical input mechanism can be used to adjust, which performs an operation when a set of conditions has been met without requiring further user input and provides improved feedback to the user.

In some embodiments, the computer system: in accordance with a determination that the control (e.g., 610, 614, and/or 616) corresponds to the first type of setting, causes output of a first set of haptics (e.g., as discussed above in relation to FIG. 6A-6D) (e.g., vibrations and/or pulses) (e.g., by the computer system, by the physical input mechanisms, and/or via one or more haptic and/or vibrating components) (e.g., a combination of one or more haptics of varying lengths (e.g., one or more short haptics and longer haptics in a particular order and in particular duration)) (e.g., multiple haptics, no haptics, and/or only one haptic) in response to detecting the rotation (e.g., 611b-611c) of the physical input mechanism (e.g., 602); and in accordance with a determination that the control (e.g., 610, 614, and/or 616) corresponds to the second type of setting, causes output of a second set of haptics (e.g., as discussed above in relation to FIG. 6A-6D) in response to detecting the rotation of the physical input mechanism (e.g., 602), where the second set of haptics is different from (e.g., a different combination of haptics of varying lengths, a different number of haptics, a different number of haptics of varying lengths, and/or different types of haptics) the first set of haptics. In some embodiments, the set of haptics are felt at the physical input mechanism, where the physical input mechanism vibrates. In some embodiments, the set of haptics are felt at the computer system, where the computer system vibrates. Causing output of a set of haptics based on prescribed conditions allows the computer system to configure the physical input mechanism to have a particular set of haptics based on the type of setting that the physical input mechanism can be used to adjust, which performs an operation when a set of conditions has been met without requiring further user input and provides improved feedback to the user.

In some embodiments, causing output of the first set of haptics in response to detecting the rotation of the physical input mechanism (e.g., 602) includes causing output of a first portion of the first set of haptics in response to detecting that the physical input mechanism has been rotated in a first manner (e.g., clockwise or counter clockwise with respect to, in some embodiments, yaw, pitch, and/or roll) by a first amount (e.g., a first amount of degrees, an arc length, an arc distance, a linear distance, and/or a linear length) (e.g., as discussed above in relation to FIGS. 6B-6D). In some embodiments, the first portion of the first set of haptics has a first level of intensity (e.g., an amount of force, an amount of pressure, and/or an amount of vibration) (e.g., as discussed above in relation to FIG. 6A-6D). In some embodiments, the level of intensity between subsets and/or portions of haptics in a set of haptics are different. In some embodiments, the level of intensity of a second portion of the first set of haptics that is output (e.g., in response to detecting that the physical input mechanism has been rotated in the first manner by an amount that is different from (e.g., more than and/or less than) the second amount) with a level of intensity that is different from the first level of intensity. In some embodiments, the first portion of the first set of haptics and the second portion of the first set of haptics are non-overlapping portions. In some embodiments, causing output of the second set of haptics in response to detecting the rotation of the physical input mechanism includes causing output of a first portion (e.g., portion of the second set of haptics that corresponds to the portion of the first set of haptics) of the second set of haptics in response to detecting that the physical input mechanism has been rotated in the first manner by the first amount (e.g., as discussed above in relation to FIGS. 6B-6D). In some embodiments, the first portion of the second set of haptics has a second level of intensity that is different from the first level of intensity (e.g., as discussed above in relation to FIG. 6A-6D). Causing output of a set of haptics with different levels of intensities based on prescribed conditions allows the computer system to configure the physical input mechanism to have a particular set of haptics based on the type of setting that the physical input mechanism can be used to adjust, which performs an operation when a set of conditions has been met without requiring further user input and provides improved feedback to the user.

In some embodiments, the first set of haptics includes a first haptic and a second haptic directly following the first haptic (e.g., as discussed above in relation to FIGS. 6B-6D). In some embodiments, the second set of haptics includes a third haptic and fourth haptic directly following the third haptic (e.g., as discussed above in relation to FIGS. 6B-6D). In some embodiments, a first time is the time between the first haptic and the second haptic (e.g., as discussed above in relation to FIGS. 6B-6D). In some embodiments, a second time is the time between the third haptic and the fourth haptic (e.g., as discussed above in relation to FIGS. 6B-6D). In some embodiments, the second time is different from the first time. Causing output of a set of haptics with timing based on prescribed conditions allows the computer system to configure the physical input mechanism to have a particular set of haptics based on the type of setting that the physical input mechanism can be used to adjust, which performs an operation when a set of conditions has been met without requiring further user input and provides improved feedback to the user.

In some embodiments, the second set of haptics (e.g., as discussed above in relation to FIGS. 6B-6D) indicate consistent movement of the physical input mechanism (e.g., 602) over a respective amount of movement of the physical input mechanism (e.g., a continuous and/or connected haptic that is provided while the physical input mechanism is moving the respective amount). In some embodiments, the third set of haptics (e.g., as discussed above in relation to FIGS. 6B-6D) indicate varying movement of the physical input mechanism over the respective amount of movement of the physical input mechanism (e.g., non-continuous and/or non-connected haptics that are provided while the physical input mechanism is moving the respective amount) (e.g., as discussed above in relation to FIG. 6A-6D). Causing output of a set of haptics that indicate different types of movement based on prescribed conditions allows the computer system to configure the physical input mechanism to have a particular set of haptics based on the type of setting that the physical input mechanism can be used to adjust, which performs an operation when a set of conditions has been met without requiring further user input and provides improved feedback to the user.

In some embodiments, an amount (e.g., total amount, a total number, and/or the total number of different types of movement haptics in, the total number of haptics irrespective of the type of haptic, and/or the total number of transitions between different haptics) of haptics in the first set of haptics is different than an amount of haptics in the second set of haptics (e.g., as discussed above in relation to FIGS. 6B-6D). Causing output of a set of haptics with a number haptics based on prescribed conditions allows the computer system to configure the physical input mechanism to have a particular set of haptics based on the type of setting that the physical input mechanism can be used to adjust, which performs an operation when a set of conditions has been met without requiring further user input and provides improved feedback to the user.

In some embodiments, the computer system (e.g., 600) is in communication with a display generation component. In some embodiments, before (e.g., while) detecting the input (e.g., 611a1-611a3) directed to the control, the computer system is displaying, via the display generation component, a representation of the control (e.g., 612, 614, and/or 616) on a first user interface. In some embodiments, in response to detecting the input (e.g., 611a1-611a3) directed to the control, the computer system: in accordance with a determination that the control corresponds to the first type of setting, displays, via the display generation component, a user interface (e.g., the first user interface or different user interface) that includes a first user interface object (e.g., 632, 642, 644, 646, 656, and/or 656) (e.g., a scale and/or one or more options), where the first user interface object includes one or more indications (e.g., 632, 642, 644, 646, 656, and/or 656) of values (e.g., 0-100, on, off, very high, high, very low, low, and/or medium) (e.g., values to which the a setting can be set) corresponding to the first setting (e.g., that is displayed at respective location (e.g., a location that is around the physical input mechanism and/or near the physical input mechanism)) (and, in some embodiments, ceasing to display the control; and in other embodiments, continuing to display the control); and in accordance with a determination that the control corresponds to a second type of setting, displaying, via the display generation component, a user interface that includes a second user interface object (and does not include the first user interface object), where the second user interface object includes one or more indications of values corresponding to the second setting, where the one or more indications of values corresponding to the first setting is different from the one or more indications of values corresponds to the second setting. In some embodiments, the computer system does not display the first user interface object concurrently with the second user interface object. In some embodiments, the one or more indications of values corresponding to the second type of setting is different from (e.g., different types of indications (e.g., numerical (e.g., 0-100), text indications (e.g., very high, high, very low, low, and/or medium)) the one or more indications of values corresponding to the first type of setting. Displaying the first user interface object or the second user interface object based on prescribed conditions allows the computer system to automatically provide a particular control for changing a setting based on the type of setting selected to be adjusted, which performs an operation when a set of conditions has been met without requiring further user input and provides improved feedback to the user.

In some embodiments, while displaying the user interface that includes the first user interface object, the computer system displays, via the display generation component, an indication (e.g., 634 and/or 648) (e.g., a highlighting and/or mark (e.g., a shape, circle, triangle, and/or square) on a value (e.g., tick mark and/or position) of a scale) of a current value of the first setting at a first location relative to (e.g., on, near, adjacent to, and/or in an area that corresponds to) the first user interface object. In some embodiments, while displaying the indication of the current value of the first setting at the first location, the computer system detects the rotation of the physical input mechanism (e.g., 602). In some embodiments, in response to detecting the rotation of the physical input mechanism, the computer system moves (e.g., based on the speed, direction, and/or distance of the rotation) display of the indication of the current value of the first setting to a second location relative to the first user interface object. Moving display of the indication of the current value of the first setting to a second location relative to the first user interface object in response to detecting the rotation of the physical input mechanism provides visual feedback to the user that the value of the setting is changing and provides the user with more control over the user interface without cluttering the user interface.

In some embodiments, the one or more indications (e.g., 632, 642, 644, 646, 656, and/or 656) of values corresponding to the first setting is displayed at a first set of locations (e.g., on the display generation component, relative to the physical input mechanism, and/or relative to the scale for the respective setting) that is representative of (e.g., that indicates the second set of movement characteristics (e.g., based on spacing between the one or more indications and/or the size of the one or more indications and/or whether one or more indications are connected or not connected)) the first set of movement characteristics. In some embodiments, the one or more indications of values corresponding to the second setting is displayed at a second set of locations (e.g., on the display generation component, relative to the physical input mechanism, and/or relative to the scale for the respective setting) that is representative of the second set of movement characteristics. In some embodiments, the first set of locations is different from (e.g., has at least one location or does not have at least one location that is in) the second set of locations. Displaying a user interface object with one or more indications of values corresponding to a respective setting provides the user with visual feedback concerning the movement characteristics of the physical input mechanism and/or the respective setting.

In some embodiments, in response to detecting the input (e.g., 611a1-611a3) directed to the control and in accordance with a determination that the control corresponds to a third type of setting, the computer system forgoes configuring the physical input mechanism (e.g., 602) to have a set of movement characteristics that is different from the first set of movement characteristics. In some embodiments, in accordance with a determination that the control corresponds to a third type of setting, the physical input mechanism continues to have the first set of movement characteristics.

In some embodiments, the second set of movement characteristics (e.g., 620a-620d) has a first amount continuity of movement (e.g., continuous smooth, connected, and not jittery haptic(s) that are provided while the physical input mechanism is moving a respective amount). In some embodiments, the third set of movement characteristics (e.g., 620a-620d) has a second amount of continuity of movement (e.g., non-continuous, not smooth, disconnected, and jittery haptic(s) that are provided while the physical input mechanism is moving the respective amount) that is different from the first amount of continuity of movement (e.g., less continuous or more continuous movement while the physical input mechanism is moved over a distance).

Note that details of the processes described above with respect to method 700 (e.g., FIG. 7) are also applicable in an analogous manner to the methods described below. For example, method 800 optionally includes one or more of the characteristics of the various methods described above with reference to method 700. For example, in response to detecting the input directed to the control of method 800, configuring the physical input mechanism to have the first set of movement characteristics of method 700. For brevity, these details are not repeated below.

FIG. 8 is a flow diagram illustrating a method for changing a haptic of an input mechanism using a computer system in accordance with some embodiments. Method 800 is performed at a computer system (e.g., 100, 300, 500) that is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the rotatable input mechanism is a part of a platform, such as a vehicle (e.g., an automobile and/or a boat) and/or smart home devices. In some embodiments, input detected at the rotatable input mechanism causes one or more settings, such as temperature, volume, window opening, window tint, cabin light brightness, and the like, to be updated. In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 800 are, optionally, combined, the orders of some operations are, optionally, changed, and some operations are, optionally, omitted.

As described below, method 800 provides an intuitive way for changing a haptic of the physical input mechanism. The method reduces the cognitive burden on a user for using the physical input mechanism, thereby creating a more efficient human-machine interface. For battery-operated computing devices, enabling a user to use the physical input mechanism faster and more efficiently conserves power and increases the time between battery charges.

At 810 of method 800, the computer system detects an input (e.g., a tap input and, in some embodiments, a not tap input, such as a swipe input, a mouse click, a button press, a gaze input, an air gesture input, and/or a gaze input with an air gesture input) directed to a control (e.g., as described above in relation to method 700).

At 820 of method 800, the computer system, in response to detecting the input directed to the control and in accordance with a determination that the control corresponds to a first type of setting (e.g., as described above in relation to method 700), displays a first user interface object (e.g., a selectable user interface object, a user interface object that, when selected, causes the first type of setting to be changed and/or causes output (e.g., by a first set of devices and/or computer systems) that is based on the first type of setting to change) that corresponds to the first setting (and that does not correspond to another type of setting). In some embodiments, the first user interface object is displayed concurrently with the control. In some embodiments, before detecting the input directed to the control, the first user interface object is not displayed and the control is displayed, and in response to detecting the input directed to the control, the computer system displays the first user interface object and ceases to display the control.

At 830 of method 800, the computer system, in response to detecting the input directed to the control and in accordance with a determination that the control corresponds to a first type of setting (e.g., as described above in relation to method 700), configures the physical input mechanism to provide an output (e.g., a haptic output and/or a vibrating output) in response to detecting an input (e.g., a tap input, a double-tap input, a press-and-hold input, a gaze input, a gaze with an air gesture input (e.g., an air tap input and/or a pointing input)) corresponding to a touch input (e.g., a physical touch input, a button press, a non-rotational input, and/or an input that causes the physical input mechanism to perform the same operation that is performed when the physical input mechanism is physically touched) on the physical input mechanism.

At 840 of method 800, the computer system, in response to detecting the input directed to the control and in accordance with a determination that the control corresponds to a second type of setting (e.g., as described above in relation to method 700) that is different form the first type of setting, displays a second user interface object (e.g., a selectable user interface object, a user interface object that, when selected, causes the second type of setting to be changed and/or causes output (e.g., by a second set of devices and/or computer systems that is different form the first set of devices and/or computer systems) that is based on the second type of setting to change (e.g., without causing output that is based on the first type of settings to change)) that corresponds to the second type of setting (and that does not correspond to the first type of setting). In some embodiments, the second user interface object is displayed concurrently with the control. In some embodiments, before detecting the input directed to the control, the second user interface object is not displayed and the control is displayed, and in response to detecting the input directed to the control, the computer system displays the second user interface object and ceases to display the control. In some embodiments, the second user interface object is not concurrently displayed with the first user interface object. In some embodiments, the second user interface object includes (and/or is displayed with) an indication that corresponds to the second type of setting and does not include (and/or is not displayed with) an indication of the first type of setting. In some embodiments, the first user interface object includes (and/or is displayed with) the indication that corresponds to the first type of setting and does not include (and/or is not displayed with) the indication of the second type of setting.

At 850 of method 800, the computer system, in response to detecting the input directed to the control and in accordance with a determination that the control corresponds to a second type of setting (e.g., as described above in relation to method 700) that is different form the first type of setting, forgoes configuring the physical input mechanism to provide the output in response to detecting the input corresponding to the touch input on the physical input mechanism. Choosing whether to configure the physical input mechanism to provide the output in response to detecting the input corresponding to the touch input on the physical input mechanism in response to detecting the input directed to the control provides the user with control over how the physical input mechanism is configured, which provides additional control options without cluttering the user interface with additional displayed controls.

In some embodiments, the physical input mechanism (e.g., 602) is a rotatable input mechanism (e.g., 602) (e.g., is, optionally, rotatable and/or twistable).

In some embodiments, the computer system detects a first input (e.g., a tap input, a double-tap input, a press-and-hold input, a gaze input, a gaze with an air gesture input (e.g., an air tap input and/or a pointing input)) that is directed to the physical input mechanism, where the first input corresponds to the touch input (e.g., 611e-611g) on the physical input mechanism. In some embodiments, in response to detecting the first input, the computer system: in accordance with a determination that the physical input mechanism (e.g., 602) was configured to provide the output (e.g., 662e and/or 662g) in response to detecting an input corresponding to the touch input (e.g., 611e-611g) on the physical input mechanism when the first input was detected, causes the physical input mechanism to provide the output (and, in some embodiments, causing the computer system and/or another device, such as an external device, to perform an operation) (e.g., as discussed above in relation to FIGS. 6E-6G); and in accordance with a determination that the physical input mechanism was not configured to provide the output in response to detecting an input corresponding to the touch input (e.g., 611e-611g) on the physical input mechanism when the first input was detected, forgoes causing the physical input mechanism to provide the output e.g., as discussed above in relation to FIGS. 6E-6G) (and, in some embodiments, causing the computer system and/or another device, such as an external device, to perform an operation). Causing the physical input mechanism to provide the output when prescribed conditions are met allows the computer system to automatically cause the physical input mechanism to provide the user with feedback (e.g., that an operation is being performed), which performs an operation when a set of conditions has been met without requiring further user input and provides improved feedback.

In some embodiments, causing the physical input mechanism (e.g., 602) to provide the output (e.g., 662e and/or 662g) includes causing the physical input mechanism to vibrate e.g., as discussed above in relation to FIGS. 6E-6G). In some embodiments, causing the physical input mechanism to provide the output includes sending data representative of the output to a processor that changes content being output (e.g., audio, visual, and/or graphic content). Causing the physical input mechanism to vibrate when prescribed conditions are met allows the computer system to automatically cause the physical input mechanism to provide the user with feedback (e.g., that an operation is being performed), which performs an operation when a set of conditions has been met without requiring further user input and provides improved feedback.

In some embodiments, in response to detecting the first input, the compute system: in accordance with a determination that the physical input mechanism (e.g., 602) was configured to provide the output (e.g., 662e and/or 662g) in response to detecting an input corresponding to the touch input (e.g., 611e-611g) on the physical input mechanism when the first input was detected, performs a first operation e.g., as discussed above in relation to FIGS. 6E-6G); and in accordance with a determination that the physical input mechanism was not configured to provide the output in response to detecting an input corresponding to the touch input on the physical input mechanism when the first input was detected, forgoes performance of any operation e.g., as discussed above in relation to FIGS. 6E-6G). In some embodiments, in response to detecting the first input and in accordance with a determination that the physical input mechanism was not configured to provide the output in response to detecting an input corresponding to the touch input on the physical input mechanism when the first input was detected, the computer system does not perform the first operation. Causing an operation to be performed when prescribed conditions are met allows the computer system to automatically causes the physical input mechanism to provide the user with feedback (e.g., that an operation is being performed) and allows the computer system to control one or more operations via the physical input mechanism, which performs an operation when a set of conditions has been met without requiring further user input and provides additional control options without cluttering the user interface with additional displayed controls.

In some embodiments, performing the first operation includes sending instructions to a respective device to perform a second operation that causes output of the respective device to be adjusted e.g., as discussed above in relation to FIGS. 6E-6G). In some embodiments, the respective device is a part of the computer system and/or a subset of the computer system. In some embodiments, the respective device is external to the computer system. In some embodiments, the respective device is a device that is not directly connected (e.g., not physically connected, not coupled to, and/or not connected directly wirelessly to) to the physical input mechanism. Causing the first operation to perform that includes sending instructions to a respective device to perform a second operation that causes output of the respective device to be adjusted in response to detecting an on the physical input mechanism, which provides additional control options without cluttering the user interface with additional displayed controls.

In some embodiments, the respective device is a speaker, and where performing the second operation includes adjusting playback of content output by the speaker (e.g., pausing music, playing music, skipping to next track, and/or going to previous track) (e.g., e.g., as discussed above in relation to FIG. 6G). Adjusting playback of content output by the speaker in response to detecting an on the physical input mechanism, which provides additional control options without cluttering the user interface with additional displayed controls.

In some embodiments, the second operation includes opening or closing a door (e.g., as discussed above in relation to FIGS. 6E-6G). In some embodiments, the door is the respective device. In some embodiments, the respective device is a processor for the door, is an actuator, and/or hinge that causes a door to open or close. Opening or close a door in response to detecting an on the physical input mechanism, which provides additional control options without cluttering the user interface with additional displayed controls.

In some embodiments, displaying the first user interface object (e.g., 632, 642, 644, 646, 656, and/or 656) that corresponds to the first setting includes replacing a third user interface object (e.g., 632, 642, 644, 646, 656, and/or 656) corresponding to a third type of setting with the first user interface object. In some embodiments, the third user interface object is replaced with another user interface object that corresponds to the second type of setting.

In some embodiments, in response to detecting the input (e.g., 611a1-611a3) directed to the control and in accordance with a determination that the control corresponds to a fourth type of setting (e.g., as described above in relation method 700) that is different from the first type of setting and the second type of setting, the computer system configures the physical input mechanism (e.g., 602) to provide a second output (e.g., 662e and/or 662g) in response to detecting the input corresponding to the touch input (e.g., 611e-611g) on the physical input mechanism, where the second output is different from the output. In some embodiments, in accordance with a determination that the control corresponds to the fourth type of setting, the computer system displays a fourth user interface object that corresponds to the fourth type of setting a(e.g., a user interface object that includes one or more indications (e.g., as described above in relation to method 700) corresponding to the fourth type of setting) and does not display a user interface object that corresponds to the first type of setting (e.g., a user interface object that includes one or more indications corresponding to the first type of setting) or the second type of setting (e.g., a user interface object that includes one or more indications corresponding to the second type of setting). Configuring the physical input mechanism to provide a second output in response to detecting the input corresponding to the touch input on the physical input mechanism, where the second output is different from the output in response to detecting the input directed to the control allows the user to control how the physical input mechanism is configured, which provides additional control options without cluttering the user interface with additional displayed controls.

In some embodiments, in response to detecting the input (e.g., 611a1-611a3) directed to the control, the computer system: in accordance with a determination that the control corresponds to a fifth type of setting (e.g., that is different from the first type of setting and the second type of setting), configures the physical input mechanism (e.g., 602) so that the physical input mechanism is rotatable (e.g., in response to detecting an input that corresponds to a rotation of the physical input mechanism); and in accordance with a determination that the control corresponds to a sixth type of setting the fifth type of setting (e.g., and/or that is different from the first type of setting and the second type of setting), configures the physical input mechanism so that the physical input mechanism is not rotatable. In some embodiments, in accordance with a determination that the control corresponds to a fourth type of setting, the computer system configures the physical input mechanism so that the physical input mechanism is not rotatable. Configuring the physical input mechanism so that the physical input mechanism is rotatable or not based on when prescribed conditions are met allows the computer system to automatically configured the physical input mechanism based on the type of setting selected to be adjusted, which performs an operation when a set of conditions has been met without requiring further user input and provides improved feedback to the user.

Note that details of the processes described above with respect to method 800 (e.g., FIG. 8) are also applicable in an analogous manner to the methods described above and below. For example, method 700 optionally includes one or more of the characteristics of the various methods described above with reference to method 800. For example, the physical input mechanism of method 800 can be the physical input mechanism of method 700. For brevity, these details are not repeated above or below.

FIG. 9 is a flow diagram illustrating a method for changing inputs for which an input mechanism is responsive using a computer system in accordance with some embodiments. Method 900 is performed at a computer system (e.g., 100, 300, 500) that is in communication with a rotatable (e.g., a hardware and/or non-displayed) input mechanism (e.g., a rotatable input mechanism, a crown, a knob, a dial, a physical and rotatable slider, and/or a rotatable hardware button). In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 900 are, optionally, combined, the orders of some operations are, optionally, changed, and some operations are, optionally, omitted.

As described below, method 900 provides an intuitive way for changing inputs for which the rotatable input mechanism is responsive. The method reduces the cognitive burden on a user for using the rotatable input mechanism, thereby creating a more efficient human-machine interface. For battery-operated computing devices, enabling a user to use the rotatable input mechanism faster and more efficiently conserves power and increases the time between battery charges.

At 910 of method 900, the computer system detects an input (e.g., a tap input and, in some embodiments, a not tap input, such as a swipe input, a mouse click, a button press, a gaze input, an air gesture input, and/or a gaze input with an air gesture input) directed to a control (e.g., as described above in relation to method 700).

At 920 of method 900, the computer system, in response to detecting the input directed to the control and in accordance with a determination that the control corresponds to a first type of setting (e.g., as described above in relation to method 900), configure the rotatable input mechanism to cause the computer system to perform one or more operations in response to a first set of inputs being directed to (e.g., on and/or at one or more locations corresponding to) the rotatable input mechanism, including: a first operation in response to a first type (e.g., a clockwise rotation of the physical input mechanism, a counter-clockwise rotation of the physical input mechanism, a tap on the physical input mechanism, a gaze directed to the physical input mechanism, a press-and-hold of the physical input mechanism, a double tap on the physical input mechanism, and/or a pulling of the physical input mechanism) of input being directed to the rotatable input mechanism; and performing a second operation in response to a second type (e.g., a clockwise rotation of the physical input mechanism, a counter-clockwise rotation of the physical input mechanism, a tap on the physical input mechanism, a gaze directed to the physical input mechanism, a press-and-hold of the physical input mechanism, a double tap on the physical input mechanism, and/or a pulling of the physical input mechanism) of input being directed to the rotatable input mechanism, wherein the first operation is different from the second operation, and wherein the first type of input is different from the second type of input; and

At 930 of method 900, the computer system, in response to detecting the input directed to the control and in accordance with a determination that the control corresponds to a second type of setting (e.g., as described above in relation to method 900) that is different from the first type of setting, configure the rotatable input mechanism to cause the computer system to perform one or more operations in response to a second set of inputs, different from the first set of inputs, being directed to (e.g., detected on and/or detected at one or more locations corresponding to) the rotatable input mechanism, including: performing the first operation in response to the first type of input being directed to the rotatable input mechanism; and forgoing performing an operation in response to the second type of input being directed to the rotatable input mechanism. In some embodiments, while forgoing performing the second operation in response to the second type of input being directed to the rotatable input mechanism, the computer system does not perform any operations in response to the second type of input being directed to the rotatable input mechanism.

In some embodiments, an amount (e.g., total amount, a total number, and/or the total number of different types of inputs) of the first set of inputs is greater than an amount of the second set of inputs (as discussed in relation to FIGS. 6A-6G). Choosing to configure the rotatable input mechanism to respond to different numbers of inputs when prescribed conditions are met allows the computer system to automatically configure the rotatable input mechanism based on the type of setting that rotatable input mechanism is configured to adjust, which performs an operation when a set of conditions has been met without requiring further user input and provides additional control options without cluttering the user interface with additional displayed controls.

In some embodiments, the first of set of inputs includes an input that corresponds to a tap input (e.g., 611e-611g) (e.g., a tap on the surface on the rotatable input mechanism and/or an input that causes the rotational input mechanism to transition from being pressed to depressed, and/or vice-versa) and an input that corresponds to a rotation input (e.g., 611b-611c) (e.g., a twisting input on the surface of the rotatable input mechanism and/or an input that causes the rotational input mechanism to be rotated clockwise and/or counter-clockwise with respective to, in some embodiments, yaw, pitch, and/or roll). Choosing to configure the rotatable input mechanism to respond to a tap input and/or a rotation input when prescribed conditions are met allows the computer system to automatically configure the rotatable input mechanism based on the type of setting that rotatable input mechanism is configured to adjust, which performs an operation when a set of conditions has been met without requiring further user input and provides additional control options without cluttering the user interface with additional displayed controls.

In some embodiments, the second set of inputs includes the input that corresponds to the rotation input (e.g., 611b-611c) and does not include the input that corresponds to the tap input (e.g., 611e-611g). In some embodiments, the second set of inputs includes the input that corresponds to the tap input but does not include the input that corresponds to the rotation input. In some embodiments, the first type of input is the rotational input, and the second type of input is tap input. Choosing to configure the rotatable input mechanism to respond to a rotation input but not a tap input when prescribed conditions are met allows the computer system to automatically configure the rotatable input mechanism based on the type of setting that rotatable input mechanism is configured to adjust, which performs an operation when a set of conditions has been met without requiring further user input and provides additional control options without cluttering the user interface with additional displayed controls.

In some embodiments, configuring the rotatable input mechanism (e.g., 602) to cause the computer system to perform one or more operations in response to the first set of inputs includes performing a third operation in response to a third type of input (e.g., 611b-611c and/or 611f-611g) being directed to the rotatable input mechanism; and configuring the rotatable input mechanism to cause the computer system to perform one or more operations in response to the second set of inputs includes performing a fourth operation in response to the third type of input being directed to the rotatable input mechanism, where the third operation (e.g., an operation that is performed in a first manner and/or at a first rate) is different from the fourth operation (e.g., an operation that is performed in a manner that is different from the first manner and/or at a rate (e.g., speed) that is different from the first rate). In some embodiments, the third type of input is an input that corresponds to a rotational input or is an input that corresponds to a tap input, pressing input, and/or pulling input. Configuring the rotatable input mechanism to cause the computer system to respond a type of input differently when prescribed conditions are met allows the computer system to automatically configure the rotatable input mechanism based on the type of setting that rotatable input mechanism is configured to adjust, which performs an operation when a set of conditions has been met without requiring further user input and provides additional control options without cluttering the user interface with additional displayed controls.

In some embodiments, in response to detecting a rotational input: in accordance with a determination that the rotatable input mechanism (e.g., 602) is configured to cause the computer system to perform one or more operations in response to the first set of inputs, performing the third operation (e.g., and/or performing an operation in the first manner) includes allowing the rotational input mechanism to move no more than a first amount (e.g., as described above in relation to movement characteristics to method 700); and in accordance with a determination that the rotatable input mechanism is configured to cause the computer system to perform one or more operations in response to the second set of inputs, performing the fourth operation (e.g., and/or performing an operation in a manner that is different from the first manner) includes allowing the rotational input mechanism to move no more than a second amount that is different from the first amount (e.g., as described above in relation to movement characteristics in method 700). Configuring the rotatable input mechanism such that the rotatable input mechanism moves by an amount that is based on a setting provides feedback to a user that the setting can only be set to a certain amount and allows the computer system to automatically configure the rotatable input mechanism based on the type of setting that rotatable input mechanism is configured to adjust, which performs an operation when a set of conditions has been met without requiring further user input, provides additional control options without cluttering the user interface with additional displayed controls, and provides feedback.

In some embodiments, in response to detecting the input (e.g., 611a1-611a3) directed to the control and in accordance with a determination that the control corresponds to a fourth type of setting that is different from the first type of setting and the second type of setting, the computer system configures the rotatable input mechanism (e.g., 602) to cause the computer system to perform one or more operations in response to the first set of inputs or the second set of inputs being directed to the rotatable input mechanism (e.g., 602). Configuring the rotatable input mechanism to cause the computer system to perform one or more operations in response to the first set of inputs or the second set of inputs being directed to the rotatable input mechanism when prescribed conditions are met allows the computer system to automatically configure the rotatable input mechanism based on the type of setting that rotatable input mechanism is configured to adjust, which performs an operation when a set of conditions has been met without requiring further user input and provides additional control options without cluttering the user interface with additional displayed controls.

In some embodiments, in response to detecting the input (e.g., 611a1-611a3) directed to the control and in accordance with a determination that the control corresponds to a fifth type of setting that is different from the first type of setting and the second type of setting, the computer system configures the rotatable input mechanism (e.g., 602) to cause the computer system to perform one or more operations in response to a fourth set of inputs being directed to the rotatable input mechanism, where the fourth set of inputs is different from the first set of input and the second set of inputs (as discussed in relation to FIGS. 6A-6G). Configuring the rotatable input mechanism to cause the computer system to perform one or more operations in response to a fourth set of inputs being directed to the rotatable input mechanism that is different from the first and second sets of inputs when prescribed conditions are met allows the computer system to automatically configure the rotatable input mechanism based on the type of setting that rotatable input mechanism is configured to adjust, which performs an operation when a set of conditions has been met without requiring further user input and provides additional control options without cluttering the user interface with additional displayed controls.

In some embodiments, while the rotatable input mechanism is configured to cause the computer system to perform one or more operations in response to the first set of inputs or the second set of inputs being directed to the rotatable input mechanism, the computer system detects a change in movement of the computer system (e.g., computer system is slowing down, computer system has stopped, computer system is speeding up, computer system has started, a determination is made that the computer system will slow down and/or stop within a predetermined period of time, and/or a determination is made that the computer system will start and/or speed up within a predetermined period of time) (as discussed in relation to FIGS. 6A-6G). In some embodiments, in response to detecting the change in movement of the computer system, the computer system configures the rotatable input mechanism to cause the computer system to perform one or more operations in response to a fifth set of inputs being directed to the rotatable input mechanism, where the fifth set of inputs that is different form the first set of inputs and the second set of inputs (as discussed in relation to FIGS. 6A-6G).

Note that details of the processes described above with respect to method 900 (e.g., FIG. 9) are also applicable in an analogous manner to the methods described above. For example, method 800 optionally includes one or more of the characteristics of the various methods described above with reference to method 900. For example, the physical input mechanism of method 800 can be the rotatable input mechanism of method 900. For brevity, these details are not repeated above.

FIGS. 10A-10D illustrate exemplary user interfaces to discuss techniques concerning how a computer system can change the behavior of a rotatable input mechanism as the rotatable input mechanism approaches a terminal position. In particular, FIGS. 10A-10D will be used to describe one technique where computer system 600 configures rotatable input mechanism 602 to lock (e.g., suddenly with a large change in resistance) at a terminal position after being rotated a maximum amount in a direction. Then, FIGS. 10A-10D will be used to describe a different technique where rotatable input mechanism 602 is configured to provide a rubber-banding effect in conjunction with rotatable input mechanism 602 approaching the terminal position. It should be understood that the techniques described below can be used in any combination thereof (e.g., for the same setting) and other similar ways of performing the techniques described below are anticipated.

FIGS. 10A-10D are used to describe one technique where computer system 600 configures rotatable input mechanism 602 to lock (e.g., suddenly without much change in resistance) at a terminal position after being rotated a maximum amount in a direction. FIG. 10A illustrates computer system 600 displaying brightness setting user interface 630 of FIG. 6B. At FIG. 10A, computer system 600 detects clockwise rotational input 611e on rotatable input mechanism 602. As illustrated in FIG. 10B, in response to detecting rotational input 611e, computer system 600 moves current brightness value indicator 634 to the right on brightness slider 632, which causes the current value for the brightness setting to be set to a new value. As computer system 600 moves current brightness value indicator 634 to the right, computer system 600 provides the set of movement characteristics discussed above in relation to FIG. 6B (e.g., while rotatable input mechanism 602 is being rotated between positions 620b2-620b3 of FIG. 6B). At FIG. 10B, computer system 600 causes rotatable input mechanism 602 to provide an abrupt and high level of resistance when indicator 634 reaches the maximum value for the brightness setting and/or when rotatable input mechanism 602 is rotated to a terminal position for the brightness setting. At FIG. 10B, in this scenario, rotatable input mechanism 602 cannot be rotated further in the clockwise direction because the maximum value for the brightness setting has been reached and rotatable input mechanism 602 is configured to lock and/or provide the high level of resistance at this setting (e.g., the terminal position). In some embodiments, the high level of resistance is not the maximum level of resistance that rotatable input mechanism 602 can provide but is a level of resistance that rotatable input mechanism 602 outputs so that it cannot be rotated one or more directions. In some embodiments, at FIG. 10B, computer system 600 detects rotation of rotatable input mechanism 602 in a counterclockwise direction and, in response to detecting the counterclockwise rotation of rotatable input mechanism 602, computer system 600 abruptly locks rotatable input mechanism 602 at a position (e.g., a terminal position) that corresponds to the minimum value for the brightness setting.

It should be understood that computer system 600 dynamically configures rotatable input mechanism 600 to lock at one or more terminal positions based on the type of setting that is currently being adjusted. In some embodiments, if computer system 600 is displaying a user interface for a different type of setting (e.g., a temperature setting, a volume setting, and/or a water flow setting) and/or if rotatable input mechanism 602 is configured to change a different type of setting in response to being rotated, computer system 600 can configure rotatable input mechanism 602 such that rotatable input mechanism 602 locks at the terminal positions for the brightness setting with a shorter (or longer) amount of movement needed to reach the terminal positions. For example, computer system 600 can cause rotatable input mechanism 602 to lock at a position that corresponds to zero degrees of rotation and a position that corresponds to 90 degrees of rotation for a first type of setting, and computer system 600 can cause rotatable input mechanism 602 to lock at a position that corresponds to zero degrees of rotation and a position that corresponds to 300 degrees of rotation for a second type of setting. In some embodiments, computer system 600 allows rotatable input mechanism 602 to be rotated different amounts for different types of settings before locking rotatable input mechanism 602 at a terminal position. Thus, in some embodiments, computer system 600 dynamically controls the number of degrees that rotatable input mechanism 602 can be rotated depending on the type of setting that is selected. In some embodiments, computer system 600 provides a haptic output (e.g., a strong haptic output and/or the strongest haptic output that computer system 600 provides as rotatable input mechanism 602 is moved for a particular setting) or causes rotatable input mechanism 602 to provide the haptic output as rotatable input mechanism 602 is rotated into a position that corresponds to a terminal position. In some embodiments, computer system 600 provides the haptic output or causes rotatable input mechanism 602 to provide the haptic output before (e.g., within a predetermined distance of) being rotated into a position that corresponds to a terminal position.

FIGS. 10A-10D are used to describe a different technique where rotatable input mechanism 602 is configured to provide a rubber-banding effect in conjunction with rotatable input mechanism 602 reaching a terminal position. FIG. 10A illustrates computer system 600 displaying brightness setting user interface. At FIG. 10A, computer system 600 detects clockwise rotational input 611e on rotatable input mechanism 602. As illustrated in FIG. 10B, in response to detecting rotational input 611e, computer system 600 moves current brightness value indicator 634 to the right on brightness slider 632, which causes the current value for the brightness setting to be set to a new value. However, instead of locking rotatable input mechanism 602 at the terminal position as discussed in the scenario above, computer system 600 can allow rotatable input mechanism 602 to be rotated further in this scenario. In this scenario, as rotatable input mechanism 602 is rotated further in the clockwise direction, computer system 600 causes rotatable input mechanism 602 to provide a set of different resistances, where rotatable input mechanism 602 gets harder to turn as rotatable input mechanism 602 is rotated further in the clockwise direction. In other words, computer system 600 causes rotatable input mechanism 602 to increase the level of resistance provided as rotatable input mechanism 602 is rotated further past the terminal position. At FIG. 10C, computer system 600 detects further rotation of rotatable input mechanism 602 in the clockwise direction and allows rotatable input mechanism 602 to continue to turn (albeit harder to turn) until rotatable input mechanism 602 has been rotated a predetermined distance past a terminal position. As illustrated in FIG. 10C, computer system 600 displays current brightness value indicator 634 to the right of brightness slider 632 to indicate that rotatable input mechanism 602 has been rotated past the maximum value for the brightness setting. While computer system 600 displays current brightness value indicator 634 to the right of brightness slider 632, computer system 600 does not continue to cause output of a device (e.g., such as a porch light or a kitchen light) to be adjusted because the current value for the brightness has reached the maximum value. Rather, computer system 600 displays current brightness value indicator 634 to the right of brightness slider 632 to indicate that rotatable input mechanism 602 is being rotated too far (e.g., past the terminal value) (e.g., and, in some embodiments, will spring back). In some embodiments, instead of displaying current brightness value indicator 634 to the right of brightness slider 632, computer system 600 continues to display current brightness value indicator 634 on brightness slider 632 at the position that corresponds to the maximum value (e.g., the position of current brightness value indicator 634 in FIG. 10B) while allowing rotatable input mechanism 602 to continue to turn (albeit harder to turn) until rotatable input mechanism 602 has been rotated a predetermined distance past a terminal position.

At FIG. 10C, rotatable input mechanism 602 has been rotated a predetermined distance (e.g., a non-zero distance) past a terminal position; thus, computer system 600 causes rotatable input mechanism 602 to spring back in the counterclockwise direction (e.g., upon release of rotatable input mechanism 602 or automatically, without regards, to whether rotatable input mechanism 602 has been released), such that rotatable input mechanism 602 returns to the position that corresponds to the terminal position at FIG. 10D. At FIGS. 10B-10C, computer system 600 can provide and/or cause rotatable input mechanism 602 to provide a set of haptic outputs that increase in strength as rotatable mechanism 602 increases the level of resistance provided while being rotated past the terminal position. In some embodiments, the output each of sequential haptic in the set of haptic outputs gets longer as rotatable mechanism 602 increases the level of resistance provided while being rotated past the terminal position. In some embodiments, the set of haptic outputs starts being output and/or physical mechanism 602 begins increasing the level of resistance provided when rotatable input mechanism 602 is at a position before the terminal position. In some embodiments, at FIGS. 10C-10D, computer system 600 can provide and/or cause rotatable input mechanism 602 to provide a set of haptic outputs that decrease in strength as rotatable input mechanism 602 springs back to the terminal position. In some embodiments, computer system 600 does not cause the set of haptic outputs that decrease in strength to be provided as rotatable input mechanism 602 springs back to the terminal position. In some embodiments, the level of resistance provided is determined based on the speed that rotatable input mechanism 602 is being rotated before and/or after the terminal position is reached. In some embodiments, computer system 600 causes rotatable input mechanism 602 to increase the level of resistance provided faster as rotatable input mechanism 602 is being rotated faster towards and/or past the terminal position (or increase the level of resistance provided slower if rotatable input mechanism 602 is being rotated slower). In some embodiments, rotatable input mechanism 602 springs back faster towards the terminal position (e.g., at FIGS. 10C-10D) if rotatable input mechanism 602 was rotated faster towards and/or past the terminal position. In some embodiments, rotatable input mechanism 602 springs back faster when rotatable input mechanism 602 is rotated farther past the terminal position and springs back slower when rotatable input mechanism 602 is not rotated as far past the terminal position. In some embodiments, computer system 600 outputs a set of sounds that increase in pitch as rotatable input mechanism 602 is being rotated towards and/or past the terminal position, and computer system 600 plays a different sound as rotatable input mechanism 602 is springing back into the terminal position. In some embodiments, the sound output while rotatable input mechanism 602 is being rotated towards and/or past the terminal position increases in volume, pitch, and/or tone as rotatable input mechanism 602 is rotated further past the terminal position. In some embodiments, the sound output while rotatable input mechanism 602 is springing back decreases in volume, pitch, and/or tone as rotatable input mechanism 602 gets closer to returning to the terminal position. In some embodiments, after springing back to the terminal position, computer system 600 causes output of a strong haptic and/or sound to indicate that rotatable input mechanism 602 is back at the terminal position. In some embodiments, to spring back, computer system 600 causes rotatable input mechanism 602 to maintain and/or increase the level of resistance provided in the direction opposite of the rotation (e.g., increases or maintains the level of resistance provided in the counterclockwise direction while rotatable input mechanism 602 is being rotated clockwise), such that rotatable input mechanism 602 rotates back when less rotational force is being applied in the direction of rotation.

At FIG. 10D, in response to detecting a counterclockwise rotation, computer system 600 causes rotatable input mechanism 602 to provide the set of movement characteristics, described above in relation to FIG. 10B until rotatable input mechanism 602 is at a position that corresponds to a minimum value for the brightness setting. In some embodiments, as rotatable input mechanism 602 approaches the position that corresponds to the minimum value for the brightness setting, computer system 600 provides and/or causes rotatable input mechanism 602 to provide similar levels of resistances, haptic outputs, and sounds as described above in relation to FIGS. 10A-10D. It should be understood that computer system 600 can cause rotatable input mechanism 602 to behave as described above in other scenarios. As an example, rotatable input mechanism 602 can be used to scroll a webpage while being rotated in the clockwise (or counterclockwise) direction, and upon reaching the end of the webpage, rotatable input mechanism 602 can increase the level of resistance and the strength of haptic outputs provided until an edge of the webpage is shown and cause rotatable input mechanism 602 to spring back when a predetermined amount of a visual indication that a user has scrolled passed the end of the webpage is displayed (or travels a predetermined distance past a predetermined distance in (or opposite of) the direction of scrolling). As another example, rotatable input mechanism 602 can be used to scroll a list of item while being rotated in the clockwise (or counterclockwise) direction and upon reaching the end of the list of items, rotatable input mechanism 602 can increase the level of resistance and the strength of haptic outputs provided until the last item is reached and cause rotatable input mechanism 602 to spring back when a predetermined amount of a visual indication that user has scrolled passed the last items of the list (or is at the end of the list) is displayed. As discussed above in relation to FIGS. 10A-10B and providing different lock positions for a terminal value based on settings, computer system 600 can initiate the rubber-banding effect dynamically at different terminal positions based on the type of setting that computer system 600 configures to be adjusted by rotatable input mechanism 602.

FIG. 11 is a flow diagram illustrating a method for changing a lock position of an input mechanism in accordance with some embodiments. Method 1100 is performed at a computer system (e.g., 100, 300, 500, and/or 600) that is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the physical input mechanism is a part of a platform, such as a vehicle (e.g., an automobile and/or a boat) and/or smart home devices. In some embodiments, input detected at the physical input mechanism causes one or more settings, such as temperature, volume, window opening, window tint, cabin light brightness, and the like, to be updated. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 1100 are, optionally, combined, the orders of some operations are, optionally, changed, and some operations are, optionally, omitted.

As described below, method 1100 provides an intuitive way for changing a lock position of the physical input mechanism. The method reduces the cognitive burden on a user for using the physical input mechanism, thereby creating a more efficient human-machine interface. For battery-operated computing devices, enabling a user to use the physical input mechanism faster and more efficiently conserves power and increases the time between battery charges.

At 1110 of method 1100, the computer system detects movement of a physical input mechanism from a first position and in a first direction (and/or detecting a request to move the physical input mechanism).

At 1120 of method 1100, the computer system, while the physical input mechanism is moving in the first direction, in response to detecting movement (e.g., rotating, horizontal, vertical, yaw movement, inward movement, outward movement, pitch movement, and/or roll movement) of the physical input mechanism from the first position and in the first direction, and in accordance with a determination that movement of the physical input mechanism is configured to change a first type (e.g., a temperature setting, a fan setting, a heating element setting, a volume setting, a brightness setting, a light setting, a contrast setting, a television setting, a cabin setting, a door setting (e.g., a garage door setting, a front door setting, and/or a back door setting) and/or a setting that does not indicate that the physical input mechanism will be configured differently and/or set the physical setting to have a different set of movement characteristics) of setting (e.g., and/or that the physical input mechanism is concurrently configured to change a first type of setting and/or that the physical input mechanism is configured to change the first type of setting), cause the physical input mechanism to stop moving in the first direction after a second position (e.g., a position that is in the first direction respect to the first position) (e.g., a position of the rotatable input mechanism, a position of an indication that is displayed on a display generation component, a position on a user interface object (e.g., a scale with one or more indications of values for a setting)), and/or a first amount that the physical input mechanism is rotated) is reached (e.g., while the physical input mechanism was moving) (e.g., without stopping movement after a third position (e.g., as described below) is reached), wherein the second position is a first distance (e.g., an arc distance/length or a linear distance/length) away from the first position.

At 1130 of method 1100, the computer system, while the physical input mechanism is moving in the first direction, in response to detecting movement (e.g., rotating, horizontal, vertical, yaw movement, inward movement, outward movement, pitch movement, and/or roll movement) of the physical input mechanism from the first position and in the first direction, and in accordance with a determination that movement of the physical input mechanism is configured to change a second type (e.g., a temperature setting, a fan setting, a heating element setting, a volume setting, a brightness setting, a light setting, a contrast setting, a television setting, a cabin setting, a door setting (e.g., a garage door setting, a front door setting, and/or a back door setting) and/or a setting that does not indicate that the physical input mechanism will be configured differently and/or set the physical setting to have a different set of movement characteristics) of setting that is different from the first type of setting, cause the physical input mechanism to stop moving in the first direction after a third position (e.g., a position of the rotatable input mechanism, a position of an indication that is displayed on a display generation component, and/or a second amount that is the physical input mechanism is rotated) (e.g., a position that is a second direction of the first position) is reached (e.g., while the physical input mechanism was moving and without stopping movement after the second position is reached), wherein the third position is a second distance away from the first position (in the first direction), and wherein the first distance is different from the second distance. In some embodiments, the physical input mechanism second position is between the first position and the third position. In some embodiments, the third position is between the first position and the second position. Causing the physical input mechanism to stop moving in a position that based on prescribed conditions allows the computer system to automatically configure the physical input mechanism to lock at position based on a type of setting that the physical input mechanism can be used to adjust, which performs an operation when a set of conditions has been met without requiring further user input and provides improved feedback to the user and provides feedback about the setting.

In some embodiments, the second position corresponds to a minimum value (e.g., 0, 0%, off, very low, low, and/or inactive) for the first type of setting. In some embodiments, the third position corresponds to a minimum value for the second type of setting. In some embodiments, the minimum value for the first type of setting is different from the minimum value for the second type of setting. In some embodiments, when an indication (e.g., a marker (e.g., a shape (e.g., a circle, a square, a triangle), a highlighted portion) of the current value is at the second position and/or is near the second position, the value for the first type of setting is set to the minimum value for the first type of setting. In some embodiments, when the indication of the current value is at the third position, the value for the second type of setting is set to the minimum value for the second type of setting. In some embodiments, the second position (e.g., corresponding to the minimum value) is a position that is to the left of a scale that indicates the range of values for the first type of setting and the third position (e.g., corresponding to the minimum value) is a position that is to the left of a scale that indicates the range of values for the second type of setting (e.g., 612, 614, and/or 616). Causing the physical input mechanism to stop moving in at a minimum position that based on prescribed conditions allows the computer system to automatically configure the physical input mechanism to lock at position based on a type of setting that the physical input mechanism can be used to adjust, which performs an operation when a set of conditions has been met without requiring further user input and provides improved feedback to the user and provides feedback about the setting.

In some embodiments, the second position corresponds to a maximum value (e.g., 100, 100%, on, very high, high, and/or active) for the first type of setting (e.g., 612, 614, and/or 616). In some embodiments, the third position corresponds to a maximum value for the second type of setting (e.g., 612, 614, and/or 616). In some embodiments, the maximum value for the first type of setting is different from the maximum value for the second type of setting. In some embodiments, when the indication of the current value is at the second position and/or is near the second position, the value for the first type of setting is set to the maximum value for the first type of setting. In some embodiments, when the indication of the current value is at the third position, the value for the second type of setting is set to the maximum value for the second type of setting. In some embodiments, the second position (e.g., corresponding to the maximum value) is a position that is to the right of a scale that indicates the range of values for the first type of setting and the third position (e.g., corresponding to the maximum value) is a position that is to the right of a scale that indicates the range of values for the second type of setting. Causing the physical input mechanism to stop moving in at a maximum position that based on prescribed conditions allows the computer system to automatically configure the physical input mechanism to lock at position based on a type of setting that the physical input mechanism can be used to adjust, which performs an operation when a set of conditions has been met without requiring further user input and provides improved feedback to the user and provides feedback about the setting.

In some embodiments, the physical input mechanism (e.g., 602) is a rotational input mechanism (e.g., and/or is, optionally and/or selectively, rotatable and/or twistable (e.g., when the physical input mechanism is configured to be rotatable and/or twistable).

Causing the physical input mechanism to stop rotating in at a position that based on prescribed conditions allows the computer system to automatically configure the physical input mechanism to lock at position based on a type of setting that the physical input mechanism can be used to adjust, which performs an operation when a set of conditions has been met without requiring further user input and provides improved feedback to the user and provides feedback about the setting.

In some embodiments, while the physical input mechanism (e.g., 602) configured to change the first type of setting (e.g., 612, 614, and/or 616), the physical input mechanism is configured to stop moving in the first direction after the second position is reached, In some embodiments, the computer system, while the physical input mechanism is configured to change the first type of setting (e.g., 612, 614, and/or 616), detects a request to configure the physical input mechanism to change a third type of setting (e.g., 612, 614, and/or 616) that is different from the first type of setting and the second type of setting. In some embodiments, as a part of detecting the request to configure the physical input mechanism to change the third type of setting, the computer system detects an input (e.g., a tap input and, in some embodiments, a non-tap input, such as a swipe input, a mouse click, a button press, a gaze input, an air gesture input, and/or a gaze input with an air gesture input) directed to (e.g., at a location corresponding to and/or on) a control. In some embodiments, the control is a user interface object. In some embodiments, the computer system displays the control on the user interface. In some embodiments, the control is a physical control that is not displayed. In some embodiments, the control is a settings control (e.g., a temperature control, a volume control, a fan control, and/or a heating element control (e.g., a heating pad control, a water heating element control, and/or a seat heating element control)). In some embodiments, the control is a value for a setting that is not displayed. In some embodiments, the computer system displays the control on a user interface that does not indicate (e.g., via text and/or symbols) that characteristics of physical input mechanism will be changed (e.g., while, in some embodiments, indicates that one or more other settings (e.g., volume, temperature, a fan, and/or a heating element) will be changed). In some embodiments, the control is a selectable user interface object. In some embodiments, in response to detecting the request to configure the physical input mechanism (e.g., 602) to change the third type of setting, the computer system configures the physical input mechanism to stop moving in the first direction after a fourth position is reached (e.g., without stopping movement after the second position is reached). In some embodiments, the fourth position is different from the second position (and, in some embodiments, the first position and the third position). In some embodiments, the fourth position is a greater or lesser distance away from the first position than the second position is from the first position. Configuring the physical input mechanism to stop moving in the first direction after a fourth position is reached in response to detecting the request to configure the physical input mechanism to change the third type of setting allows the user to control the locking position of the physical input mechanism by choosing a different setting, which provides the user with more control over the user interface without cluttering the user interface.

In some embodiments, while the physical input mechanism configured to change the first type of setting (e.g., 612, 614, and/or 616), the physical input mechanism is configured to stop moving in a second direction, different from (e.g., inverse of and/or opposite from (e.g., counterclockwise vs clockwise)) the first direction, after a fifth position is reached. In some embodiments, in response to detecting the request to configure the physical input mechanism to change the third type of setting, the computer system configures the physical input mechanism (e.g., 602) to stop moving in the second direction after a fifth position is reached. In some embodiments, the fifth position is different from (e.g., a position that is a further distance away from and/or a lesser distance away from a position) the fourth position (and, in some embodiments, the first position, the second position, and/or the third position) (e.g., while the physical input mechanism continues to be configured to stop moving in the first direction after the first position, second position, third position, or fourth position is reached). Configuring the physical input mechanism to stop moving in the second direction after a fifth position is reached allows the computer system to automatically configure the physical input mechanism to lock at position that is in a different direction based on a type of setting that the physical input mechanism can be used to adjust, which performs an operation when a set of conditions has been met without requiring further user input and provides improved feedback to the user and provides feedback about the setting.

In some embodiments, in response to detecting the request to configure the physical input mechanism to change the third type of setting (e.g., 612, 614, and/or 616), the computer system configures the physical input mechanism to change the third type of setting. In some embodiments, while the physical input mechanism (e.g., 602) is configured to change the third type of setting, the computer system detects movement of the physical input mechanism in a respective direction (e.g., first direction or second direction; and/or counterclockwise direction or clockwise direction) from a respective position. In some embodiments, as a part of detecting movement of the physical input mechanism, the computer system detects that the physical input mechanism is being turned, rotated, and/or twisted. In some embodiments, the computer system detects an input/gesture (e.g., a flicking air gesture, a press-and-hold input, a click and drag input, a click and rotate input, a pinch a rotate air gesture, and/or a gaze input) as a part of detecting movement of the physical input mechanism. In some embodiments, in response to detecting movement of the physical input mechanism in the respective direction from the respective position (and, for example, while the physical input mechanism is configured to change the third type of setting) and while the physical input mechanism is moving in the respective direction, the computer system:nin accordance with a determination that the respective direction is the first direction, causes the physical input mechanism (e.g., 602) to stop moving in the respective direction after the third position is reached (e.g., without causing the physical input mechanism to stop moving in the respective direction after the fifth position is reached); and in accordance with a determination that the respective direction is the second direction, causes the physical input mechanism to stop moving in the respective direction after the fifth position is reached (e.g., without causing the physical input mechanism to stop moving in the respective direction after the third position is reached). Causing the physical input mechanism to stop moving in the respective direction after the third position is reached or causing the physical input mechanism to stop moving in the respective direction after the fifth position is reached allow the computer system to provide feedback to the user that a terminal value has been reached for multiple directions of rotation.

In some embodiments, in accordance with a determination that movement of the physical input mechanism is configured to change the first type of setting, the computer system causes output of a first haptic when the second position is reached (e.g., without causing output of the haptic when the third position is reached). In some embodiments, in accordance with a determination that movement of the physical input mechanism is configured to change the second type of setting, the computer system causes output of a second haptic when the third position is reached (e.g., without causing output of the haptic when the second position is reached). In some embodiments, the first haptic is different from the second haptic; in other embodiments, the same as. Causing output of a haptic that is based the setting of which movement of the physical input mechanism is configured to change allows the computer system to provide a haptic output at a lock position that is based on a setting, where the haptic is based on the setting, which provides feedback to a user.

In some embodiments, in accordance with a determination that movement of the physical input mechanism (e.g., 602) is configured to change the first type of setting, the computer system causes output of a third haptic within a predetermined distance of reaching (e.g., before reaching and/or after reaching) the second position. In some embodiments, in accordance with a determination that movement of the physical input mechanism is configured to change the second type of setting (e.g., 612, 614, and/or 616), the computer system causes output of a fourth haptic within a predetermined distance of reaching the third position. In some embodiments, the third haptic is different from the fourth haptic; in other embodiments, the same as. Causing output of a third haptic or fourth haptic within a predetermined distance of reaching a respective position allows provide a haptic output before reaching a lock position that is based on a setting, where the haptic is based on the setting, which provides feedback to a user.

In some embodiments, while movement of the physical input mechanism is configured to change the first type of setting, a first user interface object (e.g., a scale, a slider, and/or one or more options) indicating a range of values (e.g., 0-100, on, off, very high, high, very low, low, and/or medium) (e.g., values to which the a setting can be set) corresponding to the first type of setting (e.g., 612, 614, and/or 616) is displayed and a first indication (e.g., 634) (e.g., a highlighting and/or mark (e.g., a shape, circle, triangle, and/or square) on a value (e.g., tick mark and/or position) of a scale) of a current value (e.g., value at which the first type of setting is currently set) for the first type of setting is displayed relative to (e.g., on, near, adjacent to, and/or in an area that corresponds to) the first user interface object. In some embodiments, while the physical input mechanism is moving in the first direction and in response to detecting movement of the physical input mechanism from the first position and in the first direction and while movement of the physical input mechanism (e.g., 602) is configured to change the first type of setting (e.g., 612, 614, and/or 616), the computer system: moves (e.g., display of) the first indication relative to the first user interface object based on the movement of the physical input mechanism; and in accordance with a determination that the second position has been reached: causes the physical input mechanism to stop moving in the first direction at the second position; and ceases to move the first indication (e.g., 632) past (at and/or after in the first direction) a first location (e.g., a location relative to the first user interface object and/or a location on the display generation component) that corresponds to the second position. Ceasing to move the first indication past a first location that corresponds to the second position provide an indication that a lock position has been reached, which provides feedback to a user.

In some embodiments, while movement of the physical input mechanism is configured to change the first type of setting, a first user interface object (e.g., a scale, a slider, and/or one or more options) indicating a range of values (e.g., 0-100, on, off, very high, high, very low, low, and/or medium) (e.g., values to which the a setting can be set) corresponding to the first type of setting (e.g., 612, 614, and/or 616) is displayed and a first indication (e.g., a highlighting and/or mark (e.g., a shape, circle, triangle, and/or square) on a value (e.g., tick mark and/or position) of a scale) of a current value (e.g., value at which the first type of setting is currently set) for the first type of setting is displayed relative to (e.g., on, near, adjacent to, and/or in an area that corresponds to) the first user interface object. In some embodiments, while the physical input mechanism is moving in the first direction and in response to detecting movement of the physical input mechanism (e.g., 602) from the first position and in the first direction and while movement of the physical input mechanism is configured to change the first type of setting (e.g., 612, 614, and/or 616), the computer system moves (e.g., display of) the first indication relative to the first user interface object based on the movement of the physical input mechanism; and in accordance with a determination that the second position has been reached, ceases to move the first indication past (at and/or after in the first direction) a second location that corresponds to the second position without causing the physical input mechanism to stop moving in the first direction.

In some embodiments, while movement of the physical input mechanism is configured to change the second type of setting, a second user interface object indicating a range of values corresponding to the second type of setting is displayed and a second indication (e.g., 634) of a current value for the second type of setting is displayed relative to the second user interface object; and the second user interface object is different from the first user interface object. In some embodiments, the appearance of the second user interface object is different from the first user interface object. In some embodiments, while the physical input mechanism is moving in the first direction and in response to detecting movement of the physical input mechanism (e.g., 602) from the first position and in the first direction and while movement of the physical input mechanism is configured to change the second type of setting (e.g., 612, 614, and/or 616), the computer system moves (e.g., display of) the second indication relative to the second user interface object based on the movement of the physical input mechanism; and in accordance with a determination that the third position has been reached: causes the physical input mechanism (e.g., 602) to stop moving in the first direction at the third position (and, in some embodiments, without causing the physical input mechanism to stop moving in the first direction at the second position); and ceases to move the second indication past (at and/or after in the first direction) a first location that corresponds to the third position (and, in some embodiments, without ceasing to move the second indication at the first location that corresponds to the second position).

In some embodiments, while movement of the physical input mechanism (e.g., 602) is configured to change the second type of setting, a second user interface object indicating a range of values corresponding to the second type of setting is displayed and a second indication of a current value for the second type of setting is displayed relative to the second user interface object; and the second user interface object is different from the first user interface object. In some embodiments, the appearance of the second user interface object is different from the first user interface object. Ceasing to move the second indication past a first location that corresponds to the third position provides feedback to a user that the third position has been reached and/or that physical input mechanism is at a terminal position, which provides feedback to a user.

In some embodiments, while the physical input mechanism is moving in the first direction and in response to detecting movement of the physical input mechanism from the first position and in the first direction and while movement of the physical input mechanism is configured to change the second type of setting, the computer system: moves (e.g., display of) the second indication relative to the second user interface object based on the movement of the physical input mechanism; and in accordance with a determination that the third position has been reached, ceases to move the second indication past (at and/or after in the first direction) a second location that corresponds to the third position without causing the physical input mechanism to stop moving in the first direction (and, in some embodiments, without ceasing to move the second indication at the second location that corresponds to the second position). Ceasing to move the second indication past a second location that corresponds to the third position without causing the physical input mechanism to stop moving in the first direction provides feedback to a user that the third position has been reached and/or that physical input mechanism is at a terminal position, which provides feedback to a user.

Note that details of the processes described above with respect to method 1100 (e.g., FIG. 11) are also applicable in an analogous manner to the methods described below.

For example, method 1200 optionally includes one or more of the characteristics of the various methods described above with reference to method 1100. For example, the physical input mechanism of method 1100 can be the physical input mechanism of method 1200. For brevity, these details are not repeated below.

FIG. 12 is a flow diagram illustrating a method for rubber-banding with an input mechanism using a computer system in accordance with some embodiments. Method 1200 is performed at a computer system (e.g., 100, 300, 500, and/or 600) that is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the physical input mechanism is a part of a platform, such as a vehicle (e.g., an automobile and/or a boat) and/or smart home devices. In some embodiments, input detected at the physical input mechanism causes one or more settings, such as temperature, volume, window opening, window tint, cabin light brightness, and the like, to be updated. In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 1200 are, optionally, combined, the orders of some operations are, optionally, changed, and some operations are, optionally, omitted.

As described below, method 1200 provides an intuitive way for rubber-banding with the physical input mechanism. The method reduces the cognitive burden on a user for using the physical input mechanism, thereby creating a more efficient human-machine interface. For battery-operated computing devices, enabling a user to use the physical input mechanism faster and more efficiently conserves power and increases the time between battery charges.

At 1210 of method 1200, the computer system detects movement of the physical input mechanism (and/or detecting a request to move the physical input mechanism).

At 1220 of method 1200, the computer system, in response to detecting movement (e.g., rotating, horizontal, vertical, yaw movement, inward movement, outward movement, pitch movement, and/or roll movement) of the physical input mechanism and in accordance with a determination that movement of the physical input mechanism is configured to change a first type (e.g., as described above in relation to method 1100) of setting, cause the physical input mechanism to provide (e.g., output, be, and/or issue) a first set of resistances (e.g., a first level of resistance (e.g., an amount of resistance and/or a resistance that has a particular amount of force and/or pressure), second level of resistance, and/or third level of resistance) (and, in some embodiments, only one level of resistance; in other embodiments, multiple levels of resistance) while (e.g., and/or during and/or when) the physical input mechanism is moved by a respective amount (e.g., one level of resistance is provided while physical input mechanism is moved less than an amount of the respective amount and a different level of resistance is providing while the physical input mechanism is moved more than the amount of the respective amount). In some embodiments, the first set of resistances does not stop movement of the physical input mechanism from further movement but rather provides resistance to further movement that is overcome with additional movement.

At 1230 of method 1200, the computer system, in response to detecting movement (e.g., rotating, horizontal, vertical, yaw movement, inward movement, outward movement, pitch movement, and/or roll movement) of the physical input mechanism and in accordance with a determination that movement of the physical input mechanism is configured to change a second type (e.g., as described above in relation to method 1100) of setting that is different from the first type of setting, causing the physical input mechanism to provide a second set of resistances (e.g., the first level of resistance, a fourth level of resistance, and/or first level of resistance) (and, in some embodiments,, only one level of resistance; in other embodiments, multiple levels of resistance), different from the first set of resistances, while the physical input mechanism is moved by the respective amount. In some embodiments, the second set of resistances does not stop movement of the physical input mechanism from further movement but rather provides resistance to further movement that is overcome with additional movement. Causing the physical input mechanism to provide a particular set of resistance based on prescribed conditions allows the computer system to configure the physical input mechanism to behave in a certain manner based on a setting the physical input mechanism can be used to adjust, which performs an operation when a set of conditions has been met without requiring further user input and provides improved feedback to the user and provides feedback about the setting.

In some embodiments, the first set of resistances are provided in accordance with a determination that a first position (e.g., a position, as described above in relation to method 1100) corresponding to a minimum value (e.g., 0, 0%, off, very low, low, and/or inactive) for the first type of setting (e.g., 612, 614, and/or 616) has been reached, and wherein the second set of resistances are provided in accordance with a determination that a second position (e.g., a position, as described above in relation to method 1100) corresponding a minimum value for the second type of setting (e.g., 612, 614, and/or 616) has been reached. In some embodiments, the minimum value for the first type of setting is different from the minimum value for the second type of setting. In some embodiments, when an indication (e.g., a marker (e.g., a shape (e.g., a circle, a square, a triangle), a highlighted portion) of the current value is at (e.g., and/or at a location that corresponds to) the first position and/or is near the first position, the value for the first type of setting is set to the minimum value for the first type of setting. In some embodiments, when the indication of the current value is at the second position, the value for the second type of setting is set to the minimum value for the second type of setting. In some embodiments, the first position (e.g., corresponding to the minimum value) is a position that is to the left of a scale that indicates the range of values for the first type of setting and the second position (e.g., corresponding to the minimum value) is a position that is to the left of a scale that indicates the range of values for the second type of setting. Causing the physical input mechanism to provide a particular set of resistance based on prescribed conditions when a minimum value is reached allows the computer system to configure the physical input mechanism to behave in a certain manner based on a setting the physical input mechanism can be used to adjust, which performs an operation when a set of conditions has been met without requiring further user input and provides improved feedback to the user and provides feedback about the minimum value being reached.

In some embodiments, the first set of resistances are provided in accordance with a determination that a third position (e.g., a position, as described above in relation to method 1100) corresponding to a maximum value (e.g., 100, 100%, on, very high, high, and/or active) for the first type of setting (e.g., 612, 614, and/or 616) has been reached. In some embodiments, the second set of resistances are provided in accordance with a determination that a fourth position (e.g., a position, as described above in relation to method 1100) corresponding to a maximum value for the second type of setting (e.g., 612, 614, and/or 616) has been reached. In some embodiments, the maximum value for the first type of setting is different form the maximum value for the second type of setting. In some embodiments, when the indication of the current value is at (e.g., and/or at a location corresponding to) the third position and/or is near the third position, the value for the first type of setting is set to the maximum value for the first type of setting. In some embodiments, when the indication of the current value is at the fourth position, the value for the second type of setting is set to the maximum value for the second type of setting. In some embodiments, the third position (e.g., corresponding to the maximum value) is a position that is to the right of a scale that indicates the range of values for the first type of setting and the fourth position (e.g., corresponding to the maximum value) is a position that is to the right of a scale that indicates the range of values for the second type of setting. Causing the physical input mechanism to provide a particular set of resistance based on prescribed conditions when a maximum value is reached allows the computer system to configure the physical input mechanism to behave in a certain manner based on a setting the physical input mechanism can be used to adjust, which performs an operation when a set of conditions has been met without requiring further user input and provides improved feedback to the user and provides feedback about the maximum value being reached.

In some embodiments, the physical input mechanism is a rotational input mechanism (e.g., 602) (e.g., and/or is, optionally and/or selectively, rotatable and/or twistable (e.g., when it is configured to be rotatable and/or twistable). Causing the physical input mechanism to provide a particular set of resistance based on prescribed conditions allows the computer system to configure the physical input mechanism to rotate in a certain manner based on a setting the physical input mechanism can be used to adjust, which performs an operation when a set of conditions has been met without requiring further user input and provides improved feedback to the user and provides feedback about the setting.

In some embodiments, causing the physical input mechanism to provide the first set of resistances while the physical input mechanism is moved by the respective amount includes: causing the physical input mechanism to provide a first level of resistance while the physical input mechanism is moved a first amount of the respective amount; and causing the physical input mechanism to provide a second level of resistance while the physical input mechanism is moved a second amount of the respective amount, wherein the second amount is different from (e.g., separate from, is not encompassed by, and/or does not include) the first amount, and wherein the first level of resistance is different from the second level of resistance. In some embodiments, the second level of resistance is greater than or less than the first level of resistance. In some embodiments, the first set of resistances increase or decrease as the physical input mechanism is moved in a respective direction. Causing the physical input mechanism is moved a first amount of the respective amount and causing the physical input mechanism to provide a second level of resistance while the physical input mechanism is moved a second amount of the respective amount allows the computer system to provide feedback to the user concerning the current position of the physical input mechanism, which provides feedback to the user. Causing the physical input mechanism to provide the first level of resistance while the physical input mechanism is moved a first portion of the respective amount and causing the physical input mechanism to provide a fourth level of resistance while the physical input mechanism is moved a second portion of the respective amount allows the computer system to provide feedback to the user concerning the current position of the physical input mechanism, which provides feedback to the user.

In some embodiments, causing the physical input mechanism to provide the second set of resistances while the physical input mechanism (e.g., 602) is moved by the respective amount includes: causing the physical input mechanism to provide a third level of resistance while the physical input mechanism is moved the first amount and the second amount of the respective amount (e.g., the entire time while and/or during the movement). In some embodiments, the third level of resistance is the first level of resistance, the second level of resistance, or a different level of resistance. Causing the physical input mechanism to provide a third level of resistance while the physical input mechanism is moved the first amount and the second amount of the respective amount allows the computer system to provide feedback to the user concerning the current position of the physical input mechanism, which provides feedback to the user. Causing the physical input mechanism to provide a third set of resistances, different from the first set of resistances and the second set of resistances, while the physical input mechanism is moved by the respective amount in accordance with a determination that movement of the physical input mechanism is configured to change a third type of setting allows the computer system to configure the physical input mechanism to behave in a certain manner based on a setting the physical input mechanism can be used to adjust, which performs an operation when a set of conditions has been met without requiring further user input and provides improved feedback to the user and provides feedback about the setting.

In some embodiments, causing the physical input mechanism (e.g., 602) to provide the second set of resistances while the physical input mechanism is moved by the respective amount includes: causing the physical input mechanism to provide the first level of resistance while the physical input mechanism is moved a first portion of the respective amount; and causing the physical input mechanism to provide a fourth level of resistance while the physical input mechanism (e.g., 602) is moved a second portion of the respective amount, wherein the second portion is different from (e.g., separate from, is not encompassed by, and/or does not include) the first portion, and wherein the first level of resistance is different from the fourth level of resistance (e.g., rubber-banding effect can be different for different settings irrespective of value).

In some embodiments, in accordance with a determination that movement of the physical input mechanism is configured to change a third type (e.g., as described above in relation to method 1100) of setting (e.g., 612, 614, and/or 616) that is different from the first type of setting (e.g., 612, 614, and/or 616), the computer system causes the physical input mechanism (e.g., 602) to provide a third set of resistances, different from the first set of resistances and the second set of resistances, while the physical input mechanism is moved by the respective amount. Causing the physical input mechanism to provide the first set of resistances or the second set of resistances while the physical input mechanism is moved by the respective amount in accordance with a determination that movement of the physical input mechanism is configured to change a fourth type of setting allows the computer system to configure the physical input mechanism to behave in a certain manner based on a setting the physical input mechanism can be used to adjust, which performs an operation when a set of conditions has been met without requiring further user input and provides improved feedback to the user and provides feedback about the setting.

In some embodiments, in accordance with a determination that movement of the physical input mechanism (e.g., 602) is configured to change a fourth type (e.g., as described above in relation to method 1100) of setting that is different from the first type of setting and the second type of setting, the computer system causes the physical input mechanism to provide the first set of resistances or the second set of resistances while the physical input mechanism (e.g., 602) is moved by the respective amount.

In some embodiments, the first set of resistances are provided based on a speed of movement of the physical input mechanism (and, in some embodiments, more resistance is provided as the speed of movement of the physical input mechanism increases, and less resistance is proved as the speed of the movement of the physical input mechanism decreases). In some embodiments, the second set of distances are provided based on the speed of movement of the physical input mechanism. Providing the first set of resistances are provided based on a speed of movement of the physical input mechanism provides feedback about the state of the physical input mechanism.

In some embodiments, the first set of resistance are provided based on a distance that the physical input mechanism has moved (and, in some embodiments, more resistance is provided as the distance that the physical input mechanism moves (e.g., moves and/or moves past and/or within a predetermined distance of a certain point and/or a terminal position (e.g., a position that corresponds to a maximum and/or minimum value)) increases, and less resistance is proved as the distance that the physical input mechanism moves (e.g., moves and/or moves past and/or within a predetermined distance of a certain point and/or a terminal position (e.g., a position that corresponds to a maximum and/or minimum value)) decreases). In some embodiments, the second set of distances are provided based on the distance that the physical input mechanism has moved.

In some embodiments, the first set of resistances includes a first resistance that has a third level of intensity (e.g., an amount of force and/or pressure); the second set of resistances includes a second resistance that has a second level of intensity (e.g., an amount of force and/or pressure) that is different from the first level of intensity; the first resistance is provided at a position that corresponds to a respective value (e.g., a terminal value (e.g., a maximum or minimum value for a setting)) for a range of values corresponding to the first type of setting (e.g., 612, 614, and/or 616); and the second resistance is provided at a position that corresponds to the respective value for a range of values corresponding to the second type of setting. In some embodiments, the position (e.g., as described above in relation to method 1100) that corresponds to the terminal value for the range of values corresponding to the second type of setting (e.g., 612, 614, and/or 616) is different from the position that corresponds to the terminal value for the range of values corresponding to the first type of setting.

In some embodiments, before detecting movement of the physical input mechanism, the computer system detects an input that is directed to a control (e.g., as described above in relation to method 1100). In some embodiments, in response to detecting the input (e.g., a tap input and, in some embodiments, a non-tap input, such as a swipe input, a mouse click, a button press, a gaze input, an air gesture input, and/or a gaze input with an air gesture input) directed to (e.g., at a location corresponding to and/or on) directed to the control (e.g., as described above in relation to method 1100) and in accordance with a determination that the control corresponds to the first type of setting, the computer system configures the physical input mechanism such that movement of the physical input mechanism is configured to change the first type of setting (e.g., without being configured to change the second type of setting (e.g., 612, 614, and/or 616)) (e.g., in response to detecting input (e.g., a rotational input, a tap input and, in some embodiments, a non-tap input and/or a non-rotational input, such as a swipe input, a mouse click, a button press, a gaze input, an air gesture input, and/or a gaze input with an air gesture input) directed to (e.g., at a location corresponding to and/or on) directed to the physical input mechanism). In some embodiments, in accordance with a determination that the control corresponds to the first type of setting (e.g., 612, 614, and/or 616), the computer system displays a first user interface for the first type of setting.

In some embodiments, in response to detecting the input and in accordance with a determination that the control corresponds to the second type of setting, the computer system configures the physical input mechanism such that movement of the physical input mechanism is configured to change the second type of setting (e.g., without being configured to change the first type of setting) (e.g., in response to detecting input (e.g., a rotational input, a tap input and, in some embodiments, a non-tap input and/or a non-rotational input, such as a swipe input, a mouse click, a button press, a gaze input, an air gesture input, and/or a gaze input with an air gesture input) directed to (e.g., at a location corresponding to and/or on) directed to the physical input mechanism (e.g., 602)). In some embodiments, in accordance with a determination that the control corresponds to the first type of setting, the computer system displays a second user interface for the second type of setting that is different from the user interface for the first type of setting. Configuring the physical input mechanism to change a certain setting in response to detecting the input provides the user with control over what an input to the rotatable input mechanism will cause to change, which provides the user with more control over the user interface without cluttering the user interface.

Note that details of the processes described above with respect to method 1200 (e.g., FIG. 12) are also applicable in an analogous manner to the methods described above and below. For example, method 1300 optionally includes one or more of the characteristics of the various methods described above with reference to method 1200. For example, the physical input mechanism of method 1200 can be the physical input mechanism of method 1300. For brevity, these details are not repeated below.

FIG. 13 is a flow diagram illustrating a method for outputting haptics with an input mechanism using a computer system in accordance with some embodiments. Method 1300 is performed at a computer system (e.g., 100, 300, 500, and/or 600) that is in communication with a physical (e.g., a hardware and/or non-displayed) input mechanism (e.g., a hardware input mechanism, a rotatable input mechanism, a crown, a knob, a dial, a physical slider, and/or a hardware button). In some embodiments, the physical input mechanism is a part of a platform, such as a vehicle (e.g., an automobile and/or a boat) and/or smart home devices. In some embodiments, input detected at the physical input mechanism causes one or more settings, such as temperature, volume, window opening, window tint, cabin light brightness, and the like, to be updated. In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide angle cameras). Some operations in method 1300 are, optionally, combined, the orders of some operations are, optionally, changed, and some operations are, optionally, omitted.

As described below, method 1300 provides an intuitive way for outputting haptics with the physical input mechanism. The method reduces the cognitive burden on a user for using the physical input mechanism, thereby creating a more efficient human-machine interface. For battery-operated computing devices, enabling a user to use the physical input mechanism faster and more efficiently conserves power and increases the time between battery charges.

At 1310 of method 1300, the computer system, while detecting movement of the physical input mechanism in a first direction (and/or while detecting that the physical input mechanism is being moved in the first direction), detects that the physical input mechanism is at a location (e.g., the physical location and/or rotational location (e.g., 1-12 o′ clock) of a dial) that corresponds to a first position (e.g., as described above in relation to method 1100).

At 1320 of method 1300, the computer system, in response to detecting that the physical input mechanism is at the location that corresponds to the first position (e.g., and while detecting movement of the physical input mechanism in the first direction and in accordance with a determination that the first position is within a threshold distance (e.g., 0-2 meters) (e.g., a zero threshold distance or a non-zero threshold distance) from a respective position (e.g., a terminal position, a stopping position, a position that corresponds to a maximum value of a setting, a position that corresponds to a minimum value of a setting, and/or a position of an indication that is displayed), causes the physical input mechanism to provide (e.g., to output and/or to vibrate) a set of haptics with intensity levels that change in a first manner (increase or decrease; get stronger or get weaker) as the physical mechanism is moved in the first direction (e.g., each haptics of the set of haptics gets stronger as the physical mechanism is moved). In some embodiments, causing the physical input mechanism to provide a set of haptics includes causing a set of haptics that can be felt at the physical input mechanism and/or causing a set of haptics that makes the physical input mechanism vibrate. In some embodiments, causing the physical input mechanism to provide the set of haptics includes causing the computer system to vibrate and/or causing a set of haptics that makes the computer system vibrate. Causing the physical input mechanism to provide a set of haptics with intensity levels that change in a first manner as the physical mechanism is moved in the first direction when prescribed conditions are met allows the computer system to automatically provide haptic outputs as physical input mechanism is being rotated to a certain position, which performs an operation when a set of conditions has been met without requiring further user input and provides improved feedback to the user and provides feedback about the setting.

In some embodiments, the movement of the physical input mechanism (e.g., 602) includes a rotation of the physical input mechanism. In some embodiments, the physical input mechanism is a rotatable input mechanism. Causing the physical input mechanism to provide a set of haptics with intensity levels that change in a first manner as the physical mechanism is rotated in the first direction when prescribed conditions are met allows the computer system to automatically provide haptic outputs as physical input mechanism is being rotated to a certain position, which performs an operation when a set of conditions has been met without requiring further user input and provides improved feedback to the user and provides feedback about the setting.

In some embodiments, causing the physical input mechanism to provide the set of haptics with intensity levels that change in the first manner as the physical mechanism is moved in the first direction includes: while detecting movement of the physical input mechanism in the first direction (e.g., by a first amount in the first direction), detecting that the physical input mechanism is at a location that corresponds to a second position that is within the threshold distance from the respective position; in response to detecting that the physical input is at the location that corresponds to the second position that is within the threshold distance from the respective position, causing the physical input mechanism to provide a first haptic of the set of haptics (e.g., while the physical input mechanism is moving), where the first haptic has a first level of intensity (e.g., as described above in relation to method 1200); after causing the physical input mechanism to provide the first haptic, detecting that the physical input mechanism has moved from the location that corresponds to the second position to a location that corresponds to a third position that is within the threshold distance from the respective position, where the third position is further away from the first position in the first direction than the second position is away from the first position in the first direction; in response to detecting that the physical input mechanism has moved from the location that corresponds to the second position to the location that corresponds to the third position, causing the physical input mechanism to provide a second haptic (e.g., without providing the first haptic) of the set of haptics while the physical input mechanism is moving, where the second haptic has a second level of intensity that is greater than (e.g., stronger than, has more pressure than, and/or is more forceful than) the first level of intensity; after causing the physical input mechanism to provide the second haptic, detecting that the physical input mechanism has moved from the location that corresponds to the third position to a location that corresponds to a fourth position that is within the threshold distance from the respective position, where the fourth position is further away from the first position in the first direction than the third position is away from the first position in the first direction; and in response to detecting that the physical input mechanism has moved from the location that corresponds to the third position to the location that corresponds to the fourth position, causing the physical input mechanism to provide a third haptic (e.g., without providing the first and second haptics) of the set of haptics while the physical input mechanism is moving, where the third haptic has a third level of intensity that is greater than the second level of intensity and the first level of intensity. Causing the physical input mechanism to provide a set of haptics with intensity levels that increase as the physical mechanism is moved allows the computer system to automatically provide haptic outputs as physical input mechanism is being rotated to a certain position and informs the user that physical input mechanism is getting closer to a position, which performs an operation when a set of conditions has been met without requiring further user input and provides improved feedback to the user and provides feedback about the setting.

In some embodiments, while detecting movement of the physical input mechanism in the first direction and after detecting that the physical input mechanism is at the location that corresponds to the first position, the computer system detects that the physical input mechanism is at a location that corresponds to a fifth position (and, in some embodiments, the fifth position is the respective position). In some embodiments, in response to detecting that the physical input mechanism is at the location that corresponds to the fifth position and in accordance with a determination that a set of criteria has been met, where the set of criteria includes a criterion that is met when the location that corresponds to the fifth position is a location that corresponds to the respective position, the computer system causes the physical input mechanism to move in a second direction that is different from the first direction (e.g., automatically and without user input (e.g., on and/or directed to the physical input mechanism)). In some embodiments, in response to detecting that the physical input mechanism is at the location that corresponds to the fifth position and in accordance with a determination that the set of criteria has not been met, the computer system does not cause the physical input mechanism to move in the second direction (e.g., automatically and without user input (e.g., on the physical input mechanism)). Causing the physical input mechanism to move in a second direction that is different from the first direction and in accordance with a determination that a set of criteria has been met allows the computer system to automatically provide feedback that a terminal value has been reached, which performs an operation when a set of conditions has been met without requiring further user input and provides improved feedback to the user and provides feedback about the setting.

In some embodiments, the set of criteria includes a criterion that is met when an input directed to (e.g., an input that causes the physical input mechanism to move and/or an input directed to and/or on the physical input mechanism) the physical input mechanism is no longer detected (and/or release of the physical input mechanism is detected). Causing the physical input mechanism to move in a second direction that is different from the first direction and in accordance with a determination that an input directed to the physical input mechanism is no longer detected allows the computer system to automatically provide feedback that a terminal value has been reached, which performs an operation when a set of conditions has been met without requiring further user input and provides improved feedback to the user and provides feedback about the setting.

In some embodiments, while causing the physical input mechanism to move in the second direction, the computer system causes the physical input mechanism to provide a second set of haptics with intensity levels that change in a second manner (increase or decrease; get stronger or get weaker) as the physical mechanism is moved in the second direction, where the second manner is different from the first manner. Causing the physical input mechanism to provide a set of haptics with intensity levels that decrease as the physical mechanism is moved allows the computer system to automatically provide haptic outputs as physical input mechanism is being rotated from a certain position and informs the user that physical input mechanism is getting moving away from the certain position, which performs an operation when a set of conditions has been met without requiring further user input and provides improved feedback to the user and provides feedback about the setting.

In some embodiments, causing the physical input mechanism to provide the second set of haptics with intensity levels that change in the second manner includes: while causing the physical input mechanism to move in the second direction, detecting that the physical input mechanism is at a location that corresponds to a sixth position; in response to detecting that the physical input mechanism is at the location that corresponds to the sixth position, causing the physical input mechanism to provide a fourth haptic of the second set of haptics, where the fourth haptic has a fourth level of intensity (e.g., as described above in relation to method 1200); while causing the physical input mechanism to move in the second direction and after detecting that the physical input mechanism is at the location that corresponds to the sixth position, detecting that the physical input mechanism has moved from the location that corresponds to the sixth position to a location that corresponds to a seventh position, where the seventh position is further away from the fifth position in the second direction than the sixth position is away from the fifth position in the second direction; and in response to detecting that the physical input mechanism has moved from the location that corresponds to the sixth position to the location that corresponds to the seventh position, causing the physical input mechanism to provide a fifth haptic of the second set of haptics (e.g., without providing the fourth haptic), where the fifth haptic of the second set of haptics has a fifth level of intensity that is less than (e.g., weaker than, less forceful than, and/or has less pressure than) the fourth level of intensity.

In some embodiments, the physical input mechanism is caused to move in the second direction without being caused to provide any haptics as the physical input mechanism is moved in the second direction (e.g., in accordance with a determination that the physical input mechanism started moving without user input to causes the physical input mechanism to move in the second direction).

In some embodiments, before detecting movement of the physical input mechanism, the computer system displays a first user interface object (e.g., as described above in relation to methods 1100-1200) indicating a range of values corresponding to the first type of setting is displayed and a first indication (e.g., 634) (e.g., as described above in relation to methods 1100-1200) of a current value for the first type of setting is displayed relative to the first user interface object (e.g., 632). In some embodiments, while detecting movement of the physical input mechanism in the first direction, the computer system moves the first indication relative to (e.g., as described above in relation to methods 1100-1200) the first user interface object (e.g., 632) based on the movement of the physical input mechanism (e.g., as described above in relation to methods 1100-1200).

In some embodiments, while detecting movement of the physical input mechanism in the first direction, the computer system detects that the physical input mechanism is at a location that is past (e.g., and/or within a predetermined distance past) a second respective position relative to (e.g., in, in relation to, going in, looking in, and/or judging from) the first direction. In some embodiments, in response to detecting that the physical input mechanism is at the location that is past the second respective position relative to the first direction, the computer system ceases to move the first indication (e.g., 634) relative to the first user interface object (e.g., 634) (e.g., past the location that is past the second respective position relative to the first direction) based on the movement of the physical input mechanism (and/or as the physical input mechanism is moved in the first direction). In some embodiments, in response to detecting that the physical input mechanism is not at a location that is past the second respective position relative to the first direction, continuing to move the first indication relative to the first user interface object based on and/or as the physical mechanism is moved in the first direction.

In some embodiments, while movement of the first indication (e.g., 634) relative to the first user interface object has ceased, the computer system detects that movement of the physical input mechanism has changed from being in the first direction to be in a third direction that is different from the first direction. In some embodiments, while the physical input mechanism is moving in the third direction, the computer system detects that the physical input mechanism is not at the location that is past the second respective position relative to the first direction. In some embodiments, in response to detecting that the physical input mechanism is not at the location that is past the second respective position relative to the first direction, moving the first indication relative to the first user interface object (e.g., 632) based on the movement of the physical input mechanism (e.g., in the second direction).

In some embodiments, in response to detecting that the physical input mechanism is at the location that corresponds to the first position and while detecting movement of the physical input mechanism in the first direction: in accordance with a determination that the first position is not within the threshold distance (e.g., 0-2 meters) from the respective position, the computer system forgoes causing the physical input mechanism to provide the set of haptics with intensity levels that change in the first manner as the physical mechanism is moved in the first direction. Choosing not to cause the physical input mechanism to provide the set of haptics with intensity levels that change in the first manner as the physical mechanism is moved in the first direction in accordance with a determination that the first position is not within the threshold distance allows the computer system to inform the user that a terminal position is not near, which provides improved feedback.

In some embodiments, the set of haptics includes a first respective haptic that has a first respective level of intensity and a second respective haptic that has a second respective level of intensity that is greater than the first level of intensity; and the second respective haptic is provided after the first respective haptic is provided. Causing the physical input mechanism to provide a first respective haptic that has a first respective level of intensity and, after, a second respective haptic that has a second respective level of intensity that is greater than the first level of intensity allows the computer system to automatically provide haptic outputs as physical input mechanism is being rotated to a certain position, which performs an operation when a set of conditions has been met without requiring further user input and provides improved feedback to the user and provides feedback about the setting.

In some embodiments, causing the physical input mechanism to provide the set of haptics with intensity levels that change in the first manner includes causing the physical input mechanism to provide a sequence of a plurality of haptics that increases (or, in other embodiments, decrease) over time as the physical mechanism is moved in the first direction. Causing the physical input mechanism to provide a sequence of a plurality of haptics, where output of the sequence has an intensity level that increases over time as the physical mechanism is moved allows the computer system to automatically provide haptic outputs as physical input mechanism is being rotated to a certain position, which performs an operation when a set of conditions has been met without requiring further user input and provides improved feedback to the user and provides feedback about the setting.

In some embodiments, causing the physical input mechanism to provide the set of haptics with intensity levels that change in the first manner includes causing the physical input mechanism to provide a single haptic that increases (or, in other embodiments, decrease) over time as the physical mechanism is moved in the first direction. In some embodiments, the length of time that a first haptic of the plurality of haptics is output is less than the length of time that the single haptic is output. Causing the physical input mechanism to provide a single haptic that has an intensity level that increases over time as the physical mechanism is moved in the first direction when prescribed conditions are met allows the computer system to automatically provide haptic outputs as physical input mechanism is being rotated to a certain position, which performs an operation when a set of conditions has been met without requiring further user input and provides improved feedback to the user and provides feedback about the setting.

In some embodiments, the computer system is in communication with a speaker. In some embodiments, while causing the physical input mechanism to provide the set of haptics with intensity levels that change in the first manner as the physical mechanism is moved in the first direction, the computer system outputs, via the speaker, a sound as the physical mechanism is moved in the first direction. In some embodiments, the sound increases in pitch and/or decreases in pitch, volume, and/or tone (e.g., notes going up or down a scale) as the physical input mechanism is moved in the first direction. In some embodiments, the sound increases in pitch, volume, and/or tone as the physical input mechanism is moved in the first direction and decreases in pitch, volume, and/or tone as the physical input mechanism is moved in another direction, or vice versa.

Note that details of the processes described above with respect to method 1300 (e.g., FIG. 13 are also applicable in an analogous manner to the methods described above. For example, method 1100 optionally includes one or more of the characteristics of the various methods described above with reference to method 1300. For example, the physical input mechanism of method 1100 can be the physical input mechanism of method 1300. For brevity, these details are not repeated above.

FIGS. 14A-14D illustrate exemplary user interfaces to discuss techniques concerning how a computer system can configure a rotatable input mechanism to behave like a joystick and/or rocker (e.g., a rocking chair and/or a window rocker). FIG. 14A illustrates computer system 600 displaying user interface 1460 for changing a type of setting, such as a garage door, a kitchen window, and/or a set of dining room blinds. In some embodiments, computer system 600 displays user interface 1460 after detecting an input on a setting that corresponds to user interface 1460 at FIG. 6A. Rather than detecting an input on one or more of settings 612-616, which do not correspond to user interface 1460. Thus, at FIG. 14A, computer system 600 configures rotatable input mechanism 602 using the techniques discussed below based on whether computer system 600 has configured rotatable input mechanism 602 to adjust a value for a particular type of setting. As illustrated in FIG. 14A, user interface 1460 includes adjustment indicator 1462, which has the appearance of a joystick. In some embodiments, adjustment indicator 1462 has a different appearance, such as an appearance of one or more of the indicators described above in relation to FIGS. 6B-6D.

At FIG. 14A, adjustment indicator 1462 is in a neutral position, which is in the center of user interface 1460. By displaying adjustment indicator 1462 in the neutral position, computer system 600 indicates that the value for a particular setting is not changing (e.g., a garage door isn't going up or down and/or a kitchen window isn't going up or down). At FIG. 14A, computer system 600 detects a clockwise rotational input on rotatable input mechanism 602. As illustrated in FIG. 14B, in response to detecting the clockwise rotational input on rotatable input mechanism 602, computer system 600 moves adjustment indicator 1462 upward as rotatable input mechanism 602 is being rotated in the clockwise direction. Once rotatable input mechanism 602 is rotated past the position that corresponds to the neutral position of adjustment indicator 1462, computer system 600 causes a device, such as an actuator, to adjust an object, such as dining room blinds (e.g., opening or closing). In FIG. 14A, as rotatable input mechanism 602 is rotated in the clockwise direction and adjustment indicator 1462 is going upward, computer system 600 causes a device to change in a first manner (e.g., increase a value and cause a device to become more opened or to become opened). In some embodiments, as rotatable input mechanism 602 is rotated in the counterclockwise direction adjustment indicator 1462 is displayed going downward, computer system 600 a device to change in a second manner that is different from or the opposite of the first manner (e.g., decrease a value and cause a device to become more closed or to become closed).

Notably, at FIG. 14B, the rate that computer system 600 causes the device to adjust output is based on the amount that rotatable input mechanism 602 is rotated. For example, if rotatable input mechanism 602 stays in a respective position that is past the neutral position computer system 600 will continue to cause a device to adjust output at the same rate until a maximum or minimum value is reached. However, if rotatable input mechanism 602 is rotated further away from the neutral position and the respective position, computer system 600 will cause a device to adjust output at a faster rate. In some embodiments, rotatable input mechanism 602 is rotated to a position that corresponds to a terminal position (e.g., a position that corresponds to a maximum rate of change or a minimum rate of change for a setting), and computer system 600 causes a device to adjust output in a manner (e.g., more opened and/or more closed) that is at the fastest rate of adjustment that computer system 600 will instruct the device adjusted output.

At FIG. 14B, rotatable input mechanism 602 is rotated to the terminal position. Thus, in conjunction with detecting that rotatable input mechanism 602 is rotated to a position that corresponds to the terminal position, computer system 600 outputs a set of haptic outputs 1472b. In some embodiments, the strength of haptic outputs 1472b increases as rotatable input mechanism 602 is rotated to the position that corresponds to the terminal position. In some embodiments, computer system 600 outputs a sound that increases in tone, volume, and/or pitch as rotatable input mechanism 602 is rotated to the position that corresponds to the terminal position. At FIG. 14B, computer system 600 detects that rotatable input mechanism 602 has been released (or no longer detects a rotational input on rotatable input mechanism 602). In some embodiments, in response to detecting a rotation of rotatable input mechanism 602, computer system 600 changes display of a user interface element (e.g., a background and/or foreground) if rotatable input mechanism 602 is configured to change a value of a particular type of setting and does not change the display of the user interface element if rotatable input mechanism 602 is not configured to change the value of the particular type of setting.

As illustrated in FIGS. 14C-14D, in response to detecting that rotatable input mechanism 602 has been released, computer system 600 causes rotatable input mechanism 602 to spring back to the neutral position (e.g., as shown in FIG. 14D). While causing rotatable input mechanism 602 to spring back to the neutral position, computer system 600 causes a set of haptic outputs 1472c to be output. In some embodiments, one or more of haptic outputs 1472c are provided when rotatable input mechanism 602 returns back to the neutral position or is close to (e.g., within a predetermined distance from) returning back to the neutral position.

While causing rotatable input mechanism 602 to spring back to the neutral position, computer system 600 does not cause a device to adjust output. However, if a user caused rotatable input mechanism 602 to be rotated clockwise past a neutral position in one direction and subsequently caused rotatable input mechanism 602 to be rotated past the neutral position in the opposite direction, computer system 600 would cause the device to adjust output in a first manner (e.g., while rotatable input mechanism was rotated clockwise past a neutral position in the first direction) and subsequently cause the device to adjust output in a different manner (e.g., while rotatable input mechanism 602 was rotated counterclockwise past a neutral position in the opposite direction). However, computer system 600 would not cause device to adjust output in the different manner until rotatable input mechanism 602 was past the neutral position in the other direction. In some embodiments, rotatable input mechanism 602 springs back to the neutral position based on the speed of rotatable input mechanism 602 when it moved past the neutral position, such that faster movement in one direction leads to a faster springing back of rotatable input mechanism 602 in the other direction. In some embodiments, rotatable input mechanism 602 springs back to the neutral based on the position that rotatable input mechanism 602 was in before rotatable input mechanism 602 was released, such that rotatable input mechanism 602 springs back faster (or with more force) as the distance between the position that rotatable input mechanism 602 was in immediately before being released and neutral position increases. In some embodiments, to spring back, computer system 600 cause rotatable input mechanism 602 to maintain and/or increases the level of resistance provided in the direction opposite of the direction of rotation (e.g., increases or maintains the level of resistance provided in the counterclockwise direction while rotatable input mechanism 602 is being rotated clockwise), such that rotatable input mechanism 602 rotates back when less rotational force is being applied in the direction of rotation. It should be understood that computer system 600 dynamically configures rotatable input mechanism 602 to spring back at one or more dynamic terminal positions based on the type of setting that is currently being adjusted. For example, computer system 600 can cause rotatable input mechanism 602 to spring back at a position that corresponds to zero degrees of rotation and a position that corresponds to 90 degrees of rotation for a first type of setting, and computer system 600 can cause rotatable input mechanism 602 to spring back at a position that corresponds to zero degrees of rotation and a position that corresponds to 300 degrees of rotation for a second type of setting. Thus, in some embodiments, computer system 600 dynamically controls the number of degrees that rotatable input mechanism 602 can be rotated depending on the type of setting that is selected.

FIG. 15 is a flow diagram illustrating a method for a physical input mechanism using a computer system in accordance with some embodiments. Method 1500 is performed at a computer system (e.g., 100, 300, 500, and 600) that is in communication with a physical (e.g., a hardware and/or non-displayed) input mechanism (e.g., 602) (e.g., a hardware input mechanism, a rotatable input mechanism, a crown, a knob, a dial, a physical slider, and/or a hardware button). In some embodiments, the physical input mechanism is a part of a platform, such as a vehicle (e.g., an automobile and/or a boat) and/or smart home devices. In some embodiments, input detected at the physical input mechanism causes one or more settings, such as temperature, volume, window opening, window tint, cabin light brightness, and the like, to be updated. In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 1500 are, optionally, combined, the orders of some operations are, optionally, changed, and some operations are, optionally, omitted.

As described below, method 1500 provides an intuitive way for using the physical input mechanism. The method reduces the cognitive burden on a user for using the physical input mechanism, thereby creating a more efficient human-machine interface. For battery-operated computing devices, enabling a user to use the physical input mechanism faster and more efficiently conserves power and increases the time between battery charges.

At 1510 of method 1500, the computer system (e.g., 600) detects an input (e.g., 611a1-611a3) (e.g., a tap input and, in some embodiments, a not tap input, such as a swipe input, a mouse click, a button press, a gaze input, an air gesture input, and/or a gaze input with an air gesture input) directed to (e.g., at, on, near, and/or at and/or near a location corresponding to) a control (e.g., 612, 614, and/or 616). In some embodiments, the control is a physical control that is not displayed. In some embodiments, the control is a settings control (e.g., a temperature control, a volume control, a fan control, and/or a heating element control (e.g., a heating pad control, a water heating element control, and/or a seat heating element control)). In some embodiments, the control is a value for a setting that is not displayed. In some embodiments, the computer system displays the control, before detecting the input directed to the control, on a user interface that does not indicate (e.g., via text and/or symbols) that characteristics of physical input mechanism will be changed (e.g., while, in some embodiments, the user interface indicates that one or more other settings (e.g., volume, temperature, a fan, and/or a heating element) will be changed). In some embodiments, the computer system displays the control and/or the control is a user interface object.

At 1520 of method 1500, the computer system (e.g., 600), in response to detecting the input directed to the control and in accordance with a determination that the control corresponds to a first type (e.g., 612, 614, and/or 616) (e.g., a temperature setting, a fan setting, a heating element setting, a volume setting, a brightness setting, a light setting, a contrast setting, a television setting, a cabin setting, a door setting (e.g., a garage door setting, a front door setting, and/or a back door setting) and/or a setting that does not indicate that the physical input mechanism will be configured differently and/or set the physical setting to have a different set of movement characteristics) of setting, configures the physical input mechanism (e.g., 602) such that the physical input mechanism moves (e.g., from a release position (e.g., position at which the physical input mechanism is released)) to a first position after input directed to the physical input mechanism is no longer detected (e.g., after input corresponding to the physical input mechanism is released and/or no longer detected at a location corresponding to the input mechanism).

At 1530 of method 1500, the computer system (e.g., 600) in response to detecting the input (e.g., 611a1-611a3) directed to the control and in accordance with a determination that the control corresponds to a second type (e.g., a temperature setting, a fan setting, a heating element setting, a volume setting, a brightness setting, a light setting, a contrast setting, a television setting, a cabin setting, a door setting (e.g., a garage door setting, a front door setting, and/or a back door setting) and/or a setting that does not indicate that the physical input mechanism will be configured differently and/or set the physical setting to have a different set of movement characteristics) of setting that is different from the first type of setting, forgoes configuring the physical input mechanism such that the physical input mechanism moves to the first position after input directed to the physical input mechanism is no longer detected. In some embodiments, in accordance with a determination that the control corresponds to a second type of setting that is different from the first type of setting, the computer system configured the physical input mechanism such that the physical input mechanism does not move and/or continues to be moved after the physical input mechanism is a position at the release position. Configuring the physical input mechanism such that the physical input mechanism moves to a first position after input directed to the physical input mechanism is no longer detected in response to detecting input provides the user with a control option for adjusting a certain type of setting, which provides the user with more control over the user interface without cluttering the user interface. Choosing whether to configure the physical input mechanism such that the physical input mechanism moves to a first position after input directed to the physical input mechanism is no longer detected in response to detecting input allows the computer system to configure the physical input mechanism to behave in a certain manner based on a setting the physical input mechanism can be used to adjust, which performs an operation when a set of conditions has been met without requiring further user input and provides improved feedback to the user and provides feedback about the setting.

In some embodiments, the physical input mechanism (e.g., 602) is a rotatable input mechanism (e.g., 602) (e.g., and/or is a rotatable, twistable, and/or twistable input mechanism).

In some embodiments, the physical input mechanism (e.g., 602) moving after input directed to the physical input mechanism is no longer detected includes the physical input mechanism rotating (e.g., rotating clockwise or counterclockwise with respect to yaw, pitch, and/or roll) (e.g., as described above in relation to FIG. 14A-14D).

In some embodiments, the input directed to the physical input mechanism (e.g., 602) is no longer detected in accordance with a determination that an input (e.g., one or more touch inputs) directed to the physical input mechanism has been released (e.g., an input that causes the physical input mechanism to rotate) (e.g., as described above in relation to FIGS. 14B-14D). Configuring the physical input mechanism such that the physical input mechanism moves to a first position after input directed to the physical input mechanism is released provides the user with a control option for adjusting a certain type of setting, which provides the user with more control over the user interface without cluttering the user interface.

Choosing whether to configure the physical input mechanism such that the physical input mechanism moves to a first position after input directed to the physical input mechanism is released allows the computer system to configure the physical input mechanism to behave in a certain manner based on a setting the physical input mechanism can be used to adjust, which performs an operation when a set of conditions has been met without requiring further user input and provides improved feedback to the user and provides feedback about the setting.

In some embodiments, after detecting the input directed to the control (e.g., 611a-611a3), the computer system detects a first input (e.g., a rotational input, such as a twisting input, and/or, in some embodiments, a non-rotational input (e.g., a click and drag input, a press-and-hold input, a twisting air gesture input, and/or a gaze input)) that moves the physical input mechanism (e.g., 602) from a second position to a third position (e.g., as described above in relation to FIGS. 14B-14D). In some embodiments, while the detecting the first input and while the physical input mechanism is in the third position, the computer system detects that the first input is no longer detected (e.g., has been released and/or is no longer at the location of the physical input mechanism). In some embodiments, in response to detecting that the first input is no longer detected, the computer system: in accordance with a determination that the physical input mechanism is configured (e.g., currently configured and/or configured when the first input was no longer detected) such that the physical input mechanism moves to the first position after input directed to the physical input mechanism is no longer detected, causes (e.g., automatically without user input (e.g., intervening user input after the first input was detected and/or no longer detected)) the physical input mechanism to move from the third position to the first position (e.g., as described above in relation to FIGS. 14B-14D); and in accordance with a determination that the physical input mechanism is not (e.g., currently configured and/or configured when the first input was no longer detected) configured such that the physical input mechanism moves to the first position after input directed to the physical input mechanism is no longer detected, forgoes causing the physical input mechanism to move from the third position to the first position (e.g., as described above in relation to FIGS. 14B-14D). In some embodiments, in accordance with a determination that the physical input mechanism has not been configured such that the physical input mechanism moves to the first position after input directed to the physical input mechanism is no longer detected, the physical input mechanism continues to be in the third position.

Causing the physical input mechanism to move from the third position to the first position provides the user with a control option for adjusting a certain type of setting, which provides the user with more control over the user interface without cluttering the user interface.

Choosing whether to cause the physical input mechanism to move from the third position to the first position allows the computer system to configure the physical input mechanism to behave in a certain manner based on a setting the physical input mechanism can be used to adjust, which performs an operation when a set of conditions has been met without requiring further user input and provides improved feedback to the user and provides feedback about the setting.

In some embodiments, in accordance with a determination that the first input has a first rate (e.g., speed, momentum, and/or velocity), the physical input mechanism (e.g., 602) is caused to move from the third position to the first position at a second rate (e.g., as described above in relation to FIGS. 14B-14D); and in accordance with a determination that the first input has a third rate that is greater than the first rate, the physical input mechanism is caused to move from the third position to the first position at a fourth rate that is greater than the second rate (e.g., as described above in relation to FIGS. 14B-14D). In some embodiments, the first rate is equal to the second rate. In some embodiments, the third rate is equal to the fourth rate. In some embodiments, the second rate is based on the first rate and is not based on the third rate. In some embodiments, the fourth rate is based on the third rate and is not based on the first rate. Causing the physical mechanism to move to the first position at a rate that is based on the rate of the first input allows the computer system to automatically provide different feedback concerning how fast the user rotated the physical input mechanism in a direction, which performs an operation when a set of conditions has been met without requiring further user input and provides improved feedback to the user and provides feedback about the setting.

In some embodiments, in accordance with a determination that a distance between the first position and the third position is a first distance, the physical input mechanism (e.g., 602) is caused to move from the third position to the first position at a fifth rate (e.g., as described above in relation to FIGS. 14B-14D); and in accordance with a determination that the distance between the first position and the third position is a second distance that is greater than the first distance, the physical input mechanism is caused to move from the third position to the first position at a sixth rate that is greater than the fifth rate (e.g., as described above in relation to FIGS. 14B-14D). Causing the physical mechanism to move to the first position at a rate that is based on the distance that rotatable input mechanism moved allows the computer system to automatically provide different feedback concerning how much the user rotated the physical input mechanism in a direction, which performs an operation when a set of conditions has been met without requiring further user input and provides improved feedback to the user and provides feedback about the setting.

In some embodiments, an indication (e.g., 1462) (e.g., a highlighting and/or mark (e.g., a shape, circle, triangle, and/or square) on a value (e.g., tick mark and/or position) of a scale) of a current value (e.g., value at which the first type of setting is currently set) for the first type of setting is displayed at a location that corresponds to the second position before the first input is detected. In some embodiments, in response to detecting the first input, the computer system moves display of the indication of the current value from the location that corresponds to the second position to a location that corresponds to the third position; (e.g., as described above in relation to FIGS. 14B-14D). In some embodiments, in response to detecting that the first input is no longer detected and in accordance with a determination that the physical input mechanism is configured such that the physical input mechanism moves to the first position after input directed to the physical input mechanism (e.g., 602) is no longer detected, the computer system ceases to move display of the indication of the current value while causing the physical input mechanism to move from the third position to the first position (e.g., as described above in relation to FIGS. 14B-14D) (and/or continuing to display the indication at the location that corresponds to the third position, forgoing changing the current value of the setting, and/or maintaining the value of the setting while causing the physical input mechanism to move from the third position to the first position). In some embodiments, the indication (e.g., a highlighting and/or mark (e.g., a shape, circle, triangle, and/or square) on a value (e.g., tick mark and/or position) of a scale) of the current value (e.g., value at which the first type of setting is currently set) is displayed relative to (e.g., on, near, adjacent to, and/or in an area that corresponds to) a user interface object (e.g., a scale, a slider, and/or one or more options) indicating a range of values (e.g., 0-100, on, off, very high, high, very low, low, and/or medium) (e.g., values to which the a setting can be set) corresponding to the first type of setting. In some embodiments, the first position, second position, and/or third position are positions that are on and/or overlay the user interface object. Ceasing to move display of the indication of the current value while causing the physical input mechanism to move from the third position to the first position provides feedback to the user that the value is not changing while the physical input mechanism is being moved, which provides feedback about the current processes running on the computer system.

In some embodiments, the computer system is in communication with a display generation component. In some embodiments, in response to detecting the input directed to the control, the computer system: in accordance with a determination that the control corresponds to the first type of setting, displays, via the display generation component, a first user interface object (e.g., a scale, a slider, and/or one or more options) that indicates a range of values (e.g., 0-100, on, off, very high, high, very hot, cool, very cool, hot, very low, low, and/or medium) for the first type of setting; and in accordance with a determination that the control corresponds to the second type of setting, displays, via the display generation component, a second user interface object (e.g., a scale, a slider, and/or one or more options) that indicates a range of values (e.g., 0-100, on, off, very high, high, very low, low, and/or medium) for the second type of setting. In some embodiments, the second user interface object is different from the first user interface object. Displaying a scale that is based on the type of setting that a user selected to control provides the user a control option for adjusting a certain type of setting, which provides the user with more control over the user interface without cluttering the user interface.

In some embodiments, the first user interface object occupies (e.g., covers and/or is displayed over) a first display area (e.g., an area of a display generation component and/or an area of a scale where one or more input directed to the area causes an indication on the scale to change) and does not cover a second display area, and wherein the second user interface object occupies the first display area and the second area. In some embodiments, the first user interface object indicates less values than the second user interface object. In some embodiments, the first type of setting can be set to less values than the second type of setting. Displaying a scale at different sizes based on the type of setting that a user selected to control provides the user a control option for adjusting a certain type of setting and provides feedback to the user concerning the values for a setting, which provides the user with more control over the user interface without cluttering the user interface and provides feedback.

In some embodiments, the first user interface object does not include a value for the first type of setting at a location (e.g., location relative to the scale and/or relative to the display generation component) corresponding to the first position (and/or indicates a neutral value and/or a non-settable value for the first type of setting (e.g., a value between off and on) at the location corresponding to the first position). In some embodiments, the second user interface does include a value for the second type of setting at the location corresponding to the first position (and/or indicates a neutral value and/or a non-settable value for the first type of setting (e.g., a value between off and on) at the location corresponding to the first position). Displaying a scale that does not have a value for setting corresponding to the first position provides feedback to the user that a physical input mechanism, what at the first position, is not causing the computer system to adjust output and/or cause an external device to adjust output, which provides feedback about the underlying processes of the computer system.

In some embodiments, in response to detecting the input directed to the control, the computer system: in accordance with a determination that the control corresponds to the first type of setting, displays, via the display generation component, a user interface that includes a user interface element (e.g., a background and/or foreground), where a color (e.g., background and/or foreground color) of the user interface element is not adjusted in response to detecting movement of the physical input mechanism while the user interface element is displayed; and in accordance with a determination that the control corresponds to the second type of setting, displays, via the display generation component, the user interface element (e.g., a background color or a foreground color), where the color of the user interface element is adjusted in response to detecting on movement of the physical input mechanism (e.g., 602) while the user interface element is displayed. Displaying or not display a user element where the color of the user interface element is adjusted in response to detecting on movement of the physical input mechanism while the user interface element is displayed allows the computer system to automatically display the user interface element changing based on the type of setting being adjusted, which performs an operation when a set of conditions has been met without requiring further user input and provides improved feedback to the user and provides feedback about the setting and provides feedback about the underlying processes of the computer system.

Note that details of the processes described above with respect to method 1500 (e.g., FIG. 15) are also applicable in an analogous manner to the methods described below.

For example, method 1600 optionally includes one or more of the characteristics of the various methods described above with reference to method 1500. For example, the physical input mechanism of method 1500 can be the rotatable input mechanism of method 1600. For brevity, these details are not repeated below.

FIG. 16 is a flow diagram illustrating a method for a rotatable input mechanism using a computer system in accordance with some embodiments. Method 1600 is performed at a computer system (e.g., 100, 300, 500, and/or 600) that is in communication with a rotatable (e.g., a hardware and/or non-displayed) input mechanism (e.g., 602) (e.g., a hardware input mechanism, a crown, a knob, a dial, a physical slider, and/or a hardware button) and an output device (e.g., a fan, a thermostat, a heater, an air conditioner, a door, a speaker, a light, and/or a heating/cooling element): In some embodiments, the rotatable input mechanism is a part of a platform, such as a vehicle (e.g., an automobile and/or a boat) and/or smart home devices. In some embodiments, input detected at the rotatable input mechanism causes one or more settings, such as temperature, volume, window opening, window tint, cabin light brightness, and the like, to be updated. In some embodiments, the computer system is a watch, a phone, a tablet, a processor, a head-mounted display (HMD) device, and/or a personal computing device. In some embodiments, the computer system is in communication with a display generation component, such as a display screen and/or a touch-sensitive display. In some embodiments, the computer system is in communication with one or more cameras (e.g., one or more telephoto, wide angle, and/or ultra-wide-angle cameras). Some operations in method 1600 are, optionally, combined, the orders of some operations are, optionally, changed, and some operations are, optionally, omitted.

As described below, method 1600 provides an intuitive way for using the rotatable input mechanism. The method reduces the cognitive burden on a user for using the rotatable input mechanism, thereby creating a more efficient human-machine interface. For battery-operated computing devices, enabling a user to use the rotatable input mechanism faster and more efficiently conserves power and increases the time between battery charges.

At 1610 of method 1600, the computer system, while detecting that the rotatable input mechanism is rotating (e.g., being rotated by the computer system and/or a user of the computer system) in a first direction (e.g., starting at a start position and rotating in the first direction from the start position), causes the output device to adjust an output (e.g., increase/decrease fan speed, temperature, brightness, volume, bass, treble and/or open and/or close door and/or window) in a first manner based on the rotatable input mechanism rotating in the first direction. In some embodiments, the output is adjusted in a first manner (e.g., positive or negative) regardless of an amount of rotation in the first direction (e.g., as described above in relation to FIGS. 14B-14D).

At 1620 of method 1600, the computer system, while causing the output device to adjust the output based on the rotatable input mechanism rotating in the first direction, detects the rotatable input mechanism is rotating in a second direction that is different from (e.g., the reverse of and/or the opposite of) the first direction (e.g., detecting that the rotatable input mechanism has transitioned from being rotated in the first direction to being rotated in the second direction) (e.g., as described above in relation to FIGS. 14B-14D).

At 1630 of method 1600, the computer system, in response to detecting that the rotatable input mechanism is rotating in the second direction and in accordance with (in some embodiments, a determination that) the rotatable input mechanism rotating a first amount in the first direction (e.g., a final amount and/or a total amount before reversal) before rotating in the second direction, causes (e.g., this does not include automatic rotation that would occur when the rotatable input mechanism is returning to the start position because no adjustment occurs during automatic rotation) the output device to adjust output (e.g., the output is adjusted in the first manner (e.g., positive or negative) until rotation reaches the start position) in a second manner (e.g., with the same rate of speed and/or in the same direction and/or manner (e.g., increase or decrease) of adjustment) based on rotation of the rotatable input mechanism (e.g., as described above in relation to FIGS. 14B-14D) (e.g., adjust output in a direct manner while rotating in the second direction than while rotating the first direction (e.g., increase volume while rotating in first direction and decrease volume while rotating in second direction; and/or decrease brightness while rotating in the first direction and increase brightness while rotating in the first direction)).

At 1640 of method 1600, the computer system, in response to detecting that the rotatable input mechanism is rotating in the second direction and in accordance with the rotatable input mechanism rotated a second amount (e.g., rotated all the way to or past the max or the min and/or rotated past a middle position but, in some embodiments, not to max or min) in the first direction before rotating in the second direction, wherein the second amount is greater than the first amount, forgoes causing the output device to adjust output in the second manner based on rotation of the rotatable input mechanism (e.g., output would be adjusted in a second manner different from the first manner when rotation goes passed the start position) (e.g., as described above in relation to FIGS. 14B-14D). In some embodiments, in accordance with the rotatable input mechanism rotated the second amount (e.g., rotated all the way to or past the max or the min) in the first direction before rotating in the second direction, the computer system does not cause the output device to adjust output (e.g., in any manner) (e.g., as described above in relation to FIGS. 14B-14D). In some embodiments, in accordance with the rotatable input mechanism rotated the second amount (e.g., rotated past a middle position but, in some embodiments, not to max or min) in the first direction before rotating in the second direction, the computer system causes the output device to adjust output in the first manner (e.g., as described above in relation to FIGS. 14B-14D).

In some embodiments, the first manner is the same as the second manner (e.g., if above a middle level before/after reversing, both directions increase a setting). Choosing whether to cause the output device to adjust output in the second manner that is the same as the first manner based on rotation of the rotatable input mechanism based on the position of the amount that the rotatable input mechanism rotated in the first direction before rotating in the second direction provides the user with control over when the device's output should be adjusted, which provides the user with more control over the user interface without cluttering the user interface.

In some embodiments, the first manner is different from the second manner (e.g., if above a middle level before reversing and below a middle level after reversing (or vice-versa), one direction increases the setting while other direction decreases the setting) (e.g., as described above in relation to FIGS. 14B-14D). Choosing whether to cause the output device to adjust output in the second manner that is different from the first manner based on rotation of the rotatable input mechanism based on the position of the amount that the rotatable input mechanism rotated in the first direction before rotating in the second direction provides the user with control over when the device's output should be adjusted, which provides the user with more control over the user interface without cluttering the user interface.

In some embodiments, detecting the rotatable input mechanism is rotating in the second direction occurs in response to detecting that an input (e.g., as described above in relation to method 1500) directed to the rotatable input mechanism (e.g., 602) is no longer detected (e.g., detecting that the input directed to the rotatable input mechanism has been released) (e.g., as described above in relation to method 1500). Choosing whether to cause the output device to adjust output in the second manner in response to detecting that an input directed to rotatable input mechanism is no longer detected provides the user with control over when the device's output should be adjusted, which provides the user with more control over the user interface without cluttering the user interface.

In some embodiments, detecting the rotatable input mechanism (e.g., 602) is rotating in the second direction occurs in response to detecting an input (e.g., a manual input and/or a rotational input and, in some embodiments, a non-rotational input (e.g., a click and drag input, a press-and-hold input, a twisting air gesture input, and/or a gaze input) (e.g., as described above in relation to method 1500) that corresponds to a rotation of the rotatable input mechanism (e.g., 602) in the second direction (e.g., and/or detecting that an input has transitioned from being in the third direction to being in a fourth direction that is different from the third direction) (e.g., as described above in relation to FIGS. 14B-14D). Choosing whether to cause the output device to adjust output in the second manner in response to detecting a rotation of the rotatable input mechanism in the second direction provides the user with control over when the device's output should be adjusted, which provides the user with more control over the user interface without cluttering the user interface.

In some embodiments, computer system is in communication with a display generation component. In some embodiments, before detecting that the rotatable input mechanism is rotating in the first direction, the computer system displays, via the display generation component, a user interface that includes a first user interface object (e.g., as described above in relation to method 1500) that indicates a range of values (e.g., as described above in relation to method 1500) for the first type of setting and an indication (e.g., 1462) (e.g., as described above in relation to method 1500) of the current value for the first type of setting (e.g., as described above in relation to FIGS. 14B-14D). In some embodiments, while causing the output device to adjust the output based on the rotatable input mechanism rotating in the first direction, the computer system moves the indication (e.g., 1462) of the current value for the first type of setting in a third direction (e.g., a direction that corresponds to and/or is based on the first direction) relative to the first user interface object (e.g., as described above in relation to method 1500) (e.g., as described above in relation to FIGS. 14B-14D). In some embodiments, in response to detecting that the rotatable input mechanism is rotating in the second direction, the computer system moves the indication (e.g., 1462) of the current value for the first type of setting in a fourth direction (e.g., a direction that corresponds to and/or is based on the second direction) relative to the first user interface object, wherein the fourth direction is different from the third direction.

Moving the indication of the current value based on movement of the rotatable input mechanism provides the user with feedback of how an input on the rotatable input mechanism is causing output to be adjusted.

In some embodiments, the first amount of rotation corresponds to an amount of rotation that does not cause the rotatable input mechanism (e.g., 602) to be in a position that corresponds to a terminal value (e.g., as described above in relation to FIGS. 14B-14D) (e.g., a binary value, a minimum value, a maximum value, a value that corresponds to off and/or inactive, and/or a value that corresponds to active and/or on) in the range of values for the first type of setting (e.g., a temperature setting, a fan setting, a heating element setting, a volume setting, a brightness setting, a light setting, a contrast setting, a television setting, a cabin setting, a door setting (e.g., a garage door setting, a front door setting, and/or a back door setting) and/or a setting that does not indicate that the physical input mechanism will be configured differently and/or set the physical setting to have a different set of movement characteristics). In some embodiments, the second amount of rotation corresponds to an amount of rotation that causes the rotatable input mechanism to be in the position that corresponds to the terminal value in the range of values for the first type of setting. Choosing whether to cause the output device to adjust output in the second manner based on the amount of rotation applied to rotatable input mechanism and whether rotatable input mechanism was rotated to a terminal value provides the user with control over when the device's output should be adjusted, which provides the user with more control over the user interface without cluttering the user interface.

In some embodiments, in accordance with the rotatable input mechanism (e.g., 602) rotating the second amount in the first direction before rotating in the second direction (and/or that output of the device is at a maxed level (e.g., window fully opened/fully closed, light on highest setting/lowest setting, fan on highest/lowest setting), the computer system moves the indication (e.g., 1462) of the current value in the second direction without causing the output device to adjust output in the first manner (and, in some embodiments, the second manner) based on rotation of the rotatable input mechanism (e.g., as described above in relation to FIGS. 14B-14D).

In some embodiments, causing the output device to adjust output in the first manner includes causing a window to become more opened (e.g., to let more outside air in and/or to let more inside air out) or more closed (e.g., to let less outside air in and/or to let more inside air out) (e.g., as described above in relation to FIGS. 14B-14D). Choosing whether to cause a window to be adjusted based on movement of the rotatable input mechanism provides the user with control over when the device's output should be adjusted, which provides the user with more control over the user interface without cluttering the user interface.

In some embodiments, in response to detecting that the rotatable input mechanism (e.g., 602) is rotating in the second direction, the computer system: in accordance with a determination that the rotatable input mechanism has been rotated in the second direction by a third amount, causes the output device to adjust output in the first manner (e.g., the second manner is the first manner); and in accordance with a determination that the rotatable input mechanism has been rotated in the second direction by a fourth amount that is greater than the third amount, causes the output device to adjust output in a manner that is different from the first manner (e.g., the second manner is different from the first manner) (e.g., as described above in relation to FIGS. 14B-14D). Causing the output device to adjust output in a manner that is different from the first manner in accordance with a determination that the rotatable input mechanism has been rotated in the second direction provides the user with an additional control option to adjust output different, which provides the user with more control over the user interface without cluttering the user interface (e.g., as described above in relation to FIGS. 14B-14D).

In some embodiments, while detecting that the rotatable input mechanism (e.g., 602) is rotating in the first direction, the computer system provides a first set of haptics (e.g., 1472b). In some embodiments, in response to detecting that the rotatable input mechanism is rotating in the second direction and in accordance with the rotatable input mechanism rotated the second amount in the first direction before rotating in the second direction, the computer system provides a second set of haptics (e.g., 1472c) that are different from the first set of haptics (e.g., as described above in relation to FIGS. 14B-14D). In some embodiments, in response to detecting that the rotatable input mechanism is rotating in the second direction and in accordance with the rotatable input mechanism rotated the first amount in the first direction before rotating in the second direction, the computer system forgoes providing a second set of haptics that are different from the first set of haptics and/or provides the first set of haptics (e.g., as described above in relation to FIGS. 14B-14D). Providing different sets of haptics as a rotatable input mechanism is rotating in different direction provides the user with feedback concerning how much rotatable input mechanism and/or if rotatable input mechanism is returning from a maximum position, which provide feedback to the user.

In some embodiments, while detecting that the rotatable input mechanism is rotating in the first direction, the computer system provides a third set of haptics. In some embodiments, in response to detecting that the rotatable input mechanism (e.g., 602) is rotating in the second direction and in accordance with the rotatable input mechanism rotated the second amount in the first direction before rotating in the second direction, the computer system forgoes providing a set of haptics (e.g., as described above in relation to FIGS. 14B-14D). In some embodiments, in response to detecting that the rotatable input mechanism is rotating in the second direction and in accordance with the rotatable input mechanism rotated the first amount in the first direction before rotating in the second direction, the computer system does not forgo providing a set of haptics and/or provides the third set of haptics.

Providing haptics based on the amount that rotatable input mechanism has been rotated provides the user with feedback concerning how much rotatable input mechanism and/or if rotatable input mechanism is returning from a maximum position, which provide feedback to the user.

In some embodiments, while detecting that the rotatable input mechanism is rotating in the first direction, the computer system provides a first set of sounds (e.g., as described above in relation to FIGS. 14B-14D). In some embodiments, in response to detecting that the rotatable input mechanism is rotating in the second direction and in accordance with the rotatable input mechanism rotated the second amount in the first direction before rotating in the second direction, the computer system provides a second set of sounds that are different from the first set of sounds (e.g., as described above in relation to FIGS. 14B-14D). In some embodiments, in response to detecting that the rotatable input mechanism is rotating in the second direction and in accordance with the rotatable input mechanism rotated the first amount in the first direction before rotating in the second direction, the computer system forgoes providing a second set of sounds that are different from the first set of sounds and/or provides the first set of sounds. Providing different sets of sounds as a rotatable input mechanism is rotating in different directions provides the user with feedback concerning how much rotatable input mechanism and/or if rotatable input mechanism is returning from a maximum position, which provide feedback to the user.

In some embodiments, while detecting that the rotatable input mechanism is rotating in the first direction, the computer system provides a third set of sounds. In some embodiments, in response to detecting that the rotatable input mechanism is rotating in the second direction and in accordance with the rotatable input mechanism rotated the second amount in the first direction before rotating in the second direction, the computer system forgoes providing a set of sounds. In some embodiments, in response to detecting that the rotatable input mechanism is rotating in the second direction and in accordance with the rotatable input mechanism rotated the first amount in the first direction before rotating in the second direction, the computer system does not forgo providing a set of sounds and/or provides the third set of sounds (e.g., as described above in relation to FIGS. 14B-14D).

Providing sounds based on the amount that rotatable input mechanism has been rotated provides the user with feedback concerning how much rotatable input mechanism and/or if rotatable input mechanism is returning from a maximum position, which provide feedback to the user.

Note that details of the processes described above with respect to method 1600 (e.g., FIG. 16) are also applicable in an analogous manner to the methods described above.

For example, method 1600 optionally includes one or more of the characteristics of the various methods described above with reference to method 1500. For example, method 1600 occurs after method 1500. For brevity, these details are not repeated above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve use of an input mechanism. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to use an input mechanism. Accordingly, use of such personal information data enables users to have calculated control of an input mechanism. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes.

Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of input mechanism services, the present technology can be configured to allow users to select to “opt in” or “opt out” of participation in the collection of personal information data during registration for services or anytime thereafter. In another example, users can select not to provide input-associated data for targeted services. In yet another example, users can select to limit the length of time input-associated data is maintained or entirely prohibit the development of a baseline input profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, behaviors using input mechanisms can be determined by inferring preferences based on non-personal information data or a bare minimum amount of personal information, such as the content being requested by the device associated with a user, other non-personal information available to services, or publicly available information.

What is claimed is:

1-98. (canceled)

99. A method, comprising:
at a computer system that is in communication with a physical input mechanism:
while detecting movement of the physical input mechanism in a first direction, detecting that the physical input mechanism is at a location that corresponds to a first position; and
in response to detecting that the physical input mechanism is at the location that corresponds to the first position:
in accordance with a determination that the first position is within a threshold distance from a respective position, causing the physical input mechanism to provide a set of haptics with intensity levels that change in a first manner as the physical mechanism is moved in the first direction.

100. (canceled)

101. The method of claim 99, wherein causing the physical input mechanism to provide the set of haptics with intensity levels that change in the first manner as the physical mechanism is moved in the first direction includes:
while detecting movement of the physical input mechanism in the first direction, detecting that the physical input mechanism is at a location that corresponds to a second position that is within the threshold distance from the respective position;
in response to detecting that the physical input is at the location that corresponds to the second position that is within the threshold distance from the respective position, causing the physical input mechanism to provide a first haptic of the set of haptics, wherein the first haptic has a first level of intensity;
after causing the physical input mechanism to provide the first haptic, detecting that the physical input mechanism has moved from the location that corresponds to the second position to a location that corresponds to a third position that is within the threshold distance from the respective position, wherein the third position is further away from the first position in the first direction than the second position is away from the first position in the first direction;
in response to detecting that the physical input mechanism has moved from the location that corresponds to the second position to the location that corresponds to the third position, causing the physical input mechanism to provide a second haptic of the set of haptics while the physical input mechanism is moving, wherein the second haptic has a second level of intensity that is greater than the first level of intensity;
after causing the physical input mechanism to provide the second haptic, detecting that the physical input mechanism has moved from the location that corresponds to the third position to a location that corresponds to a fourth position that is within the threshold distance from the respective position, wherein the fourth position is further away from the first position in the first direction than the third position is away from the first position in the first direction; and
in response to detecting that the physical input mechanism has moved from the location that corresponds to the third position to the location that corresponds to the fourth position, causing the physical input mechanism to provide a third haptic of the set of haptics while the physical input mechanism is moving, wherein the third haptic has a third level of intensity that is greater than the second level of intensity and the first level of intensity.

102. The method of claim 99, further comprising:
while detecting movement of the physical input mechanism in the first direction and after detecting that the physical input mechanism is at the location that corresponds to the first position, detecting that the physical input mechanism is at a location that corresponds to a fifth position; and
in response to detecting that the physical input mechanism is at the location that corresponds to the fifth position and in accordance with a determination that a set of criteria has been met, wherein the set of criteria includes a criterion that is met when the location that corresponds to the fifth position is a location that corresponds to the respective position, causing the physical input mechanism to move in a second direction that is different from the first direction.

103. The method of claim 102, wherein the set of criteria includes a criterion that is met when an input directed to the physical input mechanism is no longer detected.

104. The method of claim 102, further comprising:
while causing the physical input mechanism to move in the second direction, causing the physical input mechanism to provide a second set of haptics with intensity levels that change in a second manner as the physical mechanism is moved in the second direction, wherein the second manner is different from the first manner.

105. The method of claim 104, wherein causing the physical input mechanism to provide the second set of haptics with intensity levels that change in the second manner includes:
while causing the physical input mechanism to move in the second direction, detecting that the physical input mechanism is at a location that corresponds to a sixth position;
in response to detecting that the physical input mechanism is at the location that corresponds to the sixth position, causing the physical input mechanism to provide a fourth haptic of the second set of haptics, wherein the fourth haptic has a fourth level of intensity;
while causing the physical input mechanism to move in the second direction and after detecting that the physical input mechanism is at the location that corresponds to the sixth position, detecting that the physical input mechanism has moved from the location that corresponds to the sixth position to a location that corresponds to a seventh position, wherein the seventh position is further away from the fifth position in the second direction than the sixth position is away from the fifth position in the second direction; and
in response to detecting that the physical input mechanism has moved from the location that corresponds to the sixth position to the location that corresponds to the seventh position, causing the physical input mechanism to provide a fifth haptic of the second set of haptics, wherein the fifth haptic of the second set of haptics has a fifth level of intensity that is less than the fourth level of intensity.

106. The method of claim 102, wherein the physical input mechanism is caused to move in the second direction without being caused to provide any haptics as the physical input mechanism is moved in the second direction.

107. The method of claim 99, further comprising:
before detecting movement of the physical input mechanism, displaying a first user interface object indicating a range of values corresponding to the first type of setting is displayed and a first indication of a current value for the first type of setting is displayed relative to the first user interface object; and
while detecting movement of the physical input mechanism in the first direction, moving the first indication relative to the first user interface object based on the movement of the physical input mechanism.

108-109. (canceled)

110. The method of claim 99, further comprising:
in response to detecting that the physical input mechanism is at the location that corresponds to the first position and while detecting movement of the physical input mechanism in the first direction:
in accordance with a determination that the first position is not within the threshold distance from the respective position, forgoing causing the physical input mechanism to provide the set of haptics with intensity levels that change in the first manner as the physical mechanism is moved in the first direction.

111. The method of claim 99, wherein:
the set of haptics includes a first respective haptic that has a first respective level of intensity and a second respective haptic that has a second respective level of intensity that is greater than the first level of intensity; and
the second respective haptic is provided after the first respective haptic is provided.

112. The method of claim 99, wherein causing the physical input mechanism to provide the set of haptics with intensity levels that change in the first manner includes causing the physical input mechanism to provide a sequence of a plurality of haptics that increases over time as the physical mechanism is moved in the first direction.

113. The method of claim 99, wherein causing the physical input mechanism to provide the set of haptics with intensity levels that change in the first manner includes causing the physical input mechanism to provide a single haptic that increases over time as the physical mechanism is moved in the first direction.

114. The method of claim 99, wherein the computer system is in communication with a speaker, the method further comprising:
while causing the physical input mechanism to provide the set of haptics with intensity levels that change in the first manner as the physical mechanism is moved in the first direction, outputting, via the speaker, a sound as the physical mechanism is moved in the first direction.

115. A non-transitory computer-readable storage medium storing one or more programs configured to be executed by one or more processors of a computer system that is in communication with a physical input mechanism, the one or more programs including instructions for performing the method of claim 99.

116. A computer system that is configured to communicate with a physical input mechanism, the computer system comprising:
one or more processors; and
memory storing one or more programs configured to be executed by the one or more processors, the one or more programs including instructions for performing the method of claim 99.

116-164. (canceled)
